(19) United States
(12) Patent Application Publication
(10) Pub. No.: US 2011/0082780 A1
(43) Pub. Date: Apr. 7, 2011

(54) SYSTEM AND METHOD FOR ISSUING AND MONITORING BONDS AND OTHER CONTROLLED DOCUMENTS

(75) Inventors: Amar R. Nagaram, Sioux Falls, SD (US); Trevor M. Jurgensen, Columbus, WI (US)

(73) Assignee: Western Surety Company, Sioux Falls, SD (US)

(21) Appl. No.: 12/573,313

(22) Filed: Oct. 5, 2009

(51) Int. Cl. G06Q 40/00; G06F 17/00; G06F 3/048; G06F 21/24; G06F 17/30; G06F 15/16

(52) U.S. Cl. 705/35; 715/224; 726/28; 707/783; 715/780; 709/203; 715/739; 715/810; 709/206; 707/E17.044

(57) ABSTRACT

A system and method for issuing and monitoring controlled forms, and in particular, insurance policies and bonds. The system generally comprises a server computer and a client computer coupled by a communication link, such as the Internet. A controlled form may be created by a user stationed at the client computer, and subsequently reported to a controlled form issuer at the server computer. The method begins with a user selecting a controlled form issuer and a form. The user enters information into fields of one or more data entry screens corresponding to the selected form, and then transmits the entered information to the server computer. Subsequently, the agent receives a completed controlled form from the server computer corresponding to the selected form that may be printed at the client computer and provided to a form applicant. The information entered by the user may also be used to develop a risk score for the form applicant, and the price of the controlled form may be adjusted based upon the risk score. The system may also include separate modules for viewing and editing information associated with agents who use the system, viewing and editing forms stored on the system, and communicating underwriting requests and decisions.

### FIELD OF THE INVENTION

This present invention relates generally to a system and method for issuing and monitoring controlled forms. More particularly, the present invention relates a computer system usable by an agent and a controlled form issuer (e.g., insurer or corporate surety) to issue and monitor documents, such as insurance policies or surety and fidelity bonds. The present invention also relates to systems and methods for creating and reporting controlled forms, such as bonds. More specifically, the present invention relates to computer systems that permit an agent of a controlled form issuer (e.g., insurer) to create a controlled form (e.g., bond) and report the creation of that controlled form to the controlled form issuer.

### BACKGROUND OF THE INVENTION

Web-based form providing services are known. Additionally, web-based form submission services of limited functionality are also known. However, there remains a need for a web-based business transaction system in which an agent, acting by their own authority, may issue a controlled form (e.g., bond) and thereby bind both a principal (e.g., building contractor) and a controlled form issuer (e.g., insurer).

A controlled form may be defined as a document that is tracked by an identification system uniquely identifying each document. For example, controlled forms may be used for the issuance of all types of bonds, insurance policies, many financial transactions, governmental forms, and environments in which documents are issued at remote locations.

A controlled form issuer may comprise a corporation that issues one or more controlled forms that bind the corporation to provide the agreed to service or product. A controlled form issuer may, for example, offer services such as insurance and bonding services, and/or financial services.

An obligee may be defined as an individual, partnership, corporation, or government entity that requires the guarantee that an action or service will be performed. If not properly performed, the controlled form issuer pays the obligee for any damages or fulfills the obligation. For example, an oblige may comprise an individual who requires that a building contractor performing work on his property perform the work properly.

Agents may comprise the link between controlled form issuer (e.g., insurer) and those who need controlled forms (e.g., building contractors). Agents are often granted a Power of Attorney by one or more controlled form issuers that gives them the authority to execute controlled forms. However, each agent may be limited to the amount and type of controlled forms that can be executed. Typically, this Power of Attorney and pre-executed controlled forms allow an agent to issue controlled forms right in the agent's office.

One example of a controlled form is a surety bond. A surety bond may be obtained by a person or entity (referred to herein as the obligee) to protect the recipient against loss in case a principal (e.g., building contractor) does not perform the terms of a contract (e.g., construction contract). The principals may comprise bonded entities, such as contactors, subcontractors or vendors. The obligees are beneficiaries of the surety bond, such as project owners, developers, and in some cases a contractor, when the principal is a subcontractor. The surety bond is a guaranty instrument and is commonly referred to as a payment and performance bond. Typically, there are two bonds involved in a surety obligation, one for payment and one for performance. For example, an obligee could be a real-estate investment group that has contracted with a principal (e.g. building contractor) to construct a residential high-rise building. The principal would take out a surety bond with a surety (e.g., insurer) in order to guarantee its performance, and to cover any losses incurred by the obligee due to default (e.g., non-performance or mistake) by the principal. The principal pays the surety a premium for the bond, which is often times related to the cost of the project being performed. The surety, typically through an agent, issues a surety bond for which a premium, typically a percentage of the contract amount, is paid. In order to obtain the surety bond, the principal typically visits the agent at their office, where the agent takes in the relevant information and sends the information off to the surety for processing, and eventual issuance of the bond. As explained below, some computerized systems exist for assisting in the issuance of surety bonds, but no conventional systems permit the agent to issue a surety bond (or any other type of bond) in real-time and simultaneously bind the principal, oblige and surety. Put another way, using conventional systems the agent cannot bind the principal, the obligee and the surety to a surety bond at the same time the principal requests the bond; the agent must wait for approval from the surety before the parties can be bound.

Conventional computerized systems for permitting an agent to issue controlled forms typically provide blank controlled forms that must be filled out and then fully executed prior to issuance. This requires the agent to have expertise in properly filling out all of the required fields of each of the controlled forms the agent is authorized to issue. For example, these systems force the agent to know his authorized limits for every controlled form and also know the limit of each controlled form that he can issue. This inhibits the agent from using lower skilled support staff from performing the mundane data entry required for many of the fields of the forms.

Other systems for agent issuance of controlled forms also require the agent to maintain a log and other records that are then sent to the controlled form issuer for the controlled form issuer's records. The problem with such systems is that the separate manual maintenance and sending of controlled form records may lead to errors and inaccuracies in record keeping and long and untimely delays in the receiving of these records by the controlled form issuer.

For example, U.S. Pat. Nos. 5,758,126; 5,875,435; 6,345,278; 5,878,403; and 6,167,378 describe conventional electronic form transmittal systems. The disclosures of each of these patents is hereby incorporated by reference in this application, as if fully set forth herein.

U.S. Pat. No. 6,345,278 (“Hitchcock”) discloses an application translation and transmittal system in which an applicant may provide information to a third party for storage and subsequent use. For example, Hitchcock deals with an applicant to college filing out an electronic admission application. The applicant first sets up an account with a third party who hosts an online database for facilitating college admission applications. The applicant then fills out a first college admission application form. Some of the information provided on the first college admission form is saved by the third party for use in future admission application forms. Each application completed by the applicant is validated for accuracy forwarded to the selected college by the third party for further processing, in a form preferable to such institution. For instance, the third party then may translate the information entered by the applicant to meet the needs of a particular institution before transmitting the information to the institution as a formatted admission application. Upon receipt, the institution(s) may chose to act on the application, reject the application, or offer to enter into some other arrangement with the applicant. Importantly, the third party provider cannot bind the institution to which the application form is transmitted in any way, and the form provided (i.e., admission application) is not a controlled form. Furthermore, the third party provider is not empowered by the institution with specific authorized limits, or subjected to any type of review process by the institution. For example, the third party provider merely provides the application to the institution, and does not check to see if the applicant's test scores and grades fall within the acceptable limits for the institution.

U.S. Pat. No. 5,878,403 (“DeFrancesco”) teaches a translation and transmittal system not unlike Hitchcock. DeFrancesco communicates application data to at least one third party. The third party then acts upon the information and declines, sets aside for further review, or commits to a transaction (e.g., a funding decision or loan). Nothing in DeFrancesco teaches, suggest, or discloses a system in which an agent (e.g., car dealer), based upon their own authority, may bind the third party to a loan.

U.S. Pat. No. 6,167,378 (“Webber”) teaches an electronic transaction environment for executing contracts electronically. However, the contracts in Webber require ratification by the party to be bound for the contract to be valid.

U.S. Pat. No. 5,758,126 (“Daniels”) teaches a computer system for processing information in Electronic Data Interchange (EDI) format. In one exemplary embodiment, the system includes a Graphical User Interface with various fields for accepting information related to electronic commerce transactions, and converting such information to an EDI format. Once converted, the information may be easily provided to any other entity which has a pre-existing computer system for processing EDI data. Thus, the computer system allows two entities, one with EDI capabilities and one without, to effectively communicate information related to electronic commerce transactions therebetween. Daniels does not disclose, teach or suggest a computer system whereby the EDI party may bind the non-EDI party to certain transactions, or vice versa.

U.S. Pat. No. 5,875,435 (“Brown”) teaches an automated accounting system which includes a master ledger file for an individual or entity which is hosted on a central computer. The master ledger file may be accessed and updated through various data inputs by various employees of the individual or entity as transactions occur. The master ledger file may also be accessed and updated by third parties, such as outside accountants and money managers associated with the individual or entity. Access to the system is provided to the third parties based on a password issued by the individual or entity. Brown nowhere discloses, teaches or suggest a procedure whereby the third parties may bind the individual or entity.

Electronic bond issuance systems also exist, but suffer from many of the same drawbacks as described above for electronic forms systems. For example, U.S. Pat. Nos. 4,831,526, 7,194,435 and 7,430,516 describe conventional electronic bond issuance systems. The disclosures of each of these patents is hereby incorporated by reference in this application, as if fully set forth herein.

U.S. Pat. No. 4,831,526 (“Luchs”) teaches a computer system for providing insurance quotes and issuing insurance policies. The system includes at least one computer for accomplishing data entry (e.g., an agent computer), and at least one central processor. The user (e.g., agent) begins by logging on to the system using an assigned password. The user then proceeds to enter information on the client, such as name, address, insurance policy information, etc. Once the client information is entered, a premium is calculated. At this point, the client must decide whether to accept or decline the policy based on the quoted premium. If the client accepts the policy, the policy is ‘issued,’ meaning it is sent to underwriting employees of the insurer for approval. In the exemplary embodiment, the underwriter employee logs into the system in the same way as the agent user, using an assigned password. Once logged in, the underwriting employee is then presented with an ‘in-box’ of pending policies for approval. The underwriting employee reviews the policies, and approves, rejects, or sends them to a higher authority. If approved, the policy is forwarded to a ‘batch processing’ system for further processing, and eventually printed and mailed to the client. The system described by Luchs does not permit the agent to issue the insurance policy directly to the form applicant in real-time (i.e., without sending a request to the insurer for approval), and does not permit the electronic transmission of the policy (such as through e-mail).

U.S. Pat. No. 7,194,435 (“Sforzo”) discloses a system and method for issuing surety bonds over a computer network. The agent begins the bond issuance process by accessing a website of the insurer. After entering security information (e.g., ID and password), the agent is presented with a screen to enter information concerning the bond, such as principal name and address, obligee name and address, estimated contract price, etc. Once the information is entered, the agent is presented with a list of sureties from which to choose. After the agent has selected a surety, the agent may submit the bond request to the surety over the computer network. When the bond request is received at the surety's offices, the surety employee in charge of the bond receives a message (e.g., e-mail) that the bond request has arrived, and is pending. If the surety employee approves the bond, the principal receives an authorization code directly from the insurer. The authorization code may then be provided to the obligee by the principal, so that the obligee can review and print the bond. The system described by Sforzo does not permit the agent to issue the bond directly to the principal in real-time (i.e., without sending a bond request to the insurer for approval).

Finally, U.S. Pat. No. 7,430,516 (“Blair”) discloses a system and method for issuing insurance instruments, such as surety bonds, over a computer network. The system includes a user interface, such as a web browser, which allows agents to access application screens, and view and print forms. The system also includes an application logic layer, a business logic layer, and a data management layer, which are coupled to the user interface layer. The method begins with an agent accessing the user interface, and entering (or retrieving previously-entered) client information. The agent then enters further information concerning the specific insurance instrument currently being sought by the customer. A premium is then calculated for the instrument. The premium information is then submitted (e.g., via e-mail) to the customer in the form of an invoice. The instrument is not actually created until the customer remits payment in response to the invoice. Once the instrument and any supporting documentation have been created, the documents are submitted (e.g., via e-mail) to the client for execution. The system described by Blair does not permit the agent to create the bond and provide it to the principal directly in real-time. Blair requires that an invoice be sent to the principal, and that the principal pay that invoice, before the bond is actually created, and before the bond is executed by the principal. Because certain bonds (e.g., surety bonds) are often required by principals under short time frames, intervening payment and execution steps present significant drawbacks.

As noted above, conventional computer systems involving electronic forms do not include a means for an agent (or any other third party) to immediately bind a principal and an insurer or surety to the terms of a electronically-generated form. Additionally, conventional computer systems involving electronic forms do not provide a means for electronically reporting the issuance of forms to the form issuer. Further, conventional computer systems involving electronic forms do not include a means for performing risk-scoring on a form applicant (i.e., principal) in real-time, and adjusting the cost of the instrument based on the risk score. Finally, conventional computer systems do not include effective means for controlling agency profile and user information, managing forms, and coordinating with underwriting.

Accordingly, there is presently a need for a system and method in which an agent is able to issue controlled forms in real-time, binding the issuing institution and the principal within a predetermined limit, in which risk associated with the applicant is scored and in which the cost of the instrument may be adjusted according to the risk score, and in which agency information, forms information, and underwriting tasks may be effectively managed.

### SUMMARY OF THE INVENTION

An exemplary embodiment of the present invention comprises a computer system including at least one server computer, at least one client computer coupled to the at least one server computer through a network, wherein the at least one server computer includes at least one program stored thereon, the at least one program being capable of performing the steps of permitting a user stationed at the at least one client computer to select a controlled form issuer, displaying one or more controlled forms associated with the selected controlled form issuer, permitting the user to select at least one form from the one or more controlled forms, displaying a data entry screen corresponding to the selected form, permitting the user to enter data into one or more fields of the selected form, and issuing a completed controlled form corresponding to the selected form at the at least one client computer, whereby the controlled form issuer is bound to the terms of the completed controlled form.

An exemplary embodiment of the present invention also comprises a computer readable medium having embodied therein a computer program for processing by a machine, the computer program including a first code segment for permitting a user to select a controlled form issuer, a second code segment for displaying one or more controlled forms associated with the selected controlled form issuer, a third code segment for permitting the user to select at least one form from the one or more controlled forms, a fourth code segment for displaying a data entry screen corresponding to the selected form, a fifth code segment for permitting the user to enter data into one or more fields of the selected form, and a sixth code segment for issuing a completed controlled form corresponding to the selected form, whereby the controlled form issuer is bound to the terms of the completed controlled form.

An exemplary embodiment of the present invention also comprises a computer data signal embodied in a carrier wave including a first code segment for permitting a user to select a controlled form issuer, a second code segment for displaying one or more controlled forms associated with the selected controlled form issuer, a third code segment for permitting the user to select at least one form from the one or more controlled forms, a fourth code segment for displaying a data entry screen corresponding to the selected form, a fifth code segment for permitting the user to enter data into one or more fields of the selected form, and a sixth code segment for issuing a completed controlled form corresponding to the selected form, whereby the controlled form issuer is bound to the terms of the completed controlled form.

### BRIEF DESCRIPTION OF THE DRAWINGS

The invention will be better understood with reference to the following detailed description, of which the following drawings form an integral part.

FIG. 1 is a schematic diagram of a computer system according to a first exemplary embodiment of the present invention for creating and reporting controlled forms.

FIG. 2 is a flow diagram of a routine for creating and reporting controlled forms in accordance with the first exemplary embodiment of the present invention.

FIG. 3 illustrates an exemplary security authorization display which may be displayed on the visual display of an agent computer during the step in Box 1.2 in the first exemplary embodiment of the present invention.

FIG. 4 illustrates an exemplary main menu display according to the first exemplary embodiment of the present invention.

FIG. 5 illustrates an exemplary data entry screen according to the first exemplary embodiment of the present invention.

FIG. 6 illustrates an exemplary transmitted completed controlled form displayed on the visual display of an agent computer according to the first exemplary embodiment of the present invention.

FIG. 7a is a schematic diagram of a computer system according to a second exemplary embodiment of the present invention for creating and reporting controlled forms.

FIG. 7b is a schematic diagram of a computer system according to a third exemplary embodiment of the present invention for creating and reporting controlled forms.

FIG. 8 is a flow diagram of the controlled form creation process according to the second and third exemplary embodiments of the present invention.

FIG. 9 illustrates an exemplary main menu display according to the second and third exemplary embodiments of the present invention.

FIG. 10 illustrates an exemplary data entry screen display according to the second and third exemplary embodiments of the present invention.

FIG. 11 illustrates an exemplary data entry screen display according to the second and third exemplary embodiments of the present invention, showing a controlled form number field.

FIG. 12 is a flow diagram of an exemplary utility menu routine according to the second and third exemplary embodiments of the present invention.

FIG. 13 illustrates an exemplary utility menu screen according to the second and third exemplary embodiments of the present invention.

FIG. 14 illustrates an exemplary utility menu screen according to the second and third exemplary embodiments of the present invention, showing a pair of buttons for permitting an agent to select the method to transmit a report file.

FIG. 15 is a flow diagram of an exemplary process for uploading information to a legacy system according to the second and third exemplary embodiments of the present invention.

FIG. 16 illustrates an exemplary Profile Search Screen.

FIG. 17 illustrates an exemplary Agency Management Search Screen.

FIG. 18 illustrates an exemplary Add/Edit Profile Screen.

FIG. 19 illustrates an exemplary Define Profile Authority Screen.

FIG. 20 illustrates an exemplary Add/Edit Profile Authority Screen.

FIG. 21 illustrates an exemplary View Profile Authority Override Screen.

FIG. 22 illustrates an exemplary View User Security Screen.

FIG. 23 illustrates an exemplary Add/Edit Profile Security Screen.

FIG. 24 illustrates an exemplary View Profile Status Screen.

FIG. 25 illustrates an exemplary Force On/Off Screen.

FIG. 26 illustrates an exemplary On/Off Form Details Screen.

FIG. 27 illustrates an exemplary Profile Bond List Screen.

FIG. 28 illustrates an exemplary Introduction Letter Screen.

FIG. 29 illustrates an exemplary Today's Work Screen.

FIG. 30 illustrates an exemplary Profile History Screen.

FIG. 31 illustrates an exemplary Form Search Screen.

FIG. 32 illustrates an exemplary Add/Edit Forms Screen.

FIG. 33 illustrates an exemplary Forms Authority Screen.

FIG. 34 illustrates an exemplary Form Status Screen.

FIG. 35 illustrates an exemplary Package Search Screen.

FIG. 36 illustrates an exemplary Add/Edit Package Screen.

FIG. 37 illustrates an exemplary Custom Dropdowns Screen.

FIG. 38 illustrates an exemplary Package Authority Screen.

FIG. 39 illustrates an exemplary Package Status Screen.

FIG. 40 illustrates an exemplary Package Assembly Screen.

FIG. 41 illustrates an exemplary Form History Screen.

FIG. 42 illustrates an exemplary Package History Screen.

FIG. 43 illustrates an exemplary Form Search Screen.

FIG. 44 illustrates an exemplary Pending List Screen.

FIG. 45 illustrates an exemplary Form Information Entry Screen.

FIG. 46 illustrates a first exemplary Form Summary Screen.

FIG. 47 illustrates a second exemplary Form Summary Screen.

FIG. 48 illustrates an exemplary Agency Profile Screen.

FIG. 49 illustrates an exemplary Risk Scoring Screen.

FIG. 50 illustrates an exemplary Request Approval Screen.

FIG. 51 illustrates an exemplary Compose E-mail Screen.

FIG. 52 illustrates an exemplary Draft E-mail Screen.

### DETAILED DESCRIPTION

The present invention relates to a system and method for issuing and monitoring forms, such as bonds, which permits agents to electronically issue forms which bind the principal (e.g., building contractor) and the controlled form issuer (e.g., insurer), which provides for reporting of the issuance of such forms to the form issuer, and which provides a means to perform a risk assessment of the form issuer's customers (i.e., principals). Although the referred to as a controlled form issuer herein, those of ordinary skill in the art will realize that such entity may merely comprise a provider of controlled forms, or a broker for controlled forms issued by third parties. Further, although in the exemplary cases described herein the controlled form issuer comprises an insurance company, those of ordinary skill in the art will realize that the controlled form issuer may comprise various other types of entities.

The present invention meets the needs presented above by allowing business to proceed at its own pace through eliminating unnecessary delays. An exemplary embodiment of the present invention allows a controlled form, such as a bond or insurance policy, to be issued on demand at the agent's computer. Further, the present invention also allows the price associated with the controlled form to be adjusted in accordance with risk factors associated with the form applicant.

An object of the present invention is to allow agents to facilitate the rapid exploitation of business opportunities through on demand issuance of controlled form documents. Another object of the present invention is to provide a controlled form creation and reporting system that adjusts a price or cost associated with the controlled form according to multiple risk factors, which may be associated with the form applicant. Yet another object of the present invention is to provide a system where, within predetermined levels of authorization, for an agent, selected controlled form issuer, and selected form, an agent may autonomously bind the controlled form issuer. Still another object of the present invention is to provide a new controlled form creation and reporting system that allows non-standard requests to be processed as applications in a conventional manner. Even still another object of the present invention is to provide a new controlled form creation and reporting system which can be used in the issuance of bonds, annuities, insurance policies, negotiable instruments, and other financial instruments. Yet another object of the present invention is to provide a controlled form creation and reporting system which reduces the need for agent education regarding types of controlled forms offered, pricing of controlled forms, and risks associated with the form applicant affecting the issuance of the controlled form.

In order to accomplish the above, an exemplary embodiment of the present invention may comprise a computer system including a form issuing computer network, at least one workflow system computer, and a master program operating on the form issuing computer network. The form issuing computer network may include at least one agent computer for use by an agent or by personnel of the controlled form issuer, a server computer for receiving information related to a controlled form being issued by the agent, and a communications link facilitating operational communication between the agent computer and the server computer. The workflow system computer preferably operationally interacts with the form issuing computer network, and may employ a firewall. The master program may operates on the form issuing computer network, and may include at least a main menu routine and a utility menu routine. The at least one agent computer may be used to facilitate selection of a category of controlled forms, selection of a controlled form issuer from a plurality of controlled form issuers providing controlled forms in the category, and selection of a controlled form. The at least one agent computer may also be used to facilitate input of information data related to a form applicant wishing to obtain said controlled form.

The present invention may be more completely understood with reference to the following definitions. While the present invention may be used to facilitate on demand procurement of a variety of financial instruments, insurance policies, and negotiable instruments, the exemplary embodiments contemplates use within the context of bonds, and in particular, surety bonds. Many types of bonds are available and are within the confines of the exemplary embodiments of the present invention. Because the use of terminology within the bonding industry may be slightly different than other fields of endeavor, the following definitions are provided for the terminology used within the instant disclosure:

Administrator

A person legally vested with the right of administration of an estate.

Applications

A form used to collect information to underwrite a risk.

Attachment

The legal process of taking possession of a defendant's property when the property is in dispute.

Balance Sheet

A financial statement listing assets, liabilities and net worth.

Bank Depository Bonds

Bonds guaranteeing the deposit of public funds.

Bankruptcy Trustee Bonds

Bonds which provide a guarantee to the beneficiaries of the bankruptcy action that the bonded trustees, appointed in a bankruptcy proceeding, will perform their duties and handle the affairs according to the rulings of the court.

Common types of bankruptcies are:

Chapter 7: calls for the “liquidation” of a business and allows for the sale of the assets to pay outstanding debts.

Chapter 11: calls for the “reorganization” of a business and the debtor remains in possession of the assets after the filing of a plan for the reorganization.

Bid Bonds

Bonds which guarantee that a contractor will enter into a contract at the amount bid and post the appropriate performance bonds.

These bonds are used by owners to pre-qualify contractors submitting proposals on contracts. These bonds provide financial assurance that the bid has been submitted in good faith and that the contractor will enter into a contract at the price bid.

Blanket Bonds

Bonds which guarantee the honesty of all of the employees of an entity to the stated amount of the bond.

Blanket Position Bonds

Bonds which guarantee the honesty of each of the employees of an entity stated on the bond to the stated amount of the bond.

Blanket Public Official Bond

Blanket public official bonds cover all public employees of the public entity stated on the bond to the stated amount of the bond.

Blanket Position Public Official Bond

The blanket position public official bond covers each public employee of the public entity stated on the bond to the stated amount of the bond.

Capacity

A term that refers to the size of a bond which a surety is able to write.

Commercial Bonds

A general classification of bonds that refers to all bonds other than contract and performance bonds. Commercial bonds cover obligations typically required by law or regulation. Each bond is unique to the circumstances at hand.

Commercial Blanket Bonds

These bonds provide a single amount of coverage to cover dishonest acts of employees, regardless of the number of employees involved in the loss. In other words, this type of bond covers all employees to the amount stated on the bond.

Conservator

A person, official, or institution designated to take over and protect the interest of an incompetent or minor.

Contract Bonds

A type of bond designed to guarantee the performance of obligations under a contract. These bonds guarantee the obligee that the principal will perform according to the terms of a written contract. Most of these bonds relate to construction contracts. Contract bonds protect a project owner by guaranteeing a contractor's performance and payment for labor and materials. Because the contractor must meet the surety company's pre-qualification standards, construction lenders are also indirectly assured that the project will proceed in accordance with the terms of the contract.

Court Bonds

A general term referring to bonds required in some action of law.

Damages

Term that refers to monetary measures of harm which may have occurred in a claim.

Defendant

The term that refers to the person or institution being accused in a court case.

Defendant Bonds

Defendant bonds counteract the effect of the bond that the plaintiff has furnished. These bonds are more hazardous than plaintiff bonds. Often they require the posting of collateral to be written.

Employee Retirement Income Security Act

The 1974 act that created a requirement for a bond to be posted, in the amount of ten percent of the funds, on the fiduciary of pension funds and profit-sharing plans.

Errors and Omissions Insurance

A policy that guarantees coverage for an individual in the event of unintentional mistakes. Errors and Omissions Insurance, commonly referred to as E&O, covers damages arising out of the insured's negligence, mistakes, or failure to take appropriate action in the performance of business or professional duties.

Executor

A person appointed to execute a will.

Fidelity Bonds

Bonds designed to guarantee honesty. Generally, the bond guarantees honesty of employees. These bonds cover losses arising from employee dishonesty and indemnify the principal for losses caused by the dishonest actions of its employees.

Fiduciary

One who is appointed to act in the best interests of another. A fiduciary is a person appointed by the court to handle the affairs of persons who are not able to do so themselves. Fiduciaries are often requested to furnish a bond to guarantee faithful performance of their duties.

Fiduciary Bonds

Bonds which guarantee an honest accounting and faithful performance of duties by administrators, trustees, guardians, executors, and other fiduciaries. Fiduciary bonds, in some cases referred to as probate bonds, are required by statutes, courts, or legal documents for the protection of those on whose behalf a fiduciary acts. They are needed under a variety of circumstances, including the administration of an estate and the management of affairs of a trust or a ward.

Funds Control

A method of taking control of a contract bond to ensure subcontractors and suppliers will be paid appropriately. This method may be used when the contractor would not otherwise qualify for a bond.

Indemnification

The act of guaranteeing another, repayment in the event of a loss.

Individual Bonds

A term generally used with public official bonds, which refers to bonds written in the name of the specific public official.

Large Deductible Plans

A type of insurance program bond in which the insurer pays all losses, including those that fall within the deductible, and seeks reimbursement from the policyholder on a monthly or quarterly basis. The bond guarantees the policyholder will reimburse the insurer for losses within the deductible. The insurance deductible typically range from $25,000 to $1,000,000 per claim or larger.

License and Permit Bonds

A term used to refer to bonds, which are required to obtain a license or a permit in any city, county, or state. These bonds guarantee whatever the underlying statute, state law, municipal ordinance, or regulation requires. They may be required for a number of reasons, for example the payment of certain taxes and fees and providing consumer protection as a condition to granting licenses related to selling real estate or motor vehicles and contracting services.

Maintenance Bonds

Bonds that provide for the upkeep of the project for a specified period of time after the project is completed. These bonds guarantee against defective workmanship or materials. These bonds may occasionally include a guarantee of “efficient or successful operation” or other obligations.

Minor

A person who is not of legal majority. In certain situations, a person may be appointed as a guardian of a minor.

Miscellaneous Bonds

A term used to refer to bonds which do not fit any of the other well-recognized categories of surety bonds.

Name Schedule Bonds

A type of public official or fidelity bond that lists the specific names and amounts of each named individual bonded. Name schedule bonds use one bond, but attach a schedule of individual names of the bonded public officials. Each name will list a specific dollar amount for which that individual is being bonded. These may be used to bond a panel of city council members or similar body of officials.

Name Schedule Public Official Bonds

Name schedule bonds use one bond, but attach a schedule of individual names of public officials being bonded. Each name will list a specific dollar amount for which that individual is being bonded. These may be used to bond a panel of city council members or similar body of officials.

Notary Public Bonds

Include bonds that are required by statutes to protect against losses resulting from the improper actions of notaries.

Obligee

The person or institution to which a surety guarantees that a principal will perform as expected.

Open Penalty

A term used to refer to the unlimited liability of the surety on a particular bond.

Ordinance

A municipal regulation.

Payment Bonds

Payment bonds guarantee payment of the contractor's obligation under the contract for subcontractors, laborers, and materials suppliers associated with the project. Since liens may not be placed on public jobs, the payment bond may be the only protection for those supplying labor or materials to a public job.

Penalty

A term used to refer to the monetary size or limit of bond.

Pension

A fixed sum of money regularly paid to a person.

Performance Bonds

Performance bonds guarantee performance of the terms of a contract. These bonds frequently incorporate payment bond (labor and materials) and maintenance bond liability. This protects the owner from financial loss should the contractor fail to perform the contract in accordance with its terms and conditions.

Plaintiff

The person or institution that brings an action in a court of law.

Plaintiff Bonds

Plaintiff bonds are required of a plaintiff in an action of law. They generally guarantee damages to the defendant caused by the plaintiff's legal action, should the court decide for the plaintiff.

Position Schedule Bonds

A type of fidelity or public official bond, which lists specific positions and their corresponding penalty amounts. Position schedule bonds use one bond, but attach a schedule of positions to be bonded. Each name will list a specific dollar amount for which that individual is being bonded. This type of bond may be used to bond certain positions that have a high amount of turnover. Using a position instead of a name will reduce the paperwork involved year-to-year.

Premium

A sum of money paid as consideration for an insurance policy or bond.

Principal

The individual required to be bonded by the obligee.

Public Official Bonds

A type of bond that guarantees a public official will act with honesty and/or faithful performance. These bonds are required by statutes and ordinances.

Public Officials

One who holds public office.

Rates

The amount of money per thousand dollars (or percentage) used to determine the bond premium.

Reclamation Bonds

A bond which guarantees that an institution will restore land, that it has mined or otherwise altered, to its original condition.

Replevin

A legal action used to recover specific personal property.

Retrospective Plans

Type of insurance program bond in which the final premium is a combination of incurred losses and an administrative charge. Retrospective plans are loss sensitive insurance plans. Since final loss costs may take years to develop, the bond guarantees payment of the final premium amount.

SBA

An acronym for the Small Business Administration. The SBA has a program to help small and minority owned contracting businesses obtain surety bonds.

Self-Insurers Retention Plans

A type of insurance program bond that is commonly used with Workers' Compensation insurance, General Liability coverage or other liability coverage where limited coverage is available or coverage, when available, may not be affordable.

Supply Bonds

Bonds which guarantee performance of a contract to furnish supplies or materials. In the event of a default by the supplier, the surety indemnifies the purchaser of the supplies against the resulting loss.

Surety

A person or institution which guarantees the acts of another.

Surety Bonds

Surety bonds are three-party agreements in which the issuer of the bond (the surety) joins with the second party (the principal) in guaranteeing to a third party (the obligee) the fulfillment of an obligation on the part of the principal. An obligee is the party (person, corporation or government agency) to whom a bond is given. The obligee is also the party protected by the bond against loss.

Surety Industry

The surety industry is composed of contract surety business and commercial surety business. The products comprising each are sold through the same type of distribution system—agents and brokers.

Treasury Listing

A financial rating published by the federal government that lists the maximum size of federal bond a surety is allowed to write.

Trustee

A trustee is a person named to manage a business' assets and work with the business creditors.

Work-On-Hand Reports

A type of financial statement or schedule which lists a contractor's jobs in progress.

Workers' Compensation Self-Insurers Bond

Workers' Compensation laws, at the state and federal level, require employers to compensate employees injured on the job. An employer may comply with these laws by purchasing insurance or self insuring by posting a workers' compensation bond to guarantee payment of benefits to employees. This is a hazardous class of commercial surety bond because of its “long-tail” exposure and potential cumulative liability. The “long-tail” exposure stems from the two statutory bond forms:

Traditional—bond form:

The surety is liable for payment of the principal's workers' compensation obligations occurring during the time the bond is in force. When the bond is canceled, the surety continues to have liability for all workers' compensation claims incurred between the effective date of the bond and the cancellation date of the bond.

Last surety on—bond form:

The surety assumes all past, present and future liability to pay the principal's self-insurers workers' compensation obligations. The surety is released from all accrued liability if the surety cancels the bond and the principal later posts an acceptable replacement security.

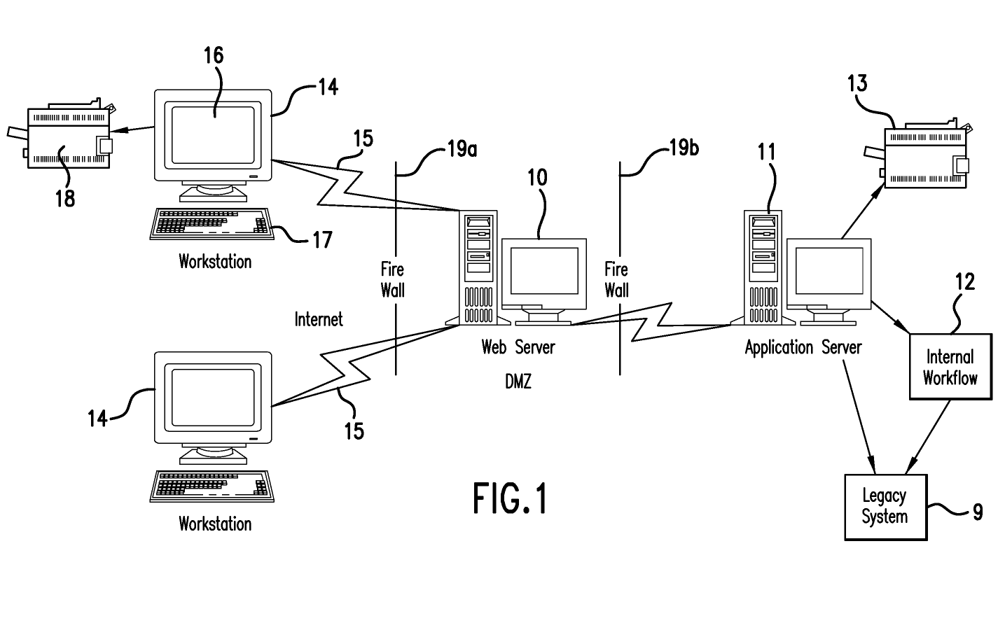

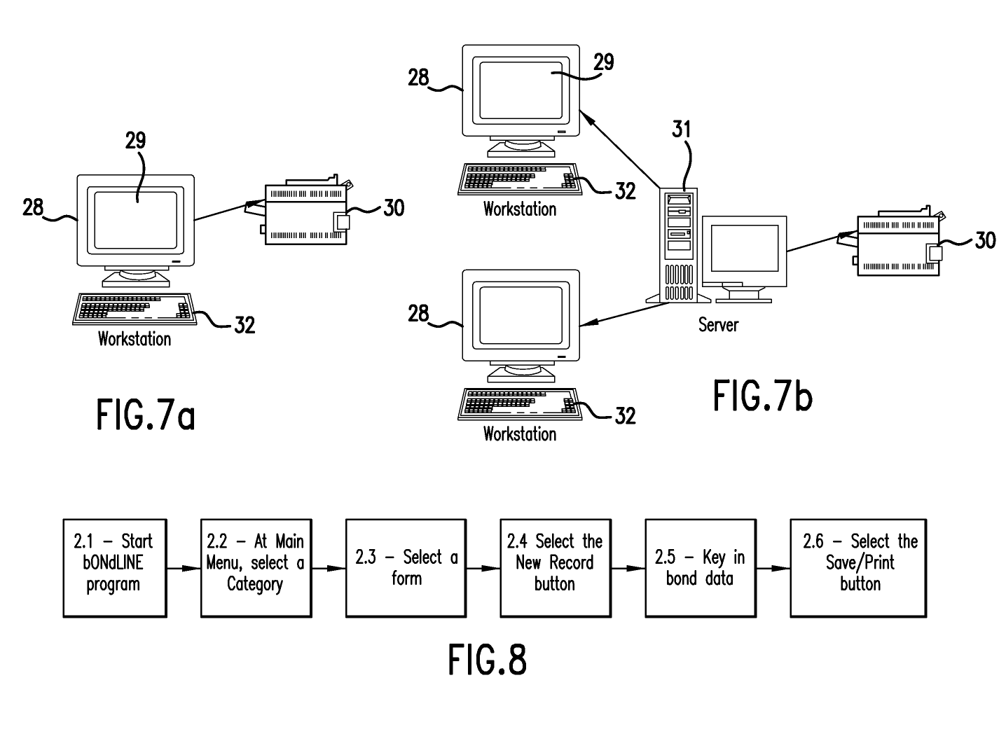

With reference now to the drawings, and in particular to FIGS. 1-15 thereof, a method and system for creating and monitoring controlled forms is described. The exemplary embodiments of the present invention comprise computer systems for electronically creating, printing, reporting and monitoring forms whose production is tracked and controlled. FIGS. 1-6 illustrate a first exemplary embodiment of the present invention, while FIGS. 7-15 illustrate second and third exemplary embodiments of the present invention.

### First Exemplary Embodiment

FIG. 1 shows a computer system according to a first exemplary embodiment of the present invention which includes a WEB server computer 10, and an application server computer 11 in communication with the WEB server computer. The application server computer 11 may be coupled to an internal workflow system 12 of the controlled form issuer, and may also be coupled to a printer 13. The computer system may also include one or more agent computers 14, which may each be associated with: (1) an agent of the controlled form issuer, or (2) an internal employee of the controlled form issuer. Each of the agent computers 14 may be coupled to the WEB server computer 10 by a communication link 15 such as, for example, the Internet or an Intranet. Each agent computer 14 may also include a visual display 16, a user interface 17 (such as, for example, a keyboard and mouse), and may have a printer 18 coupled thereto.

In the exemplary embodiment, the WEB server computer 10 may also include a fire wall system 19a, 19b set up between the WEB server computer and the agent computers 14, and between the WEB server computer and the application server computer 11, to prevent tampering and corrupting of the WEB server computer and application server computer from external sources.

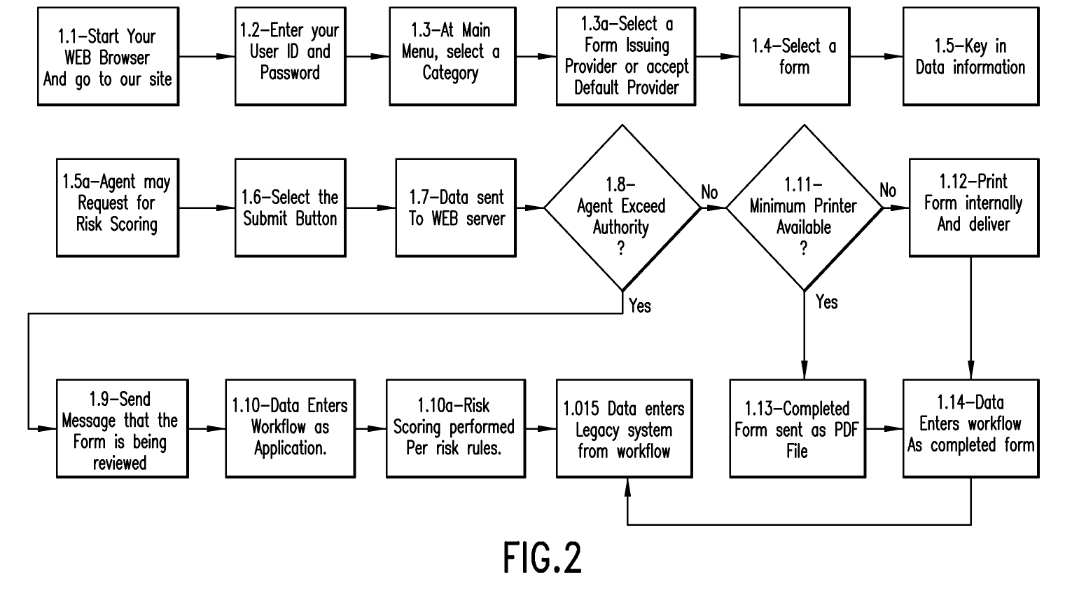

FIG. 2 is a flow diagram showing a method for creating and reporting controlled forms on the computer system according to the first exemplary embodiment of the present invention. The method shown in FIG. 2 may be implemented through software, including one or more program modules, resident on the application server computer 11, and accessed by the one or more agent computers 14 through a browser program (e.g., Microsoft Internet Explorer®) resident on the agent computer, as will be understood by those of ordinary skill in the art. Alternatively, the software implementing the method may be disposed on each of the one or more agent computers 14, or on the WEB server computer 10.

Starting with Box 1.1, the agent computer 14 may initiate a transaction communication with the WEB server computer 10 via the communication link 15, such as by initiating an Internet or Intranet browser (e.g., Microsoft Internet Explorer®) on the agent computer. Once the communication is initiated, a security authorization program may be initiated, as illustrated in Box 1.2, which operates to permit or deny the agent stationed at the agent computer 14 to create and record one or more controlled form. For example, the security authorization program may present the agent with a display screen on the visual display 16 of the agent computer 14 which includes fields for entering Username and Password information.

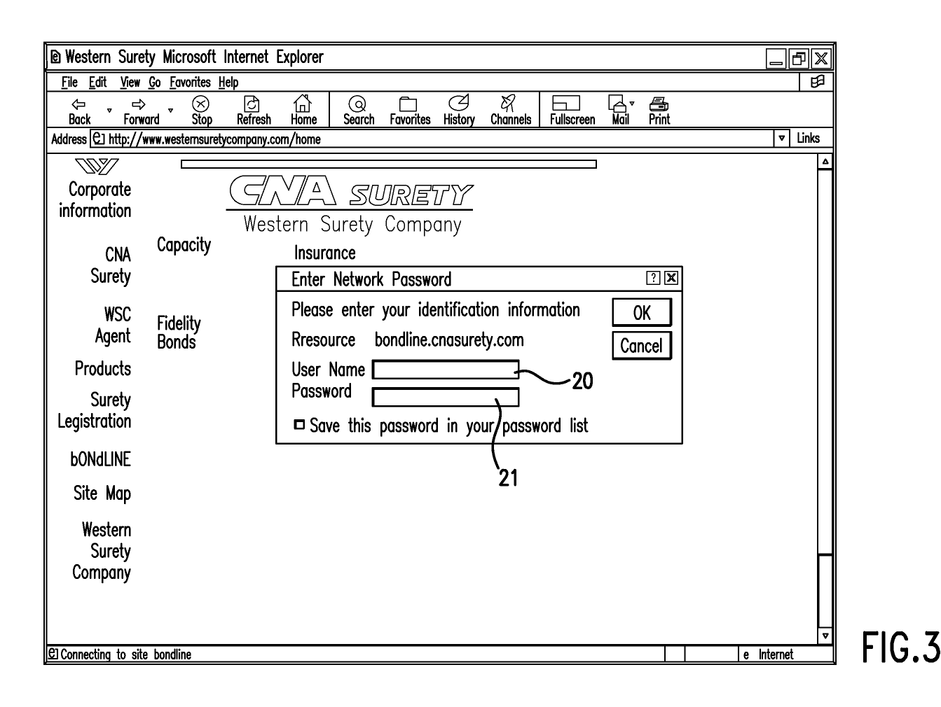

FIG. 3 illustrates an exemplary security authorization display which may be displayed on the visual display 16 of an agent computer 14 during the step shown in Box 1.2 of FIG. 2. The exemplary display requests that the agent enter a pre-assigned Username in a Username field 20, and Password in a Password field 21. Upon selection of a button on the visual display 16 (e.g., the “Ok” button), the Username and Password may be transmitted to the WEB server computer 10 for verification purposes.

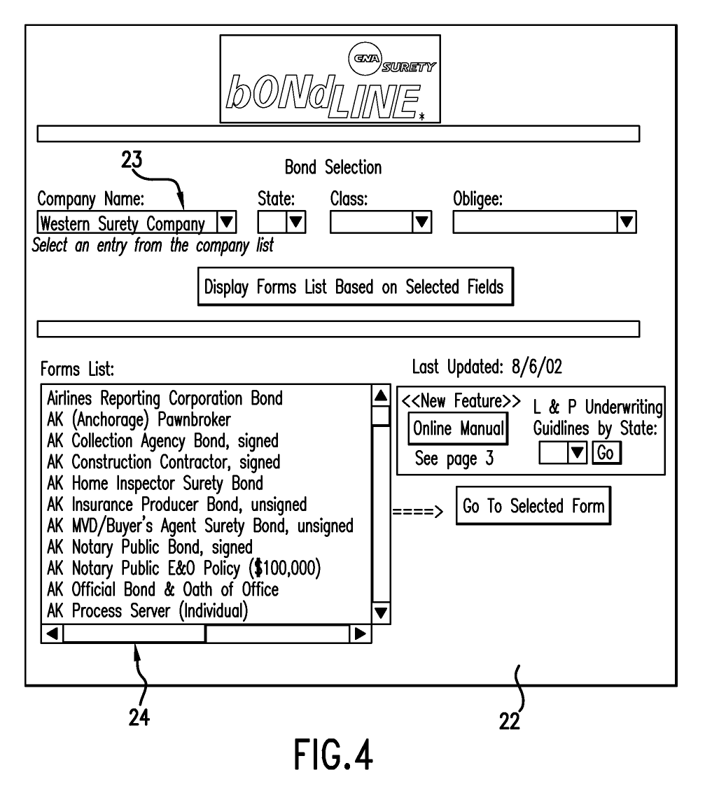

Upon authorization of the agent, a main menu 22 for selecting a controlled form to be created may be displayed on the visual display 16 of the agent computer 14 in the step shown in Box 1.3. As illustrated in FIG. 4, the main menu 22 may include a plurality of display boxes including a provider display 23 of possible controlled form issuing providers that the agent may select from, and a form display 24 of possible forms that the agent may select from corresponding to the particular controlled form issuing provider selected in the provided display. As will be understood by those of ordinary skill in the art, the providers, controlled form categories and forms may be individualized for each agent.

The agent first selects a controlled form issuing provider (e.g., insurer) in the provider display 23 which causes the forms of the selected provider to be displayed in the form display 24. As shown in Box 1.4, the user then selects a form from the displayed list of forms. As an option, at this point the computer system may check to see if the agent computer 14 is connected to a printer compatible with the system. If the printer connected to the agent computer 14 is determined to be incompatible, a pair of radio button selections (e.g., “Mail” and “FedEx”) may be displayed on the main menu 22 for permitting the agent to select how the completed controlled form will be transmitted. Upon selection of one of the radio buttons (e.g., Mail and FedEx), the agent computer 14 may transmit a corresponding signal to the WEB server computer 10 indicating the selections. The WEB server computer 10 may, in turn, transmit a signal to the application server computer 11, notifying the controlled form issuer of how the controlled form will be provided to the agent. If for example, the “FedEx” radio button is selected, a field prompting the agent to enter their Federal Express Billing ID may appear on the visual display 16 of the agent computer 14.

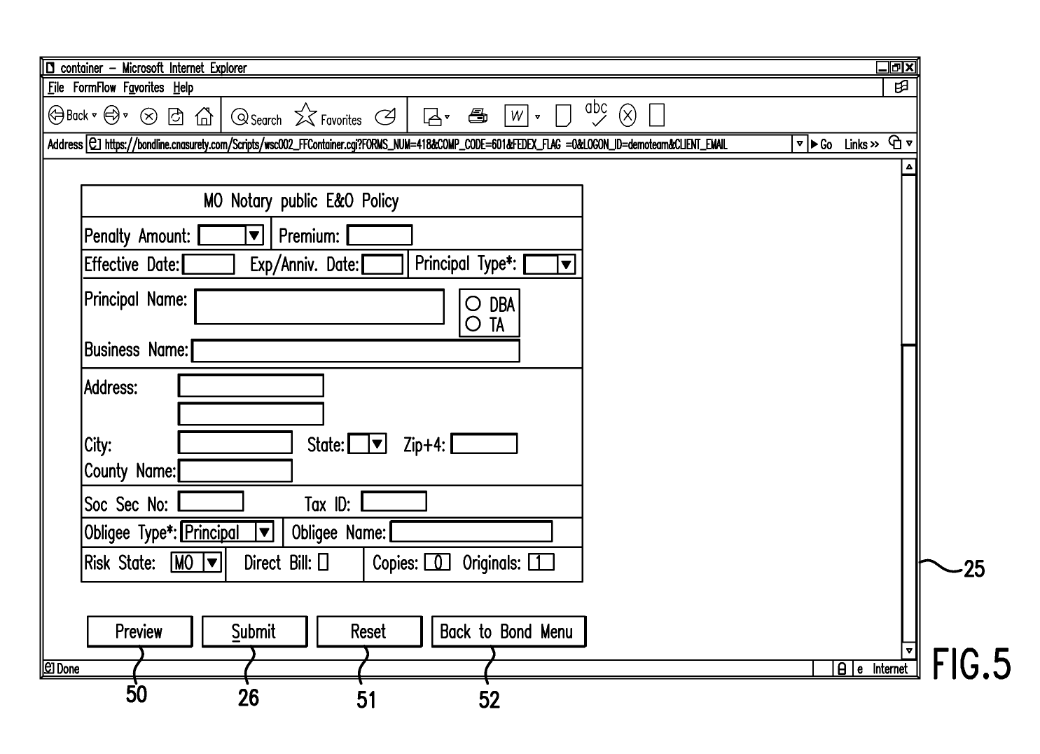

Upon selection of a form by the agent, a data entry screen 25 may be displayed which corresponds to the selected form. FIG. 5 illustrates an exemplary data entry screen which may be displayed to the agent on the visual display 16 of the agent computer 14. The data entry screen may include a plurality of individual fields, and may also include embedded default values and calculations corresponding to the selected form. The agent may enter the appropriate data information into the appropriate individual fields of the data entry screen of the selected form, as shown in Box 1.5 of FIG. 2. As will be understood by those of ordinary skill in the art, drop down menus and help screens may also be provided on the data entry screen to assist the agent in completing the data entry.

The data entry screen 25 may also include a Submit button 26 displayed thereon. Upon completion of the entries of data information into the individual fields, the agent may select the Submit button 26, as shown in Box 1.6 of FIG. 2. The computer system may then verify the entries to ensure that all the required fields for the particular form are complete and valid. For example, if the agent has not entered any information in a required field, the agent may be presented with a corresponding message on the visual display 16 of the agent computer 14 (e.g., “Information is missing. Please provide.”). Once the information has been validated, the agent computer 14 may then transmit such information to the WEB server computer 10, along with information indicating the selected form, as shown in Box 1.7 of FIG. 2.

The data entry screen 25 may also include fields for permitting the entry of risk-scoring information, as discussed in detail below. Additionally, the data entry screen 25 may include a “Preview” button 50 which permits the agent to view a preview of how the form will look before submitting it to the controlled form issuer for processing. The data entry screen 25 may also include “Reset” and “Back” buttons 51, 52 for clearing the entered information, and returning to the provider display screen shown in FIG. 4.

Next, as shown in Box 1.8, upon receipt from the agent computer 14, the WEB server computer 10 then validates the entered data information to determine whether the entered data information exceeds the limits of the selected form and/or the agent's authorized limit (e.g., coverage limits). As illustrated in FIG. 2, if the entered data information exceeds the limits of the selected form and/or the agent's authorized limit, the WEB server computer 10 may transmit the entered data information to the application server computer 11 for further processing. The WEB server computer 10 may also transmit a signal to the agent computer 14 which, upon receipt of the signal, may display a message on the visual display 16 of the agent computer 14 notifying the agent that the entered data has been submitted as an application instead of a controlled form and will reviewed by the controlled form issuer, as shown in Box 1.9. Turning to Box 1.10, the application server computer 11 may then transmit the entered data information exceeding the limits of the selected form and/or the agent's authorized limit to the internal workflow system 12 to be approved or rejected by the controlled form issuer.

As illustrated in Box 1.11 of FIG. 2, if the agent does not exceed the limits of the selected form and/or the agent's authorize limit, the WEB server computer 10 communicates with the agent computer 14 to determine whether the printer 18 of the agent computer meets minimum requirements for printing a controlled form. If the printer 18 of the agent computer 14 does not meet the minimum requirements for printing a controlled form, a message may be displayed on the visual display 16 of the agent computer to acknowledge the submission of the controlled form and transmission of the entered data information to the application server computer 11. In the next step, Box 1.12, the application server computer 11 may print a controlled form corresponding to the entered data of the selected form upon receipt thereof. Such printed controlled form may then be transmitted to the agent through various non-electronic means, such as U.S. Mail, Federal Express (FedEx), DHL, UPS, or any other equivalent means known to those of ordinary skill in the art.

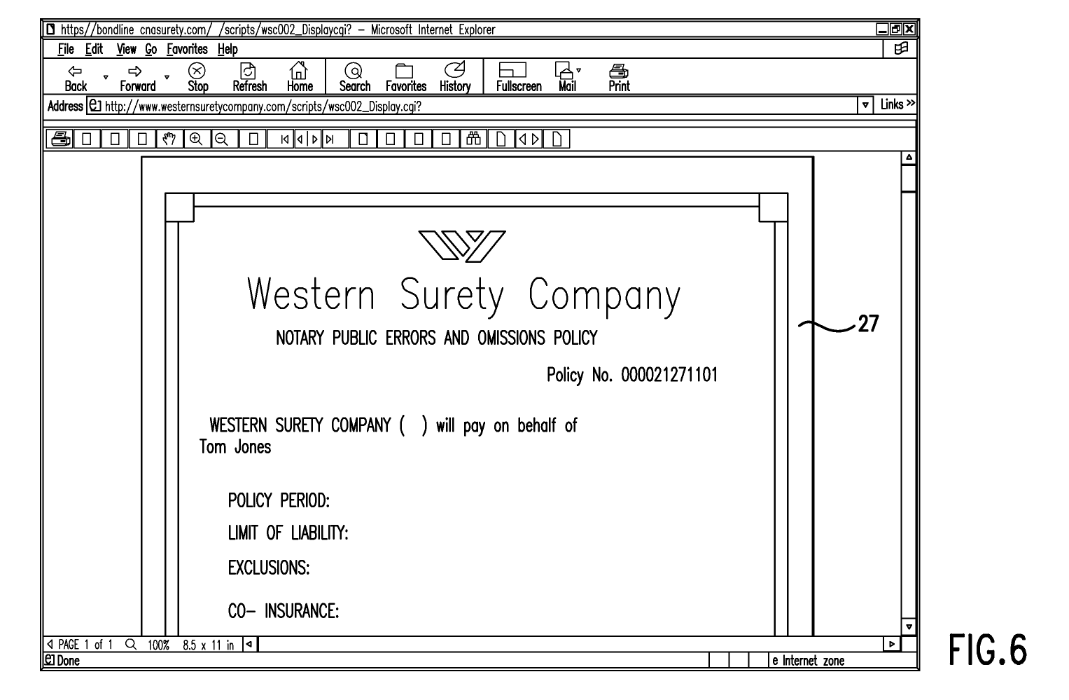

On the other hand, if the printer 18 of the agent computer 14 does meet the minimum requirements for printing a controlled form, a completed controlled form corresponding to the entered data of the selected form is transmitted (such as, for example, in PDF format) to the agent computer as shown in Box 1.13. An image of the transmitted completed controlled form 27 may also be displayed on the visual display 16 of the agent computer 14, as shown in FIG. 6. The agent may then print the completed controlled form with the printer 18 of the agent computer 14 so that the completed controlled form may be delivered to the agent's customer (i.e., principal) immediately. The system may additionally generate (along with the form) an invoice which may be given to the applicant along with the completed controlled form.

At around the same time the completed controlled form is being transmitted to the agent computer 14, the web server 10 may also generate and transmit a data packet or report file, indicating the issuance of the completed controlled form, to the application server 11 and internal workflow system 12, for further processing. For example, the data packet or report file may be uploaded to a database within the internal workflow system 12, and used in generating reports of form issuing activity for a particular time period. This process allows the agent to report all controlled form business electronically to the controlled form issuer, and therefore not have to provide paper copies of the created controlled forms, or to maintain a log of completed controlled forms. In addition to the report, the web server 10 and/or application server 11 may generate one or more images associated with the controlled form, and store such images in the internal workflow system 12 for reference purposes. For example, if the form is issued without review, an image of the controlled form (in, for example, PDF, JPEG, TIFF or other known format) may be generated and stored in the internal workflow system 12. If the form is submitted for further review, an image of the application may be generated and stored in the internal workflow system 12.

Once the completed controlled form has been printed, the application server computer 11 may then transmit the completed controlled form to the internal workflow system 12 as an executed controlled form, as shown in Box 1.14 of FIG. 2. The controlled form issuer may then review the executed controlled form to ensure that all of the proper supporting documentation has been sent from the agent to the controlled form issuer. Once the information has been verified by the controlled form issuer, an image of the entered data information and executed controlled form may then be stored in the workflow system 12. Subsequently, as depicted in Box 1.15, the workflow system 12 may transmit the entered data information into a legacy computer system 9 in communication with the workflow system. Those of ordinary skill in the art will understand that the workflow system 12 may comprise one or more computers associated with the controlled form issuer. For example, the workflow system 12 may comprise a server computer with a memory for storing data and controlled forms which may be accessed by one or more client computers operated by employees of the controlled form issuer.

Although the transfer of information and completed control forms to the legacy computer system 9 is described above as taking place through an intermediate workflow system 12, such information and completed control forms may alternatively be passed directly from the application server 11 to the legacy computer system 9, as shown in FIG. 1. The benefit of such a system is that the legacy computer system 9 may be continually updated in real-time. In such a system, errors and discrepancies in the entered information or controlled forms may be identified through software running on the application server 11, and may be remedied in real-time.

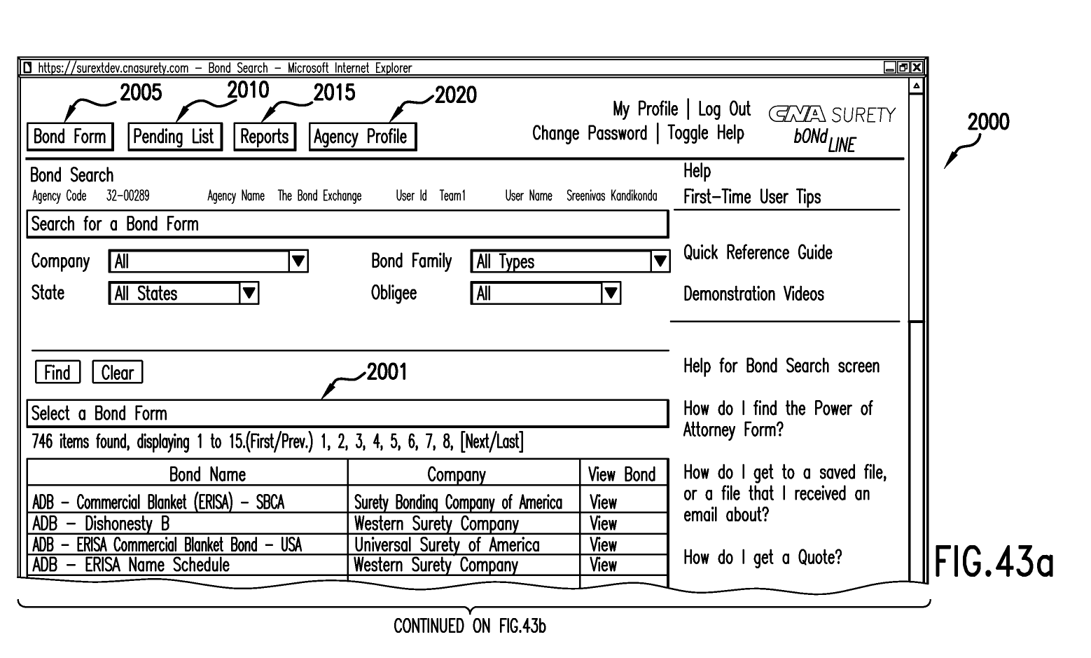

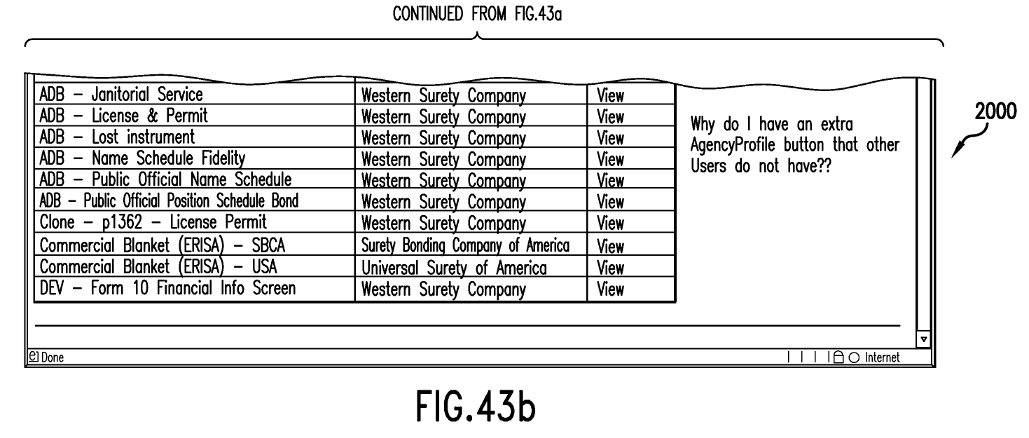

FIG. 43 shows illustrates an exemplary Form Search Screen 2000 which may be displayed on the visual display 16 of an agent computer 14 as an alternative to the main menu 22 described above. Similar to the main menu 22, the Form Search Screen 2000 allows a user (e.g., agent) to select a form to issue, and monitor the status of the form through the issuance process. The method for issuing and monitoring a form using the Form Search Screen 2000 is similar to the method described above with regard to FIG. 2. For ease of reference, FIGS. 43-48 described below show screens associated with issuing a bond, but those of ordinary skill in the art will realize that any type of controlled form may be issued and monitored using the process described below.

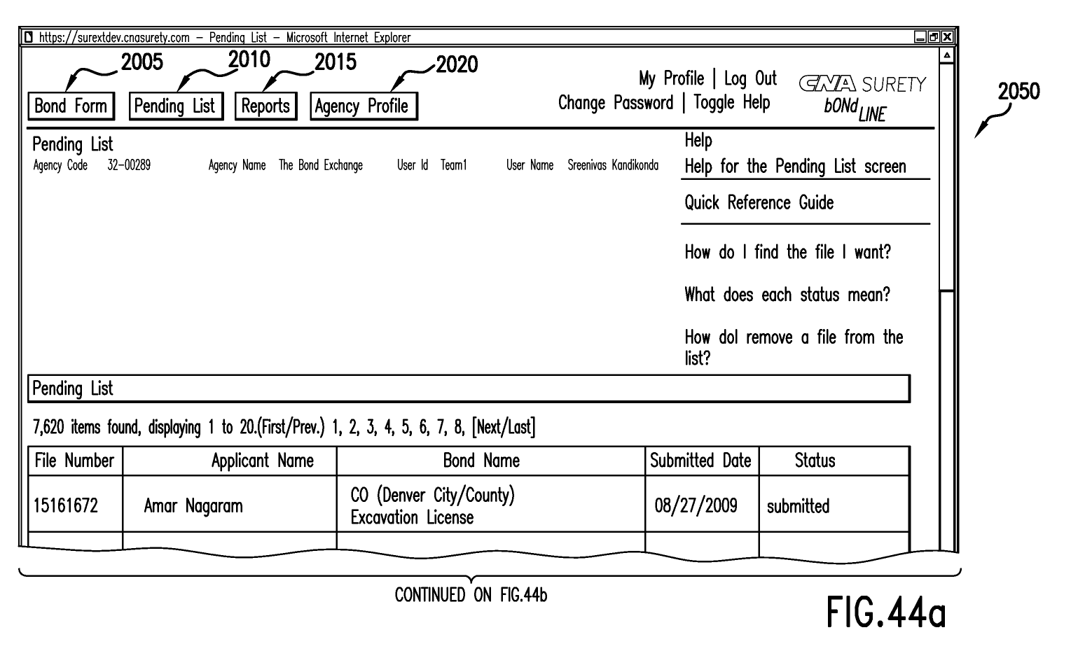

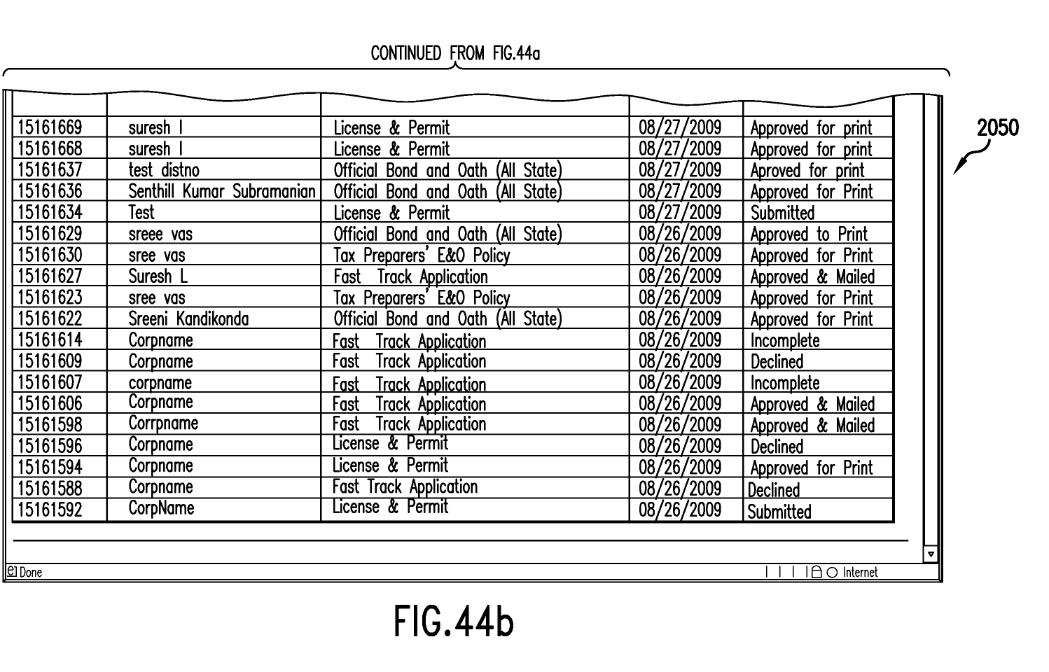

The Form Search Screen 2000 may comprise a screen of a form issuance system which permits agents associated with the controlled form issuer (e.g., insurer) to, among other things, apply for bonds and monitoring pending form status. Other screens of the exemplary form issuance system are described below in connection with FIGS. 44-48. For example, the form issuance system may be implemented as a separate program module of the software which implements the primary processes described above with reference to FIG. 2, or it may replace certain portions of that software, such as the portions relating to the issuance and monitoring of controlled forms. In short, the form issuance system may comprise a software program which may be stored within the computer system (e.g., resident on the agent computer 14 or any of the server computers 10, 11) which permits agents associated with the controlled form issuer to issue controlled forms (e.g., bonds) in real-time, where approval of the controlled form issuer is not required. Where approval of the controlled form issuer is required, the form issuance system permits real-time communications with underwriting personnel of the controlled form issuer, so that controlled forms may be issued by the agent as quickly and efficiently as possible. To accomplish the above-referenced functions, the form issuance system may include a Forms menu 2005, a Pending List menu 2010, a Reports menu 2015, and an Agency Profile menu 2020, as shown on the Form Search Screen 2000 of FIG. 43.

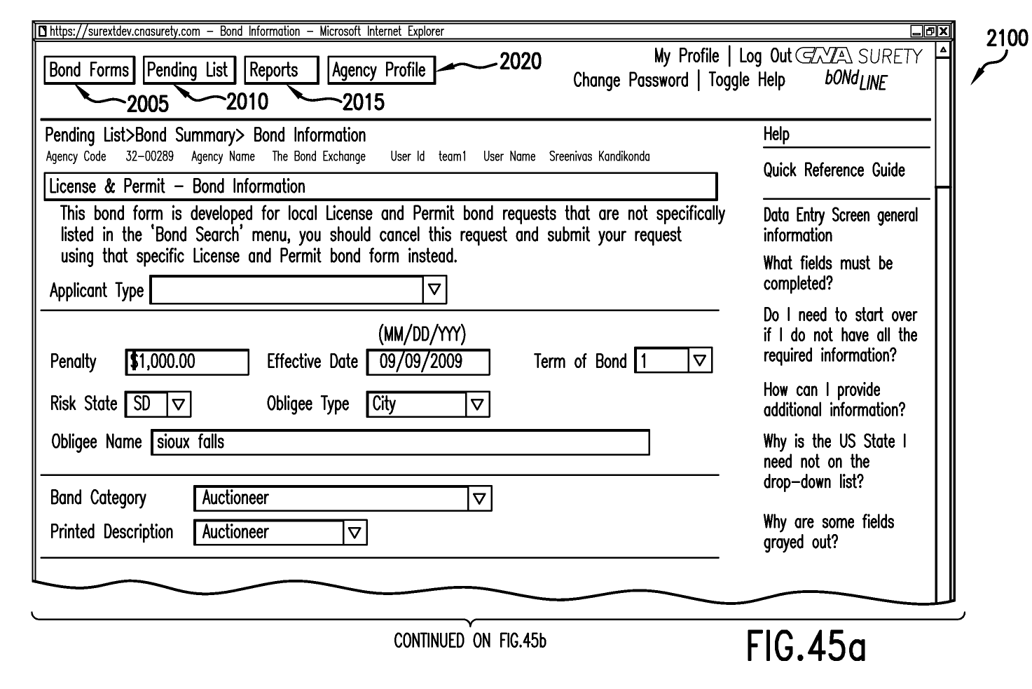

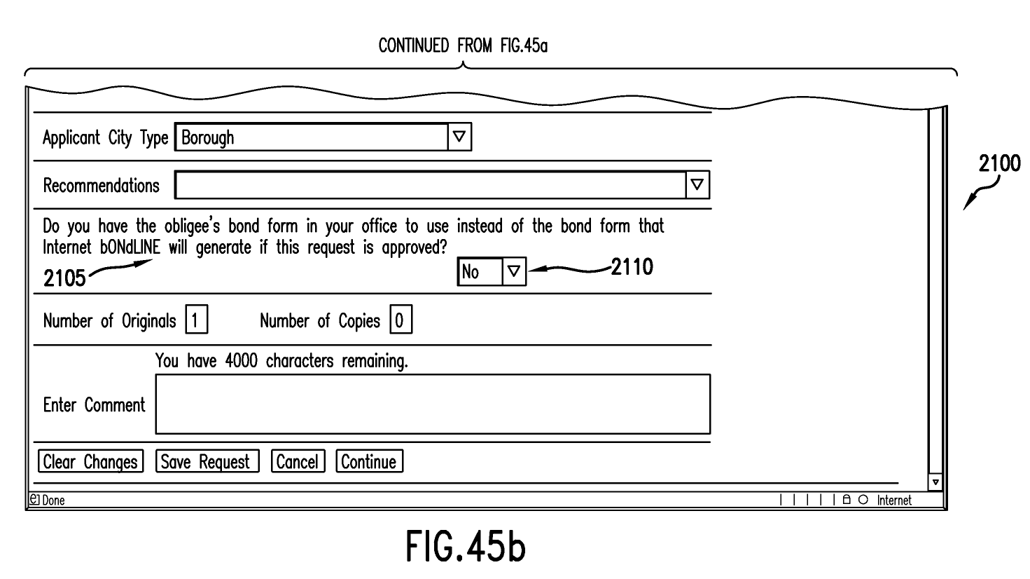

The Form Search Screen 2000 may be displayed on the visual display 16 of an agent computer 14 by the user (e.g., agent) selecting the Forms menu 2005, and then selecting, for example, the term “Form Search” from a drop-down sub-menu. The user may implement the form search by selecting various keywords and filters, as is well known in the art. As shown in FIG. 43, the user may search for “all” bonds available to the user, and the search will return all available bonds. Any bonds matching the search criteria will be displayed in a results table 2001. From the results table 2001, a particular form may be selected by, for example, clicking on the form name in the results table, which may be hyperlinked to a form information entry form, so that the user can immediately begin entering the information for issuing the form. FIG. 45 described below shows an exemplary Form Information Entry Screen 2100.

FIG. 44 shows an exemplary Pending List Screen 2050 which may be displayed on the visual display 16 of an agent computer 14 by the user (e.g., agent) selecting the Pending List menu 2010. The Pending List Screen 2050 may include a listing of all controlled forms (e.g., bonds) associated with a particular agency, and the status of each form (e.g., “Submitted,” “Approved,” “Declined,” “Pending,” etc.). Each form shown on the Pending List Screen 2050 may be hyperlinked to a page showing detailed information for the form, so that a user may go back and review previously issued forms, and perform further work on forms still in progress.

FIG. 45 shows an exemplary Form Information Entry Screen 2100 which may be displayed on the visual display 16 of an agent computer 14 by the user (e.g., agent) selecting a hyperlinked form from the Pending List Screen 2050, or by the user selecting the a hyperlinked form from the results table 2001 of the Form Search Screen 2000. The Form Information Entry Screen 2100 may include a plurality of fields into which the user may enter information necessary for issuing the form. For example, the Form Information Entry Screen 2100 may include fields, drop-down menus, etc. for Penalty Amount, Obligee Name, Risk State, etc., as shown in FIG. 45. To assist in the issuance of bonds which are not included within the computer system, the Form Information Entry Screen 2100 may include a data field 2105 which queries the user “Do you have the obligee's bond form in your office to use instead of the bond form that Internet Bondline will generate if this requested is approved?,” along with a “Yes/No” drop-down menu 2110. This data field 2105 can be particularly useful in cases where an obligee does not permit their forms to be computerized. For example, some obligees who are government or municipal entities may not permit their forms to be reproduced by others, which means that the forms still need to be filled out by hand at some point. By using the data field 2105 of the Form Information Entry Screen 2100, all the information for the form may be entered into the computer system (and saved for later use), and then the hard copy form can be used rather than a form printed from the computer system.

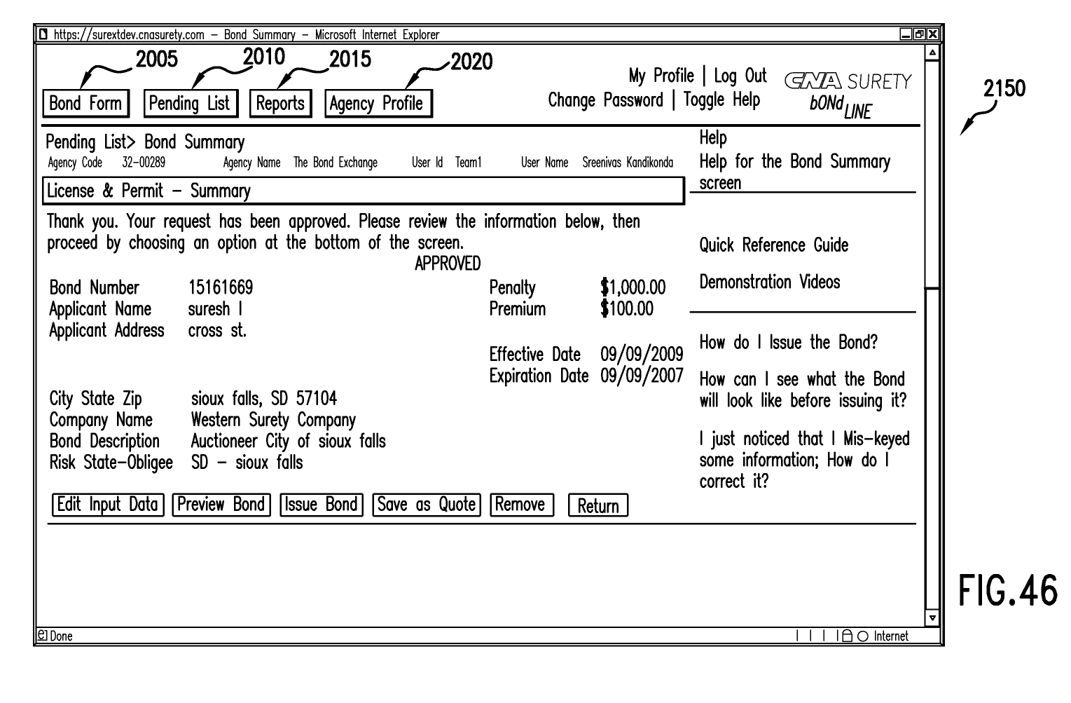

FIG. 46 shows an exemplary Form Summary Screen 2150 for an approved form which may be displayed on the visual display 16 of an agent computer 14 by the user (e.g., agent) selecting a hyperlinked form from the Pending List Screen 2050. The exemplary form selected and shown on the exemplary Form Summary Screen 2150 has an “approved” status, and is suitable for printing and delivering to the principal. To issue the form, the user may select a “Issue Bond” button from the Form Summary Screen 2150, which may cause a PDF, JPEG, or other suitable computerized version of the form to be generated on the visual display 16 of an agent computer 14 for viewing and printing. The Form Summary Screen 2150 may also include additional buttons for performing other functions associated with the form, such as an “Edit Input Data” button (for editing the form data), “Preview Bond” button (for viewing a preview of the printed version of the form), “Save as Quote (for saving the form information for quote purposes), “Remove” button (for removing the form from the Pending List Screen 2050), and a “Return” button (for returning to the Pending List Screen 2050). As noted above, when a controlled form is issued, the web server 10 and/or application server 11 may generate one or more images associated with the controlled form, and store such images in the internal workflow system 12 for reference purposes. For example, if the form is issued without review, an image of the controlled form (in, for example, PDF, JPEF, TIFF or other known format) may be generated and stored in the internal workflow system 12.

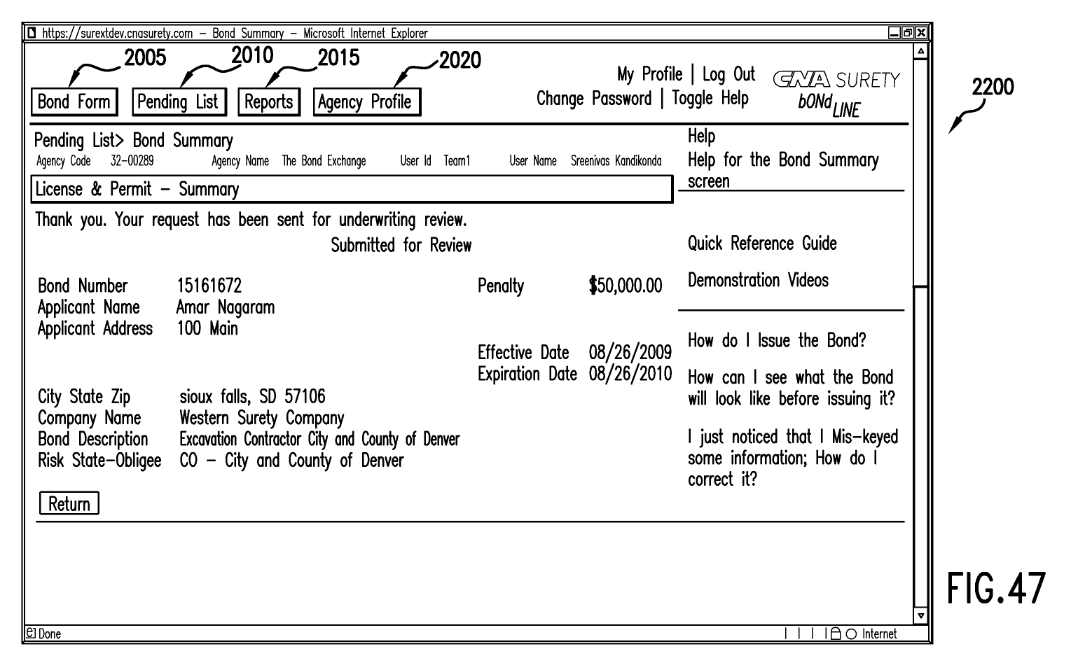

FIG. 47 shows an exemplary Form Summary Screen 2200 for a form submitted for further review which may be displayed on the visual display 16 of an agent computer 14 by the user (e.g., agent) selecting a hyperlinked form from the Pending List Screen 2050. The exemplary form selected and shown on the exemplary Form Summary Screen 2150 has an “submitted for review” status, and is awaiting further approval from an employee of the controlled form issuer (e.g., underwriter). Because the form cannot be issued at this point, the Form Summary Screen 2200 only includes a “Return” button (for returning to the Pending List Screen 2050). As discussed above, when a controlled form is submitted for review, the web server 10 and/or application server 11 may generate one or more images associated with the controlled form, and store such images in the internal workflow system 12 for reference purposes. For example, if the form is under review, an image of the controlled form application (in, for example, PDF, JPEF, TIFF or other known format) may be generated and stored in the internal workflow system 12. When a controlled form is indicated as having “submitted for review” status on the Form Summary Screen 2200, one or more employees of the controlled form issuer will preferably receive an e-mail indicating that review of the controlled form is required. Such employees may then use an agent computer 14 to access the computer system, review the request, and take some action (e.g., approve, decline, submit for additional review, etc.). The approval process for controlled form that are submitted for review is carried out by the underwriters' system, which is described further below.

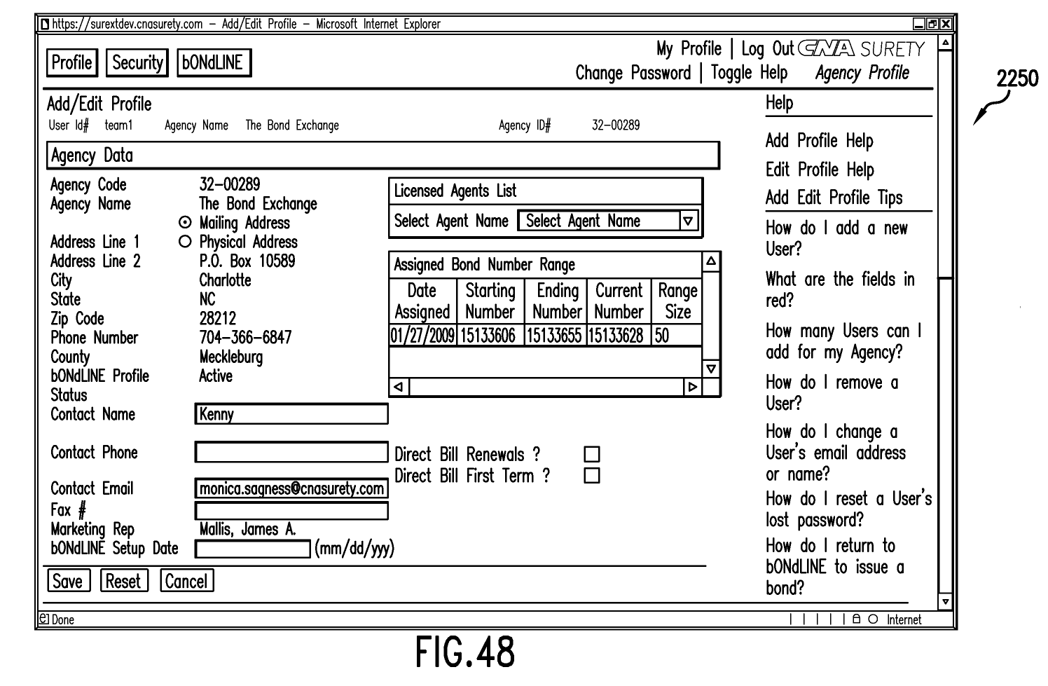

FIG. 48 shows an exemplary Agency Profile Screen 2250 which may be displayed on the visual display 16 of an agent computer 14 by the user (e.g., agent) selecting the Agency Profile menu 2020. The Agency Profile Screen 2050 may include a plurality of fields, drop-down menus, etc., which include information for a particular agency. Preferably, the agency which is presently logged into the computer system (e.g., “The Bond Exchange”) can only access their own information, and not the information of other agencies. From the Agency Profile Screen 2050, certain employees of the specified agency (e.g., agency administrators) may view the agency information and make appropriate changes.

### Second and Third Exemplary Embodiments

FIGS. 7a and 7b illustrate, respectively, second and third exemplary embodiments of the present invention for creating and reporting controlled forms. FIG. 7a shows a computer system according to second exemplary embodiment of the present invention which includes at least one agent computer 28. The agent computer may include a visual display 29, a user interface 32 (such as keyboard), and may also have a printer 30 coupled thereto. In the second exemplary embodiment, a program containing instructions for performing the steps described below with reference to FIGS. 8-15 may be included on a hard drive of the agent computer 28, or may be coupled to the agent computer through a removable media device (e.g., CD-ROM, DVD, Thumb Drive, Memory Card, etc.). FIG. 7b shows a computer system according to third exemplary embodiment of the present invention which includes one or more agent computers 28, each including a visual display 29, and a user interface 32 (such as keyboard). The agent computers 28 may be coupled, for example through Local Area Network (LAN) cables, to a server computer 31, which may have a centralized printer 30 coupled thereto. In the third exemplary embodiment, a program containing instructions for performing the steps described below with reference to FIGS. 8-15 may be included on a hard drive of either the agent computer 28 or the server computer 31, or may be coupled to the agent or server computers through a removable media device (e.g., CD-ROM, DVD, Thumb Drive, Memory Card, etc.).

The computer systems according to the second and third exemplary embodiments of the present invention contemplate the presentation of only one controlled form issuer to each agent. This is as opposed to the computer system according to the first exemplary embodiment, where the agent may select a controlled form issuer from a provider display 23, prior to selecting forms. Thus, computer systems according to the second and third exemplary embodiments of the present invention are preferably implemented internally to a single controlled form issuer (e.g., insurer). For example, the computer system according to the third exemplary embodiment may be implemented in a main office of the controlled form issuer (where various agents are disposed throughout a facility, such that sharing software and a printer makes sense), and the computer system according to the second exemplary embodiment may be implemented in a satellite office of the controlled form issuer (where only one or two agents may be disposed).

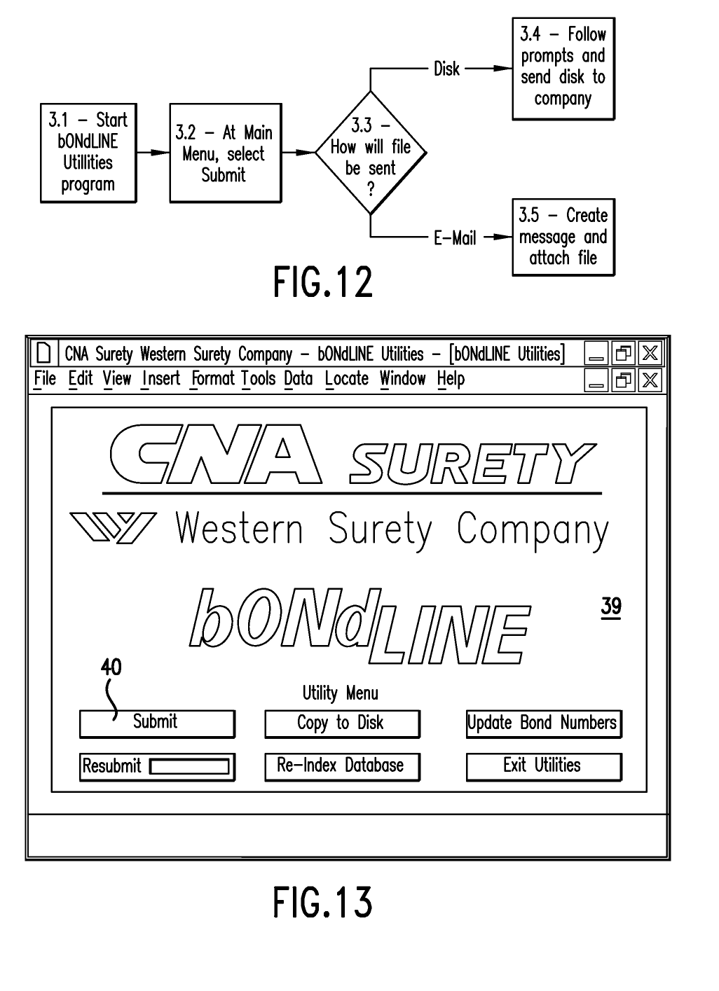

FIG. 8 is a flow diagram of the controlled form creation process of the second and third exemplary embodiments of the present invention. As with the method according the first exemplary embodiment, the method shown in FIG. 8 (and the method shown in FIG. 12 and discussed below) may be implemented through software, including one or more program modules, resident on the agent computer 28 in the second exemplary embodiment, or resident on the agent computer or server computer 31 in the third exemplary embodiment. In either of the second or third exemplary embodiments, the software may be accessed by selecting an icon displayed on the desktop of the agent computer 28, as will be understood by those of ordinary skill in the art. Alternatively, the software may be accessed by the agent computers 28 through a browser program (e.g., Microsoft Internet Explorer®) resident on the agent computer.

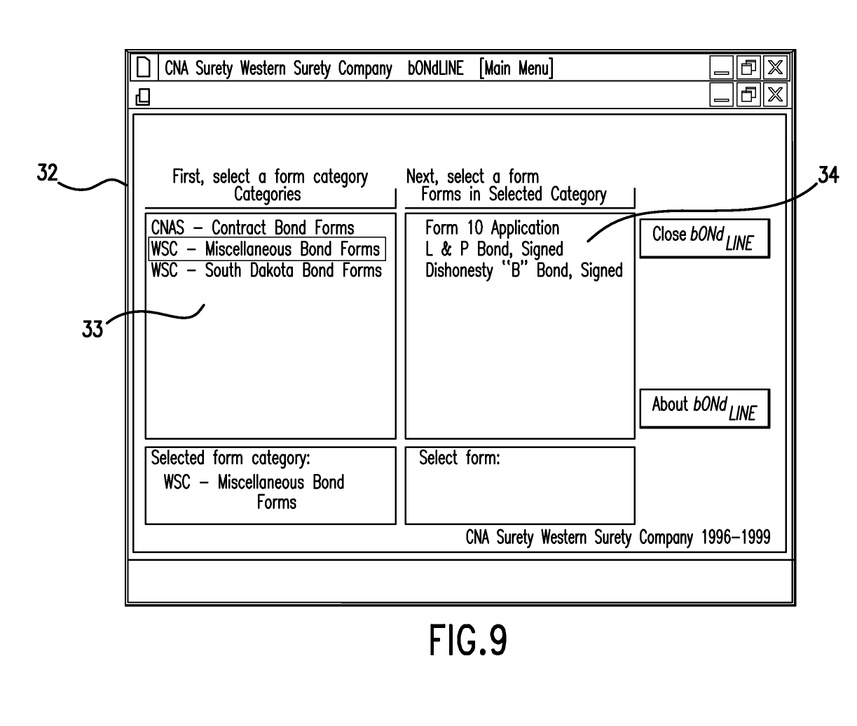

Upon initiation of the program at the agent computer 28 (Box 2.1), a main menu for selecting a controlled form to be created may be displayed on the visual display 29 of the agent computer 28. As illustrated in FIG. 9, the main menu 32 may have plurality of display boxes including a form category display 33 of possible controlled form categories that the agent may select from, and a form display 34 of possible forms that the agent may select from corresponding to the particular controlled form category selected in the form category display. As will be understood by those of ordinary skill in the art, the controlled form categories and forms may be individualized for each agent.

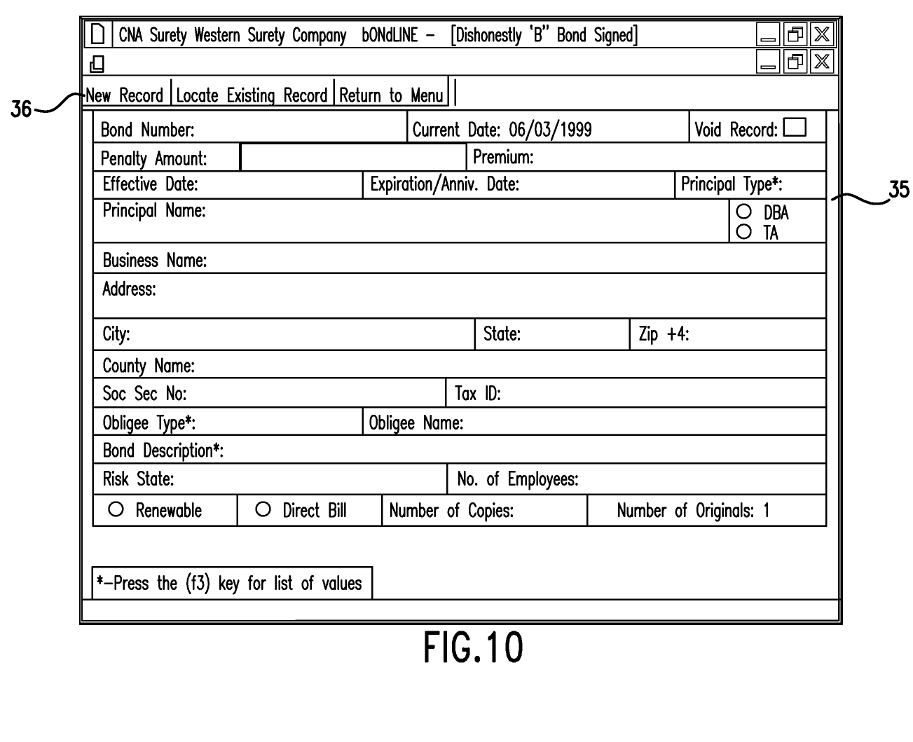

The agent begins by selecting a controlled form category (Box 2.2) which leads to displaying in the form display all the provided forms of the selected controlled form category. Upon selection of a form (Box 2.3), a data entry screen 35 may be displayed on the visual display 29 of the agent computer 28 that corresponds to the selected form, as illustrated in FIG. 10. The data entry screen 35 may have a plurality of individual fields, and also may include embedded default values and calculations corresponding to the selected form similar to that used in the data entry screens of the first exemplary embodiment of the present invention. The selected data entry screen 35 may be directly related to the controlled form that will print. This allows for simple data entry skills rather than requiring the agent to have specific controlled form knowledge. In other words, the person entering the data onto the form does not need to be familiar with the all of the procedures required complete the particular form.

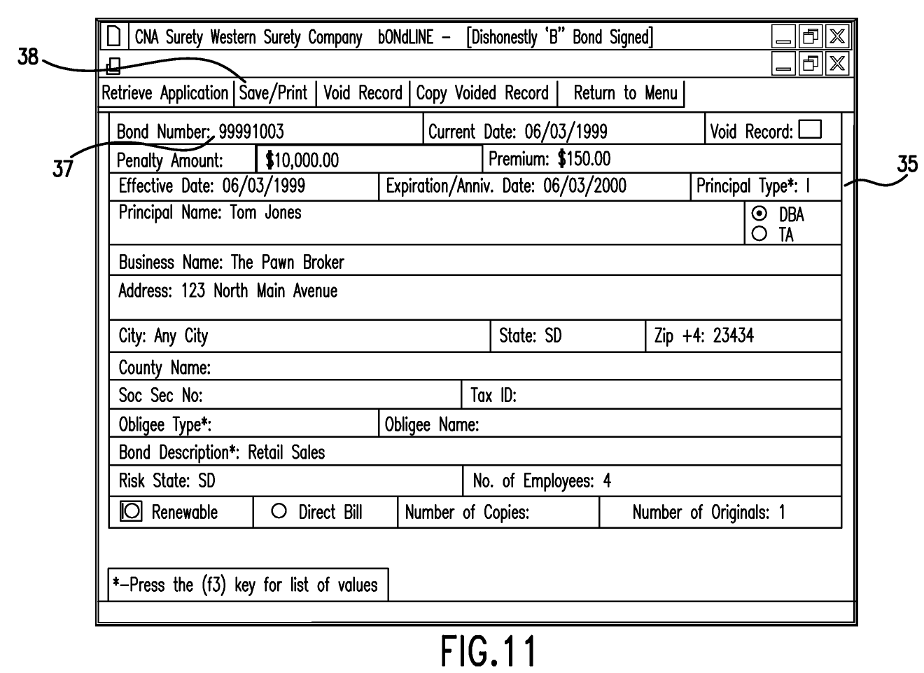

Each controlled form may include at least one encrypted controlled form number file, which may be displayed on the controlled form presented to the agent on the visual display 29 of the agent computer 28. The data entry screen 35 may also have a “New Record” button 36 displayed thereon. Selection of the New Record button may operate to create a new form record, and assign an encrypted controlled form number to the new record. As illustrated in FIG. 11, the assigned controlled form number (e.g., “99991003”) may be displayed on the selected data entry screen in a controlled form number field 37 of the selected data entry screen 35.

It will be noted by those of ordinary skill in the art that the method described above in connection with FIG. 8 provides for the electronic assigning of controlled form numbers to the selected data entry sheet (and thereby the created controlled form), rather than requiring the agent to have a pad of pre-numbered Power of Attorney forms, or a list of controlled form numbers that the agent must enter manually into the selected data entry sheet.

Returning to FIG. 8, Box 2.5 shows the step of the agent entering data information associated with the controlled form into the appropriate individual fields of the data entry screen 35. As shown in FIG. 11, such fields of the data entry screen may include Date, Premium, Penalty Amount, Principal Name, Obligee Name, Obligee Type, Risk State, etc. As with the computer system according to the first exemplary embodiment of the present invention, default values and calculations may be built into the screen and individual fields to ensure all required fields are filled out by the agent. Additionally, drop down menus and help menus may also be displayed on the selected data entry screen 35 to assist the agent in completing the data entry.

The data entry screen 35 may also include a “Save/Print” button 38 displayed thereon. After completing the entries of data information into the individual fields, the agent may select the Save/Print button (Box 2.6). After selection of the Save/Print button, the computer system verifies the entries to ensure that all the required fields for printing of the particular form are complete and valid. The computer system then stores the entered data information of the selected form in a storage medium of either the agent computer 29 (in the second and third exemplary embodiments) or the server computer 31 (in the third exemplary embodiment only). The entered data information may then be merged with the selected controlled form, and the merged controlled form printed with the printer 30 of the agent computer 29 or server computer 31.

FIG. 12 is a flow diagram showing the execution a utility menu routine according to the second and third exemplary embodiments of the present invention. The utility menu routine may be executed from a utility menu (shown in FIG. 13), which may be accessed from the main menu 32, or may be provided via a separate program icon on the desktop of the agent computer 28 as described below. The utility menu routine may be executed after completion of at least one controlled form as described above in connection with FIG. 8.

Selection of a Utilities icon from the desktop of the agent computer 14 starts the utility menu routine (Box 3.1). This leads to a utility menu display 39 on the visual display 29 of the agent computer 28, as illustrated in FIG. 13. The utility menu screen 39 may have a “Submit” button 40 displayed thereon. Upon selection the Submit button (Box 3.2), the computer system may reads the database file or files where the records corresponding to the created controlled forms were stored during the Save/Print process described above. This routine then looks for all records created since the last time the routine was run, and a report is then created corresponding to the retrieved entered data information. This report indicates to the agent which stored records are selected for transmission to the controlled form issuer. A report file may be created into which the created report may be stored. This routine allows the agent to report all the controlled form business electronically to the controlled form issuer, and therefore not have to provide paper copies of the created controlled forms, or to maintain a log of completed controlled forms.

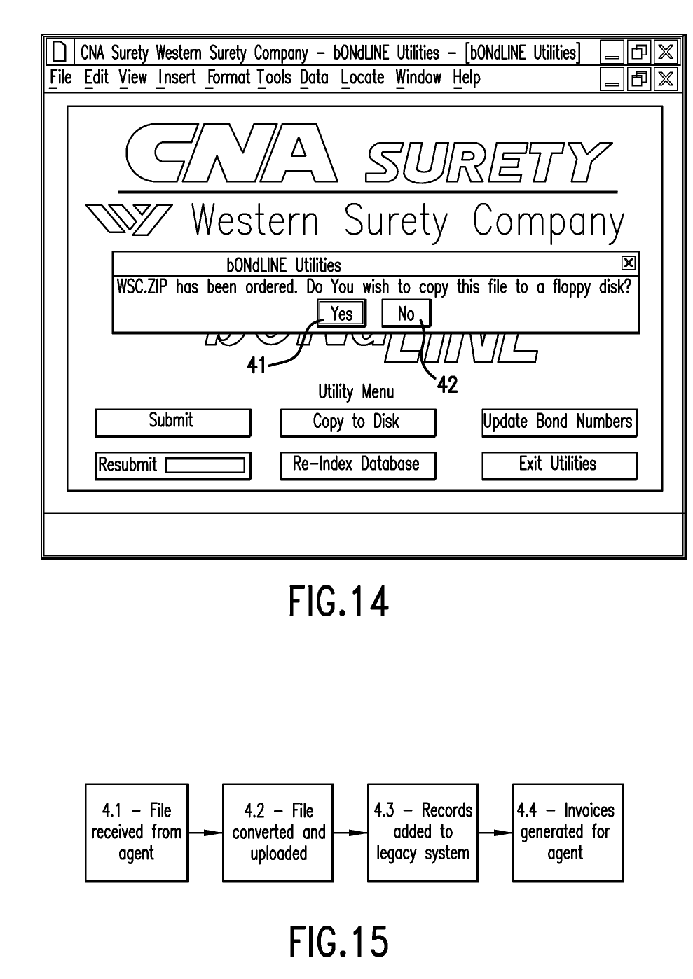

As depicted in Box 3.3 of FIG. 12, the agent may select a computer readable medium for transmitting the report file. As illustrated in FIG. 14, a first button 41 (e.g., a “Yes” button) may be displayed on the visual display 29 of the agent computer 28 for storing the report file to a transportable computer readable medium (e.g., CD-ROM, Thumb Drive, etc.) and a second button 42 (e.g., a “No” button) may be displayed on the visual display for transmitting the report file via a communication network (e.g., the Internet via e-mail).

If the agent selects the first button, the computer system performs a subsequent storing routine and stores the report file to a transportable computer readable medium (Box 3.4) which the agent then mails or otherwise delivers to the controlled form issuer. If the agent selects the second button, the routine is ended and the report file is transmitted to the controlled form issuer via e-mail across the communication network (Box 3.5).

With reference to FIG. 15, in either situation (i.e., Box 3.4 or Box 3.5), the report file may then be received by the controlled form issuer (Box 4.1). If the controlled form issuer so chooses, it may start an upload to a legacy system (e.g. a mainframe computer) of the report file. First, the report file may be stored in a server computer of the controlled form issuer. The data in the report file is checked, and if the data is error free, the records within the report file are placed on the legacy system with no human intervention as an active record (Boxes 4.2, 4.3). If the data needs further cleaning up, the records may be placed on the legacy system with a “New Pending” status. Once all records have been converted and uploaded to the legacy system, the controlled form issuer may print one or more invoices that may be sent to the agent (Box 4.4). The invoice may show all the business uploaded for that particular agent for a particular time period, and the corresponding fees due for each form applicant (i.e., principal).

### Risk-Scoring System

Any of the first through third exemplary embodiments of the present invention described above may optionally include a risk-scoring system which permits the agents issuing the controlled forms (e.g., bonds) to assess the risk associated with a particular form applicant (i.e., principal), and select an appropriate provider, form and/or premium based on the result of the risk-scoring. For example, the risk-scoring system may be implemented as a separate program module of the software which implements the primary processes described above with reference to FIGS. 2 (first exemplary embodiment), 8 and 12 (second and third exemplary embodiments). In short, the risk-scoring system comprises a software program which may be stored within the computer system (e.g., resident on the agent computers 14, 28 or server computers 10, 11, 31) which permits certain agents to perform risk assessments, and view and share such risk assessments with the controlled form issuer.

Preferably, the risk-scoring process takes places in real-time, so that the controlled form issuance process is not delayed while the agent awaits a risk score. For example, the agent may enter risk information corresponding to a person or entity into fields of a data entry screen. Once the agent selects to submit the risk information for processing (by, for example, selecting a “Calculate Risk” button on the display 16 of the agent computer 14), a calculation is performed and the agent is presented with the risk-scoring results (again, on the display 16 of the agent computer 14). These results may then be used for a variety of purposes, including, adjusting the premium applied to the selected controlled form.

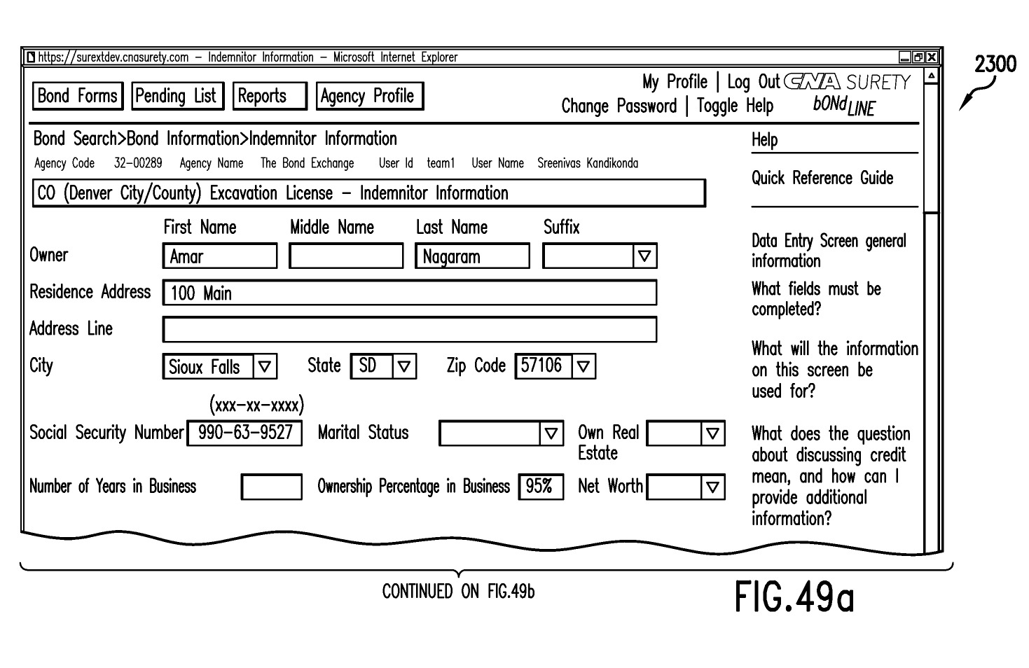

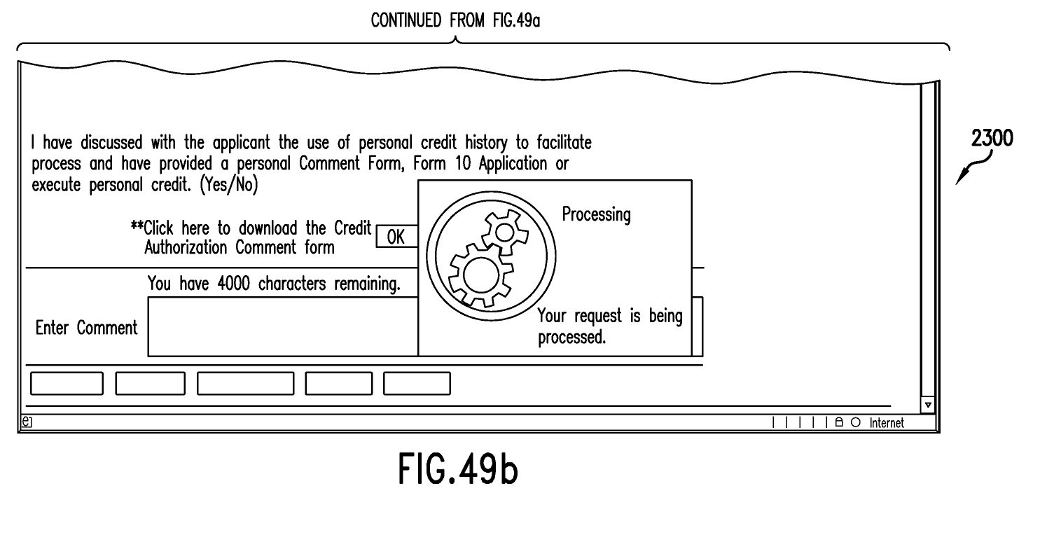

FIG. 49 shows an exemplary Risk Scoring Screen 2300 which may be displayed on the visual display 16 of an agent computer 14 by the user (e.g., agent) when the system determines that risk-scoring is required for the form. As discussed below in connection with the agency profile and manage forms systems, risk-scoring may be required when an agent requests an amount for the controlled form (e.g., penalty amount) which falls within a range specified by the controlled form issuer. The Risk Scoring Screen 2300 may include various fields for permitting the entry of information about the applicant for the principal, such as Name, Address, Social Security Number, Net Worth, etc. The Risk Scoring Screen 2300 may also include various buttons for assisting the user in entering the risk information, such as a “Back” button (for returning to the previous screen of the form application), a “Clear” button (for clearing all entered risk-scoring information), a “Save Request” button (for saving the entered risk-scoring information for later transmission), a “Cancel” button (for canceling the entry of risk-scoring information and returning to the previous screen of the form application), and a “Continue” button (for submitting the entered risk-scoring information to a third party for processing). If the user enters the appropriate risk-scoring information and selects the “Continue” button, the Risk Scoring Screen 2300 may present a pop-up window letting the user know that the information is being processed (as shown in FIG. 49). As discussed above, if the entered risk-scoring information produces a result which is within the acceptable limits established by the controlled from issuer, the form will be approved instantaneously. Approval may be indicated to the user through the presentation of a Form Summary Screen 2150, as discussed above in connection with FIG. 46.

With regard to risk-scoring of the applicant for the principal for the issuance of a controlled form (e.g., bond), certain decisions made by the agent may influence the performance of the risk-scoring. As illustrative examples, and not by way of limitation, an agent may select one controlled form issuer over another because of risk rules associates with each controlled form issuer, the agent may select one controlled form over another because of the risk rules associated with the controlled form. Additionally, the computer system according to any one of the first through third exemplary embodiments may employ some form of decision logic (e.g., software) to determine if risk-scoring is necessary, or if the agent may proceed without the performance of the risk-scoring. If the agent determines, for whatever reason, that one controlled form issuer should be used, along with an associated controlled form, the system may allow the agent to proceed without risk-scoring based upon the agents level of authorization, based upon some segment of the form applicant information, based upon the form, or based upon the risk rules. Alternately, the system may require risk-scoring, if for no other reason than to determine the appropriate cost of the controlled form being issued. Further, the computer systems according to the first through third exemplary embodiments of the present invention may also contemplates the agent having the discretion to request risk-scoring for any reason, including but not limited to, unfamiliarity with the form applicant, unfamiliarity with the controlled form, determination of price, or data analysis of the controlled forms issued through the agent.

Some segments of the applicant information may provide a basis for an immediate response to the risk-scoring resulting in approval, declination, and price adjustment. For example, if the applicant has a net income under a certain level, the risk-scoring system may indicate an immediate denial for the controlled form. Other segments of the applicant information may provide a basis for a deferred response due to the need for supplemental information or review. For example, if the applicant has been in business less than two (2) years, the risk-scoring system may indicate to the agent that further information is required from the applicant, such as personal tax records.

### Agency Profile System

Any of the first through third exemplary embodiments of the present invention described above may optionally include an agency profile system which permits certain employees of the controlled form issuer (e.g., insurer) to register agents, and apply rules to each registered agency, and the employees of the registered agency who access any one the computer systems according to the first through third exemplary embodiments. For example, the agency profile system may be implemented as a separate program module of the software which implements the primary processes described above with reference to FIGS. 2 (first exemplary embodiment), 8 and 12 (second and third exemplary embodiments). In short, the agency profile system comprises a software program which may be stored within the computer system (e.g., resident on the agent computers 14, 28 or server computers 10, 11, 31) which permits certain employees of the controlled form issuer (e.g., underwriters) to control and customize the features of the computer system to the needs of the controlled form issuer and the respective agency. As the agency profile system permits the controlled form issuer to update and modify agency information for all the agencies associated with the controlled form issuer, the agencies and individual agents have limited access to the agency profile system. For example, the agencies may (through an agency administrator) maintain their own data, and manage their own employees, but cannot view or modify the data of other agencies. As explained below, agency administrators would preferably only have access to the View User Security Screen 600, the Add/Edit Profile Security Screen 700, and the View Profile Status Screen 800 of the agency profile system. The remainder of the screens described below would only be accessed by authorized personnel of the controlled form issuer. One of the benefits of the agency management system is that it allows the changes to various parameters associated with the controlled form issuance process (e.g., penalty amounts, packages, etc.) to be made in real-time, so that once they are made by the controller form issuer an agent can immediately issue a controlled form (or package) within the changed parameters.

For example, the agency profile system may permit personnel of the controlled form issuer (e.g., insurer) to: (1) setup initial agency profiles, (2) setup initial users and grant rights to external managers (e.g., agency administrators), (3) maintain contact information (e.g., address, phone, e-mail, etc.), (4) maintain profile status, and (5) communicate profile changes with other agencies and controlled form issuer staff. The agency profile system may also permit certain employees of the controlled form issuer (e.g., Help Desk, Underwriting Services) to have read-only access to each agency's information, so that they can correspond with form applicants (i.e., principals) on various issues. In the case of a division of the controlled form issuer such as Underwriting Services, the agency profile system may permit certain employees of such a division to view agency contact information, but not change it, and may also permit such employees to change the authorization levels for a particular agency, and to add or remove controlled forms from an agency's control. Finally, the agency profile system may permit one or more employees of each agency (e.g., agency administrators) to perform limited functions, such as: (1) view agency profile information, (2) maintain agency profile contact information, (3) maintain existing users within an agency, and (4) add additional users within an agency.

The agency profile system may permit the activation of various processes, including: (1) profile search, (2) agency management system search, (3) add/edit profile, (4) define profile authority, (5) view profile authority override history, (6) view user security, (7) add/edit profile security, (8) view profile status, and (9) force on/off. Each of these processes will be explained in detail below. The agency profile system may also permit the generation of various reports, including: (1) a profile bond list report, (2) an introduction letter report, (3) a today's work report, and (4) a history report. Each of these reports will be explained in detail below. The various processes and reports may be accessed from a Processes Menu 105 and a Reports Menu 110, respectively, as explained below.

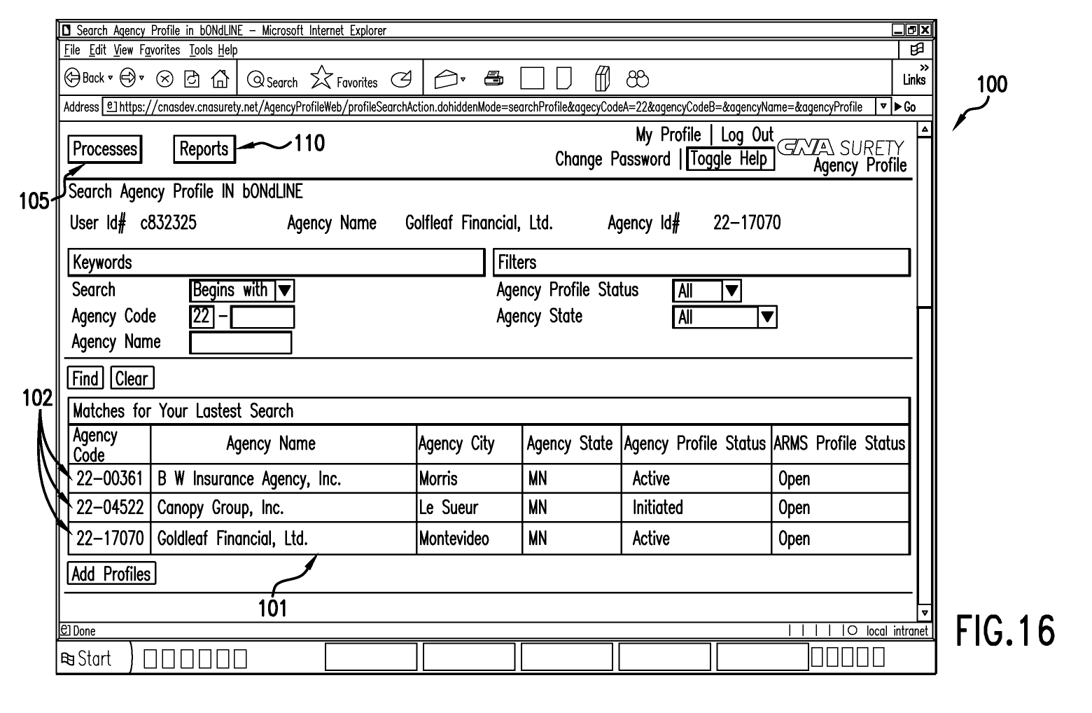

The profile search process allows certain employees of the controlled form issuer to search for an agency profile registered in the system by parameters such as agency name, agency code, etc. FIG. 16 shows an exemplary Profile Search Screen 100 which may be displayed, for example, on the video display 16 of an agent computer 14 of the computer system according to the first exemplary embodiment of the present invention. The user can display the Profile Search Screen 100 by selecting the Processes Menu 105, and then selecting, for example, the term “Search Profile” from a drop-down sub-menu. The user may implement the search by selecting various keywords and filters, as is well known in the art. As shown in FIG. 16, the user may search for agencies using an agency code (or portion thereof), and the search will return all agencies that include that code or code portion (e.g., “22”). Any agencies matching the search criteria will be displayed in a results table 101. From the results table 101, a particular agency may be selected by, for example, clicking on an agency code 102 in the results table 101, which may be hyperlinked to the agency listing. To avoid duplications, the agency profile system may restrict the entry of new agencies until at least one profile search has been completed.

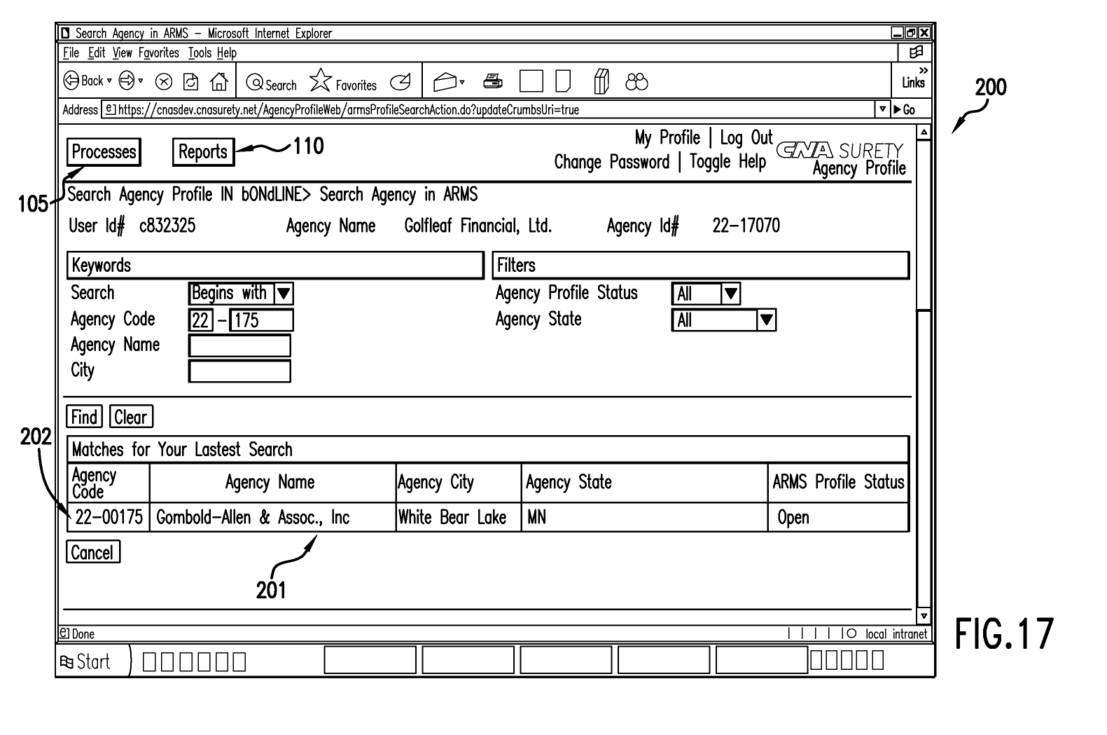

The agency management system search process allows certain employees of the controlled form issuer to search for an agency profile registered in an agency management system external to the agency management system. For example, in some cases controlled form issuers have legacy agency management systems which must be integrated with the computer systems according to the first through third exemplary embodiments. The agency management system search is similar to the profile search in that it allows the user to search by parameters such as agency name, agency code, etc. FIG. 17 shows an exemplary Agency Management Search Screen 200 which may be displayed, for example, on the video display 16 of an agent computer 14 of the computer system according to the first exemplary embodiment of the present invention. The user can display the Agency Management Search Screen 200 by selecting the Processes Menu 105, and then selecting, for example, the term “Manage Agency” from a drop-down sub-menu. The user may implement the search by selecting various keywords and filters, as is well known in the art. As shown in FIG. 17, the user may search for agencies using an agency code (or portion thereof), and the search will return all agencies that include that code or code portion (e.g., “22”). Any agencies matching the search criteria will be displayed in a results table 201. From the results table 201, a particular agency may be selected by, for example, clicking on an agency code 202 in the results table 201, which may be hyperlinked to the agency listing. To avoid duplications, the agency profile system may restrict the entry of new agencies until at least one agency management system search has been completed.

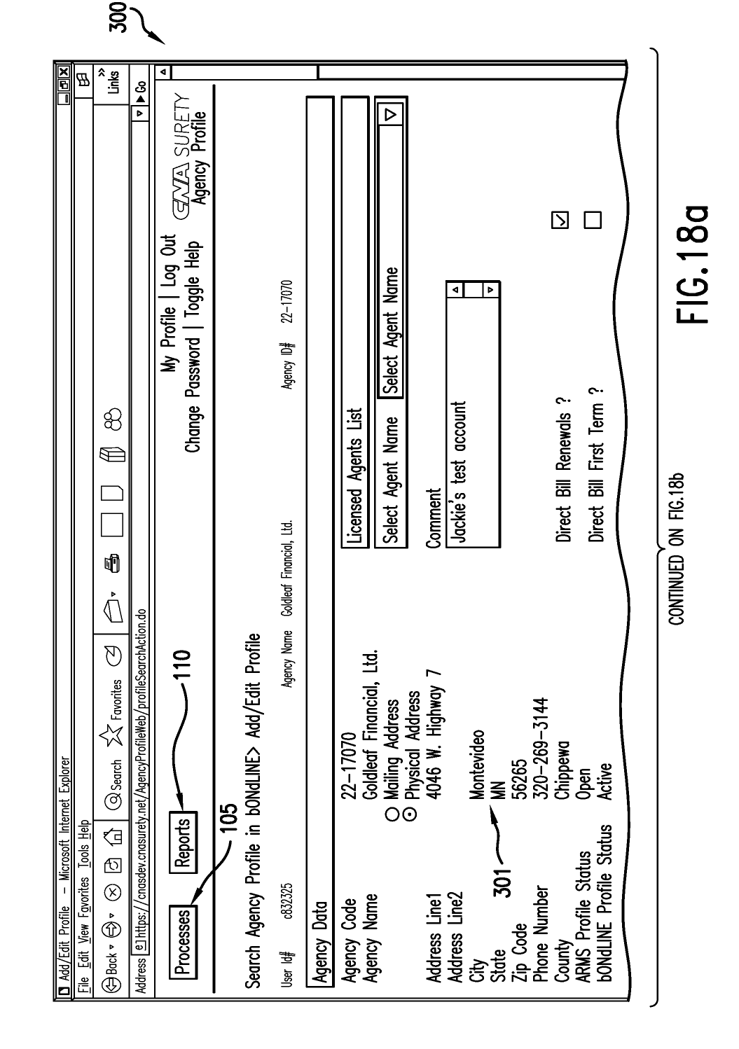

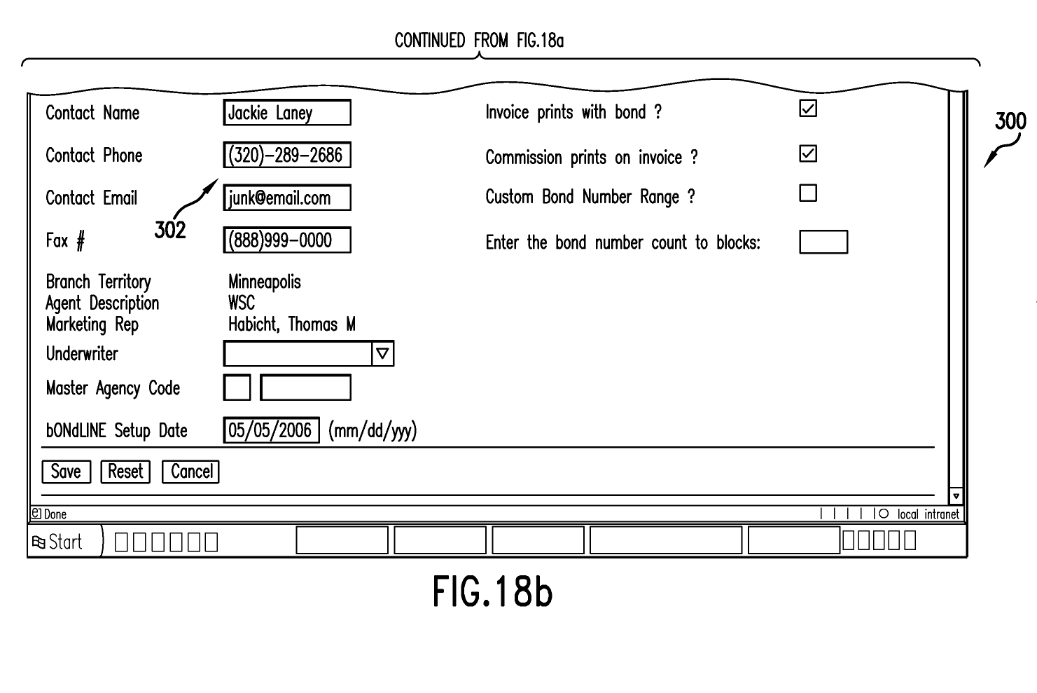

The add/edit profile process allows certain employees of the controlled form issuer to make changes to the agent's own profile information. FIG. 18 shows an exemplary Add/Edit Profile Screen 300 which may be displayed, for example, on the video display 16 of an agent computer 14 of the computer system according to the first exemplary embodiment of the present invention. The user can display the Add/Edit Profile Screen 300 by selecting the Processes Menu 105, and then selecting, for example, the term “Add Agency” from a drop-down sub-menu. The Add/Edit Profile Screen 300 may also be presented by selecting the hyperlink associated with an agency from, for example, the Profile Search Screen 100 described above. Some of the data shown on the Add/Edit Profile Screen 300 may be maintained in external databases (such as in a legacy agency management system), and is therefore presented as read-only on the screen. For example, a first set of data 301 may be designated as read-only on the Add/Edit Profile Screen 300, and a second set of data 302 may be modifiable (by entering revised information in the associated text box). For any fields that are modifiable (such as the field of the second set of data 302), the user may make modifications, and either save the changes (by selecting a “Save” button on screen), cancel changes (by selecting a “Cancel” button on screen), or reset to the original settings (by selecting a “Reset” button on screen).

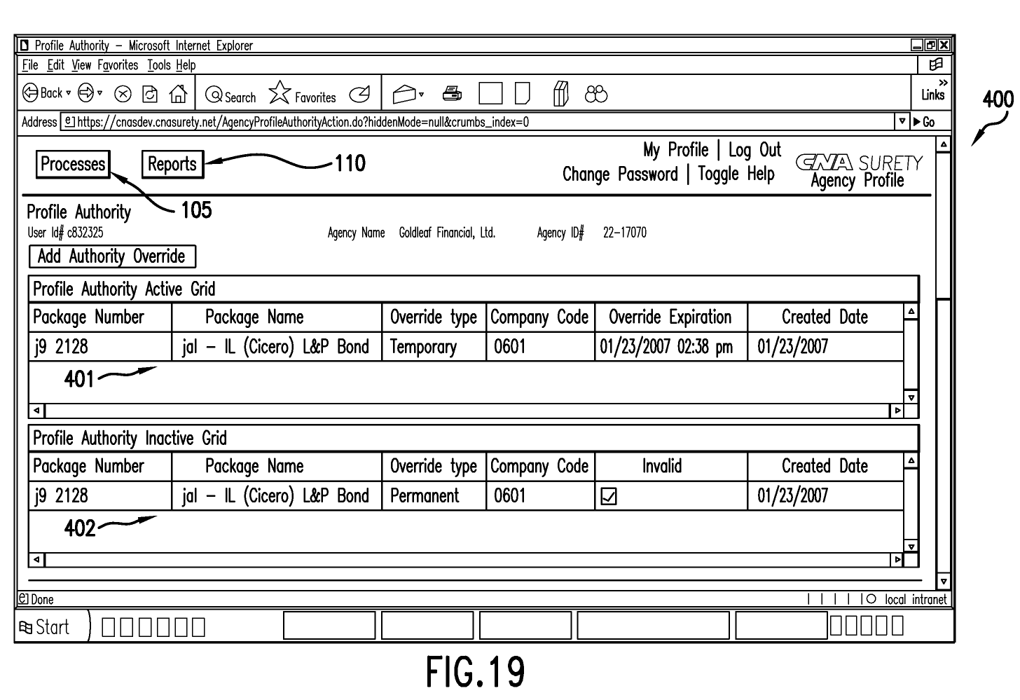

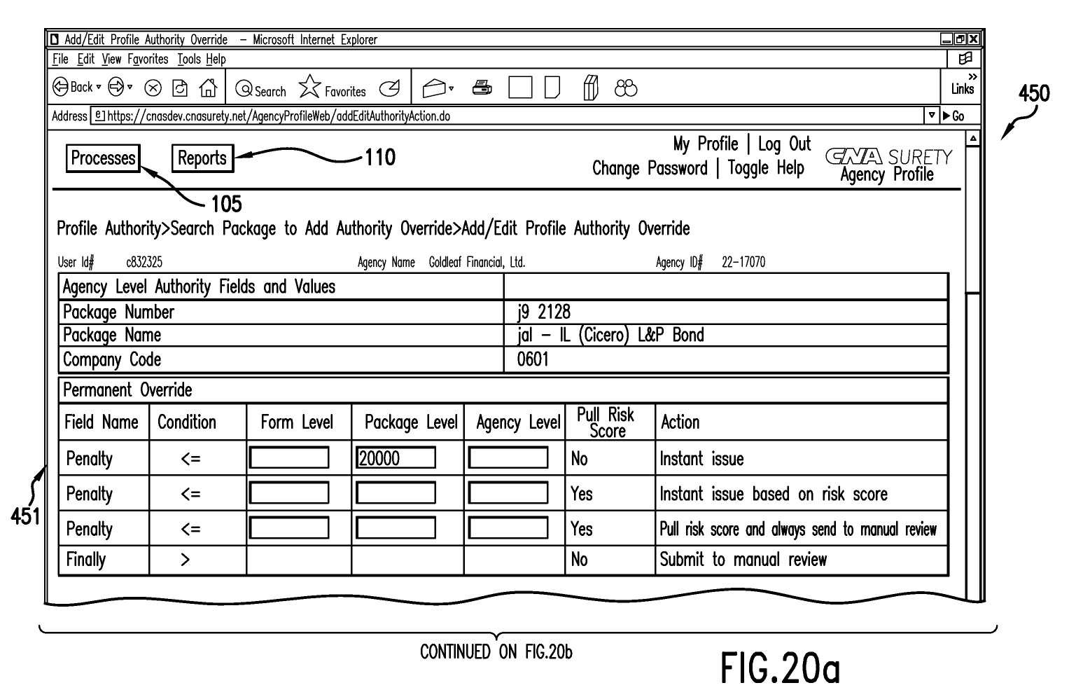

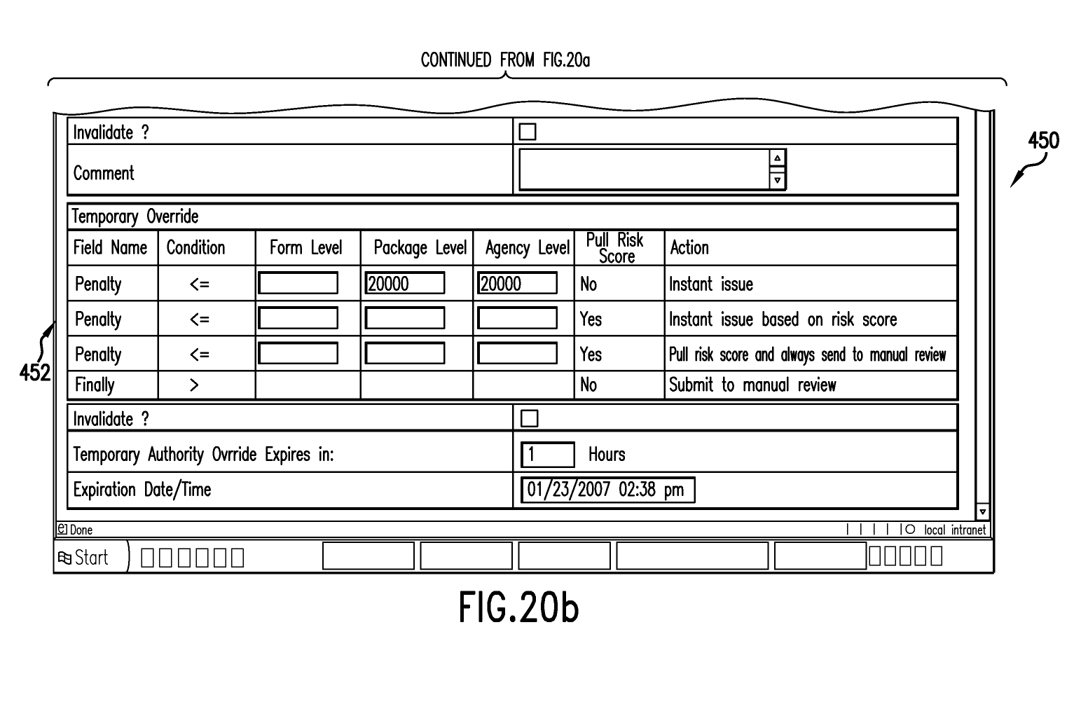

The define profile authority process allows certain employees of the controlled form issuer to define various authority and penalty levels for each “package” of a particular agency. A package may be defined as set of controlled forms associated with a particular bond or other instrument. For example, a package may comprise a set of controlled forms associated with an Illinois License & Permit (L&P) Bond, as shown in FIGS. 19 and 20. FIG. 19 shows an exemplary Define Profile Authority Screen 400 which may be displayed, for example, on the video display 16 of an agent computer 14 of the computer system according to the first exemplary embodiment of the present invention. The user can display the Define Profile Authority Screen 400 by selecting the Processes Menu 105, and then selecting, for example, the term “Define Authority” from a drop-down sub-menu. The Define Profile Authority Screen 400 includes an Active table 401 which displays active packages for the particular agency, and an Inactive table 402 which shows inactive packages for the particular agency. The Define Profile Authority Screen 400 also includes an Add Authority Override button 405, which if selected, displays an Add/Edit Profile Authority Screen 450, as shown in FIG. 20. Form the Add/Edit Profile Authority Screen 450, various authority and penalty levels may be set for each package of a particular agency by the controlled form issuer, as explained below.

Using the Add/Edit Profile Authority Screen 450, the user is permitted to define at least three (3) penalty amounts for a package at the agency level that will override any penalty amounts set at the form level or the package level. Although there are actually four (4) authority levels (i.e., “Instant issue,” “Instant issue based on risk score,” “Pull risk score and always send to manual review,” and “Submit to manual review.”) shown in FIG. 20, the user may only be permitted to change the penalty amounts for three (3) of them using the Add/Edit Profile Authority Screen 450. As explained above in the Definitions section, a penalty refers to the size or limit of a bond. Penalty amounts may be set at the form level, the package level, or the agency level. As shown in FIG. 20, the user is able to define at least three (3) penalty amounts or levels, corresponding to the authority levels of “Instant issue,” “Instant issue based on risk score,” and “Pull risk score and always send to manual review.” For example, the user can set a first range (e.g., between $0-$20,000) in which a package may be issued with no additional requirements (e.g., “Instant issue”). The user can then set second (e.g., $20,000-$30,000), and third ($30,000+) ranges in which additional requirements must be met to issue the bond, such as risk-scoring and manual review. The changes made to the penalty amounts may be made permanent, or temporary. If the user wishes to make permanent changes, the changes should be made in the Permanent Override table 451. Similarly, if the user wishes to make temporary changes, the changes should be made in the Temporary Override table 452, where a specific period of time (e.g., 1 hour) must also be selected. One of the benefits of the agency management system is that it allows the changes to the authority levels (i.e., penalty amounts) to be made in real-time, so that once they are made an agent can immediately issue a controlled form at the new authority level.

As discussed above, authority overrides can be set using the define profile authority process, as either “Temporary” or “Permanent.” Permanent overrides remain in effect until the user marks the override as invalid, by for example, selecting a check mark box in the Permanent Override table 451 labeled “Invalidate.” Temporary overrides require the user to enter the period of time (e.g., number of hours) that the override will be effective. The override will automatically expire when the time period has past, and the time period may begin as soon as the changes are finalized or saved. When an agent seeks to issue a package (e.g., IL L&P Bond), the penalty amount submitted by the agent is compared to the defined penalty amounts to determine how the bond should be processed, as discussed below.

As noted above, there may be defined four (4) authority levels for each package: (1) Level 1—Instant Issue, (2) Level 2—Instant Issue Based on Risk Score, (3) Level 3—Pull Risk Score for Manual Review, and (4) Level 4—Submit to Manual Review. For Level 1, if the penalty amount requested by the agent issuing the bond is less than or equal to the lowest authority level (Authority Level 1), the bond can be issued immediately without any other review (Instant Issue). For Level 2, if the penalty amount is greater than Authority Level 1 and less than or equal to Authority Level 2, a risk score will be calculated for the insured. This can be accomplished, for example, through a risk-scoring software module as explained below, and/or through a software module which sends a request for a credit check over the Internet to one or more known companies who provide such services. If the risk score passes a set of predetermined criteria (defined, for example, in the risk-scoring software), the bond is issued without further review. However, if the risk score fails to meet the predetermined criteria, the bond is declined without further review. However, if the risk score indicates that underwriter review is required, the bond is held for manual underwriting review. For Level 3, if the penalty amount is greater than Authority Level 2 and less than or equal to Authority Level 3, a risk score will be calculated, and the bond will be held for manual underwriter review no matter the risk score. Finally, for Level 4, if the penalty amount is greater than Authority Level 3, the bond is held for manual underwriter review. No credit report or risk score is automatically run for Level 4.

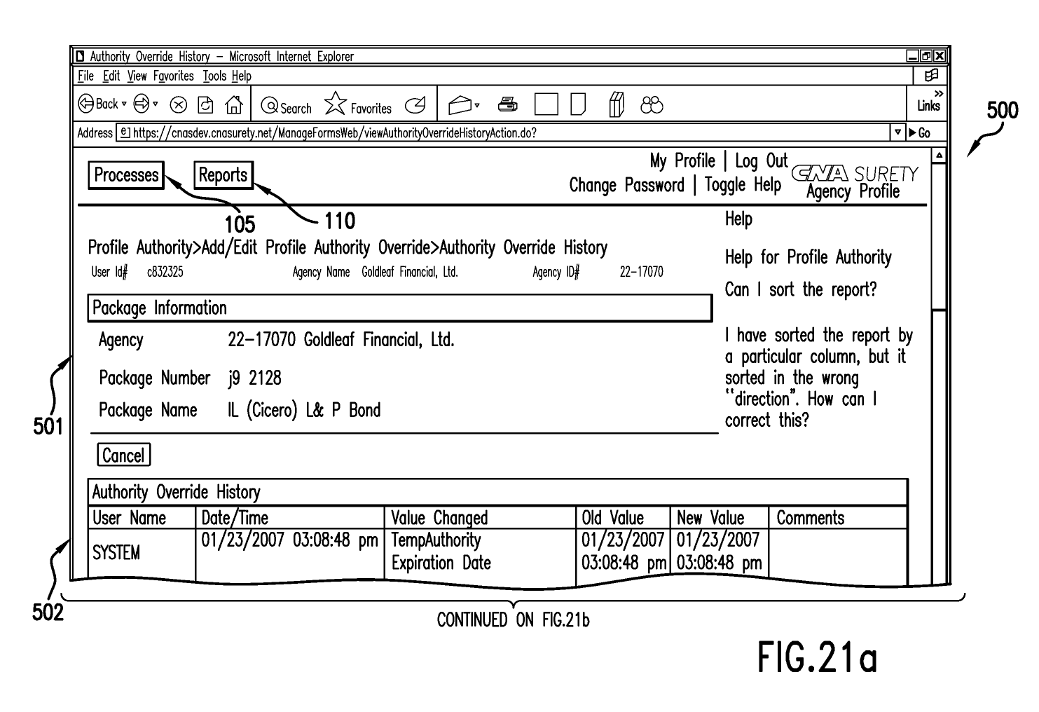

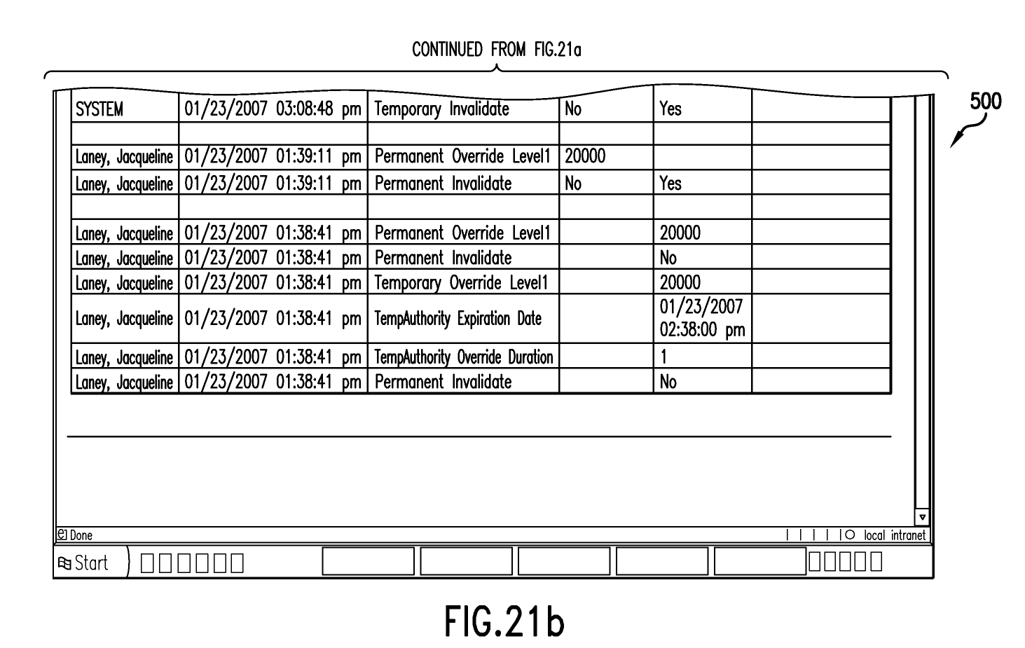

The view profile authority override history process allows certain employees of the controlled form issuer to view the history of “Temporary” and “Permanent” overrides granted during the define profile authority process. FIG. 21 shows an exemplary View Profile Authority Override Screen 500 which may be displayed, for example, on the video display 16 of an agent computer 14 of the computer system according to the first exemplary embodiment of the present invention. The user can display the View Profile Authority Override Screen 500 by selecting the Processes Menu 105, and then selecting, for example, the term “View Authority” from a drop-down sub-menu. The View Profile Authority Override Screen 500 includes a Package Information table 501, and an Override History table 502. The View Profile Authority Override Screen 500 shows every override and tracks when it was effective, when it expired, the name of the agency employee that changed it, and any comment they may have entered at the time.

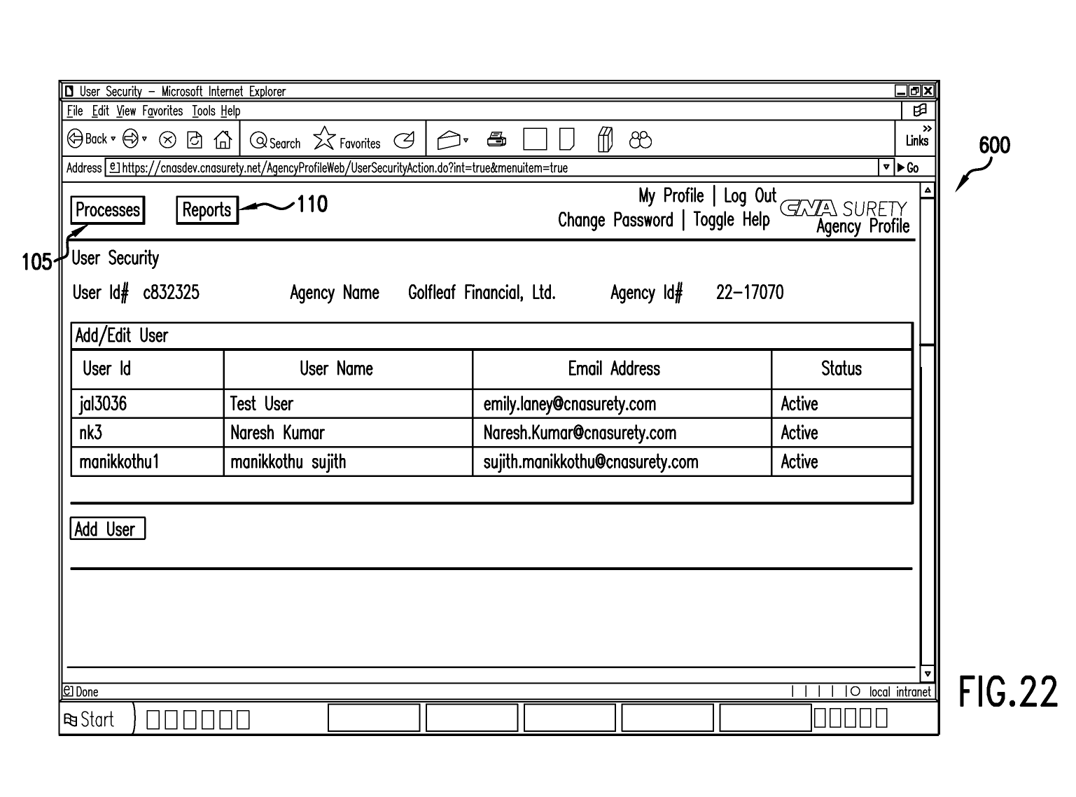

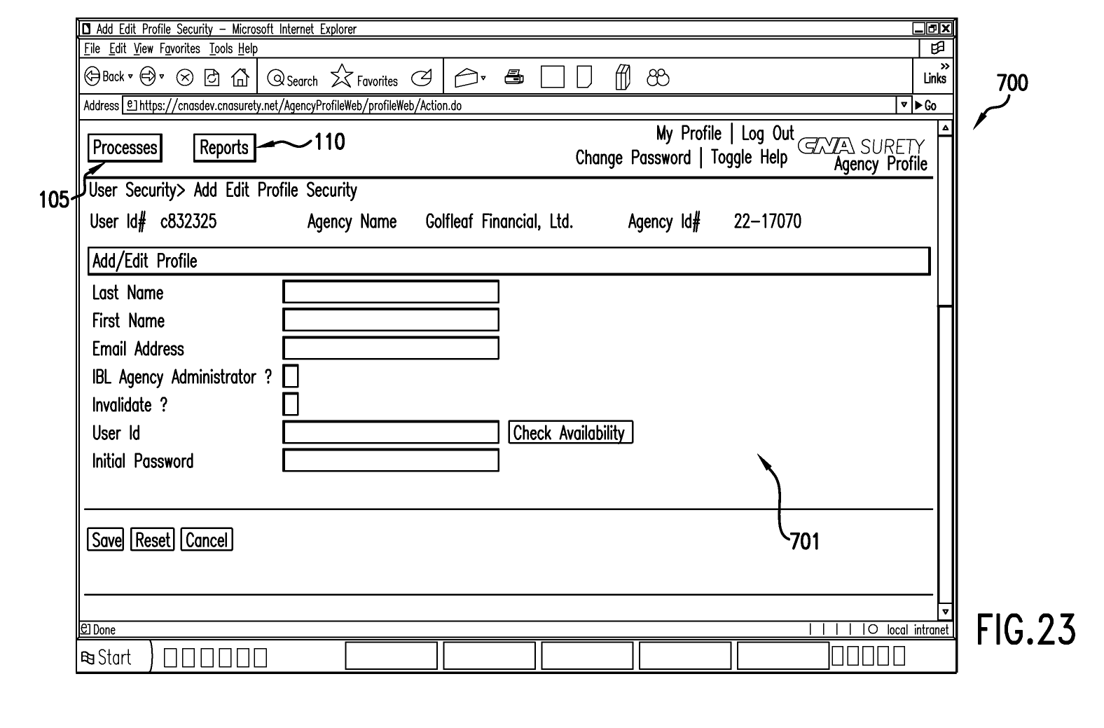

The view user security process allows certain employees of the controlled form issuer (and certain agency administrators) to view all the users (e.g., agency employees) who have ever been associated with a particular agency profile, and to add users to the profile. FIG. 22 shows an exemplary View User Security Screen 600 which may be displayed, for example, on the video display 16 of an agent computer 14 of the computer system according to the first exemplary embodiment of the present invention. The user can display the View User Security Screen 600 by selecting the Processes Menu 105, and then selecting, for example, the term “View User Security” from a drop-down sub-menu. The View User Security Screen 600 includes a user table 601, and an Add User button 605. The user table 601 shows all users, both active and inactive, that have ever been associated with the particular agency profile. The User Id field in the user table 601 may comprise a hyperlink to the Add/Edit Profile Security Screen 700 described below with reference to FIG. 23.

The add/edit profile security process allows certain employees of the controlled form issuer (and certain agency administrators) to set up profiles for other users (i.e., other agents) within the agency. FIG. 23 shows an exemplary Add/Edit Profile Security Screen 700 which may be displayed, for example, on the video display 16 of an agent computer 14 of the computer system according to the first exemplary embodiment of the present invention. The user can display the Add/Edit Profile Security Screen 700 by selecting the Processes Menu 105, and then selecting, for example, the term “Add Profile Security” from a drop-down sub-menu. The Add/Edit Profile Security Screen 700 includes a profile table 701 which may include multiple fields corresponding to the user, such as First Name, Last Name, Email Address, User Id, Password, etc. Any user can also be made an “IBL Agency Administrator,” which means that they will be given limited access to the agency profile to manage other users.

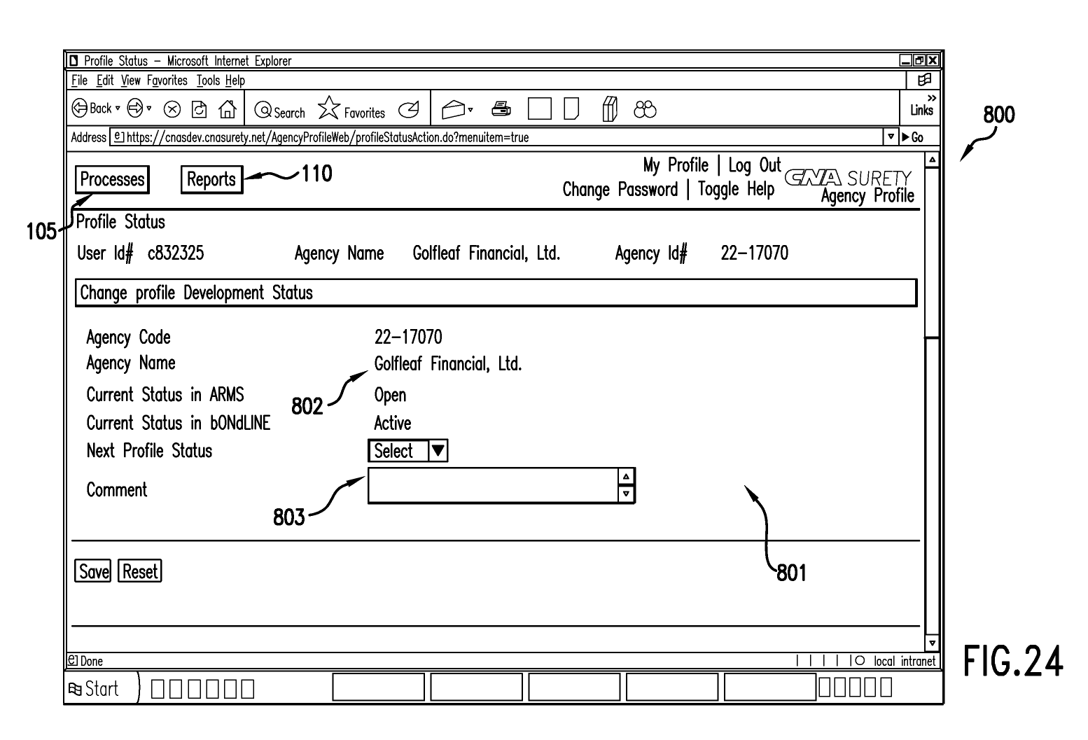

The view profile status process allows certain personnel of the controlled form issuer to manage the status of a particular agency. FIG. 24 shows an exemplary View Profile Status Screen 800 which may be displayed, for example, on the video display 16 of an agent computer 14 of the computer system according to the first exemplary embodiment of the present invention. The user can display the View Profile Status Screen 800 by selecting the Processes Menu 105, and then selecting, for example, the term “View Status” from a drop-down sub-menu. The View Profile Status Screen 800 includes an agency profile table 801 which may include information on the particular agency, such as Agency Code, Agency Name, etc. The view profile status process may be coupled to the database of a legacy agency management system such that the portion of the data which is maintained in such an external database may be made read-only. For example, a first set of data 802 may be designated as read-only on the View Profile Status Screen 800, and a second set of data 803 may be modifiable (by entering revised information in the associated text box).

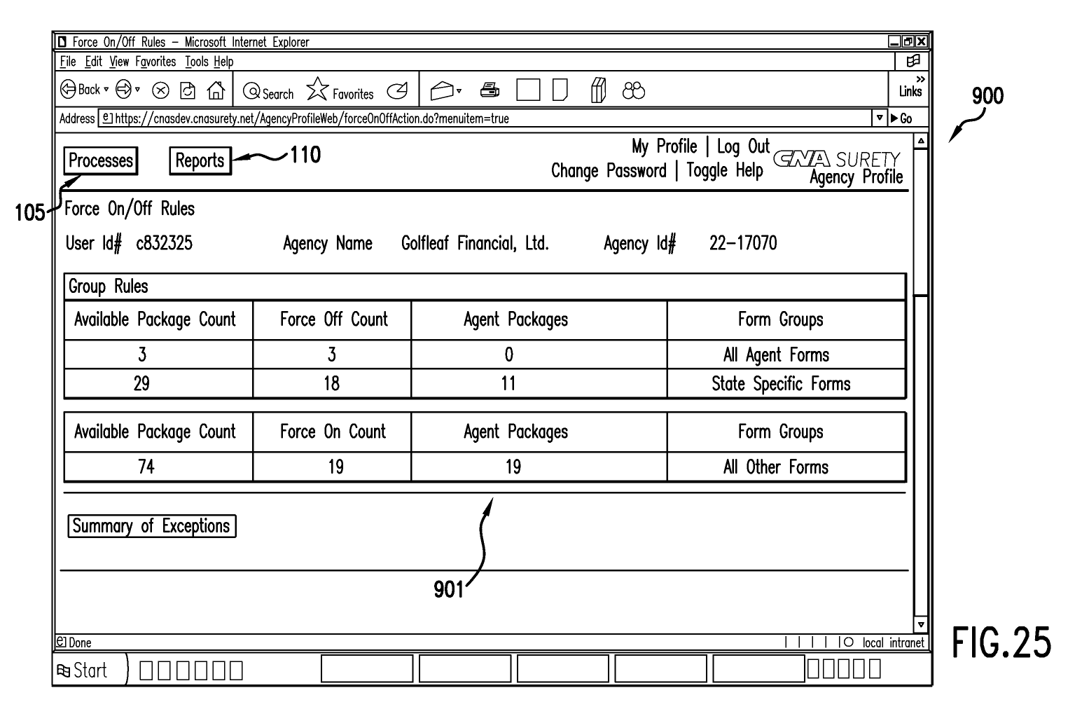

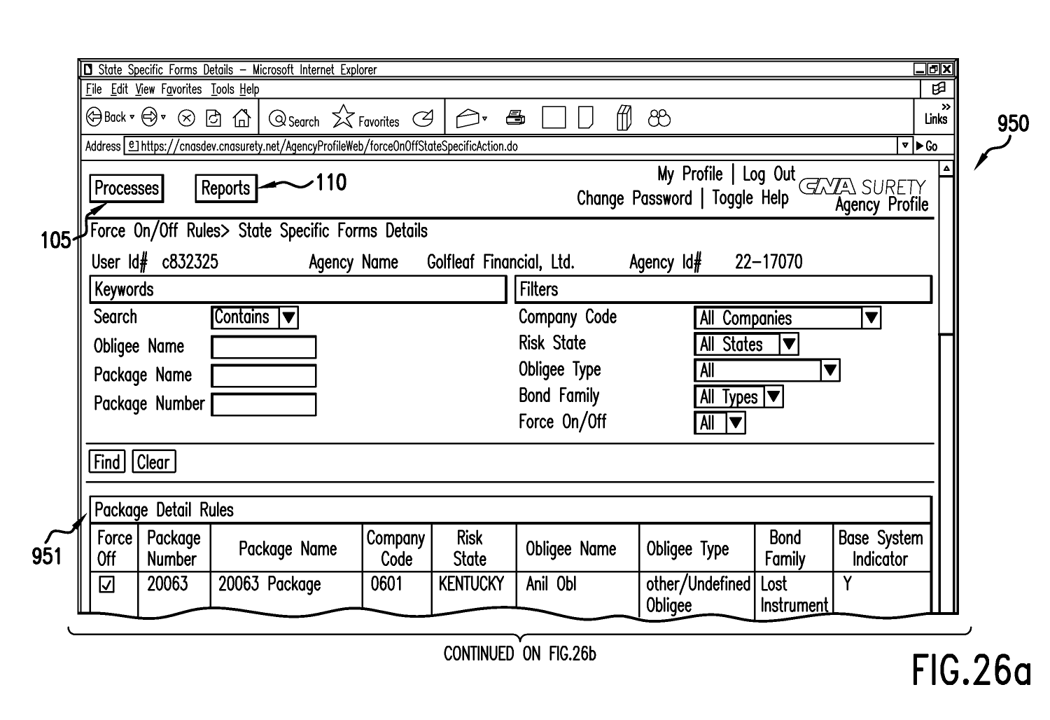

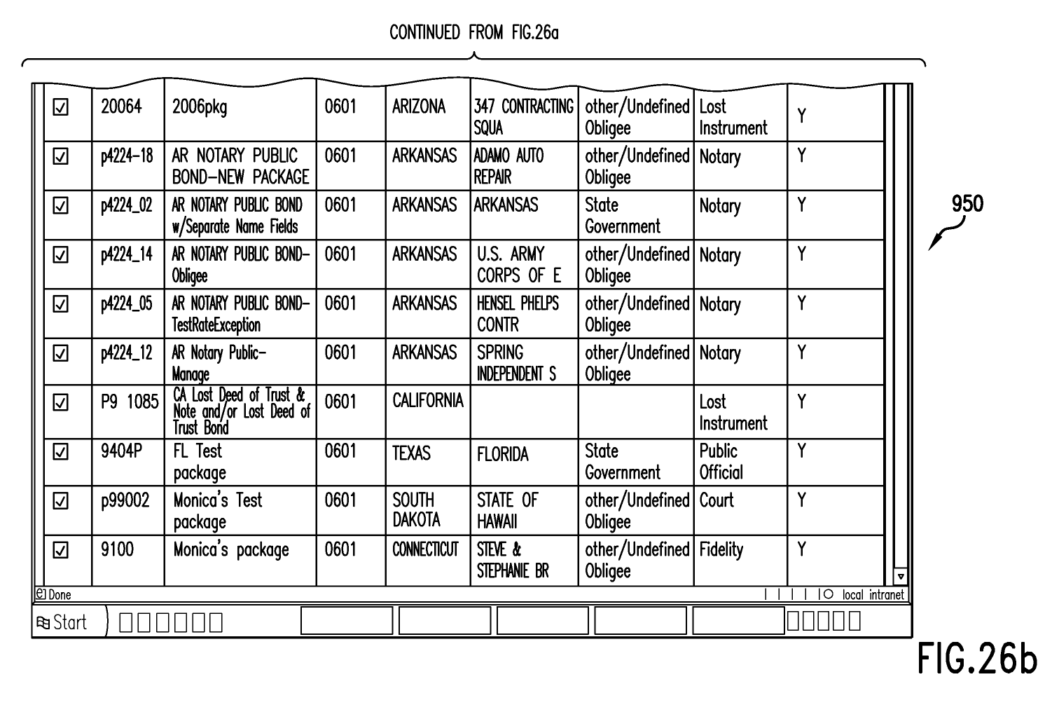

The force on/off process allows certain personnel of the controlled form issuer to customize the packages to which a particular agency has access. FIG. 25 shows an exemplary Force On/Off Screen 900 which may be displayed, for example, on the video display 16 of an agent computer 14 of the computer system according to the first exemplary embodiment of the present invention. The user can display the Force On/Off Screen 900 by selecting the Processes Menu 105, and then selecting, for example, the term “Force On/Off” from a drop-down sub-menu. The Force On/Off Screen 900 includes a Group Rules table 901. Packages that are not part of the standard list that are given to agencies can be ‘forced on’ to an agency's profile by the controlled form issuer. Packages that are part of the standard list that are given to agencies can be “forced off” the agency's profile by the controlled form issuer as well. As shown in the Group Rules table 901, there may be defined three (3) categories of forms for each agency: (1) All Agent Forms, (2) State Specific Forms, and (3) All Other Forms. All Agent Forms are packages that all agencies have access to regardless of licensing, State Specific Forms are state specific packages from states in which the agency is properly licensed, All Other Forms are defined as packages that don't fall into either of the first or second categories. The Group Rules table 901 shows a summary of the packages available in each category, and the ones for which the agency has access. The category fields (e.g., All Agent Forms, State Specific Forms, All Other Forms) in the Group Rules table 901 may comprise a hyperlink to the On/Off Form Details Screen 950 described below with reference to FIG. 26.

FIG. 26 shows an exemplary On/Off Form Details Screen 950 which illustrates all the packages available in the selected category (e.g., State Specific Forms), and the status of those packages for the current agency profile, in a Package Detail Rules table 951. The user can select and deselect packages in the Package Detail Rules table 951 by adding or removing them from the current agency profile. For example, the user may select or deselect the check mark in the check mark box in the “Force Off” column of the Package Detail Rules table 951, as will be understood by those of ordinary skill in the art. One of the benefits of the agency management system is that it allows the changes to the agency packages to be made in real-time, so that once they are made an agent can immediately issue the newly-authorized package.

As noted above, the agency profile system may also permit the generation of various reports (from the Reports Menu 110), including: (1) a profile bond list report, (2) an introduction letter report, (3) a today's work report, and (4) a history report. Each of these reports will be explained in detail below.

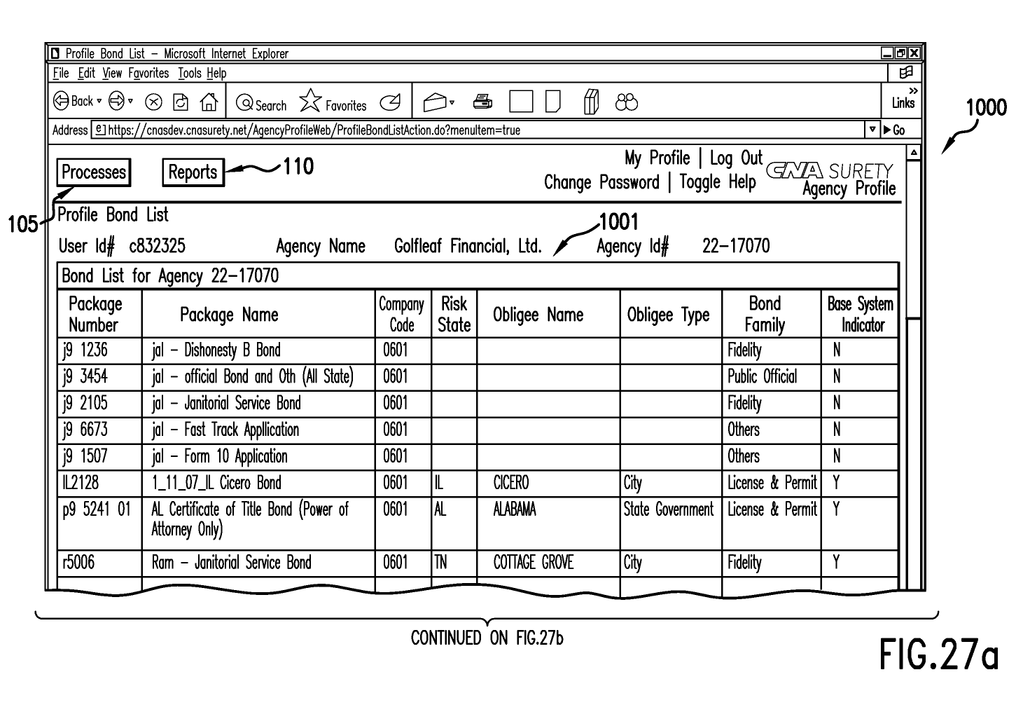

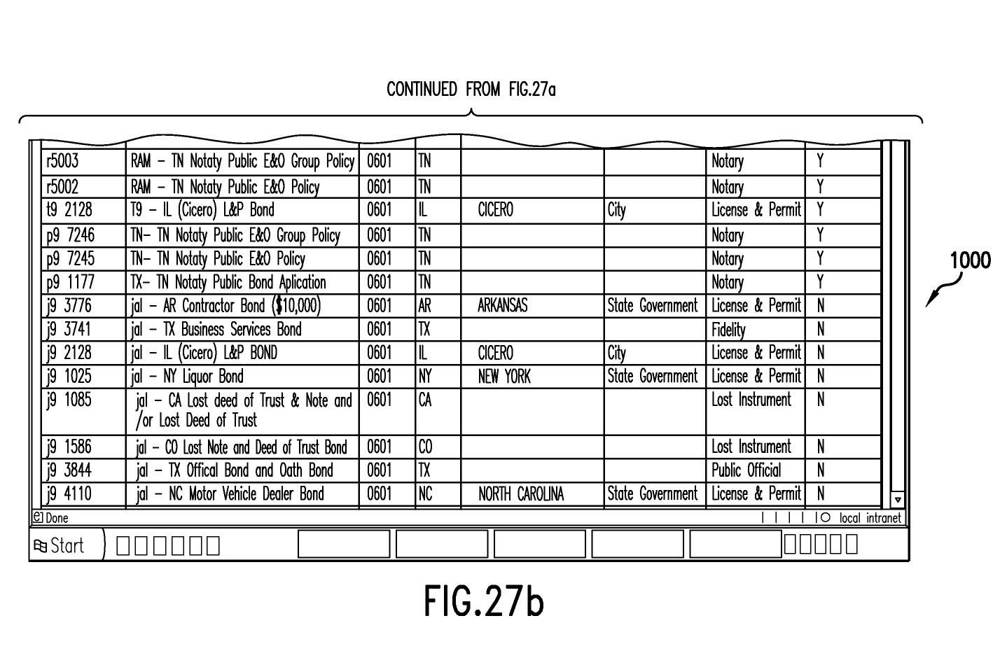

FIG. 27 shows an exemplary Profile Bond List Screen 1000 which displays a list of all the packages available for the current agency profile (e.g., “Goldleaf Financial, Ltd.”) within a Bond List table 1001. The user can display the Profile Bond List Screen 1000 by selecting the Reports Menu 110, and then selecting, for example, the term “Bond List” from a drop-down sub-menu. The Bond List table 1001 may include various categories or columns, such as Package Number, Package Name, etc. The Package Name field in the bond list able 1001 may comprise a hyperlink to all levels of authority currently set for the package. For example, the Package Name field in the Bond List able 1001 may comprise a hyperlink to the Add/Edit Profile Authority Screen 450 described above.

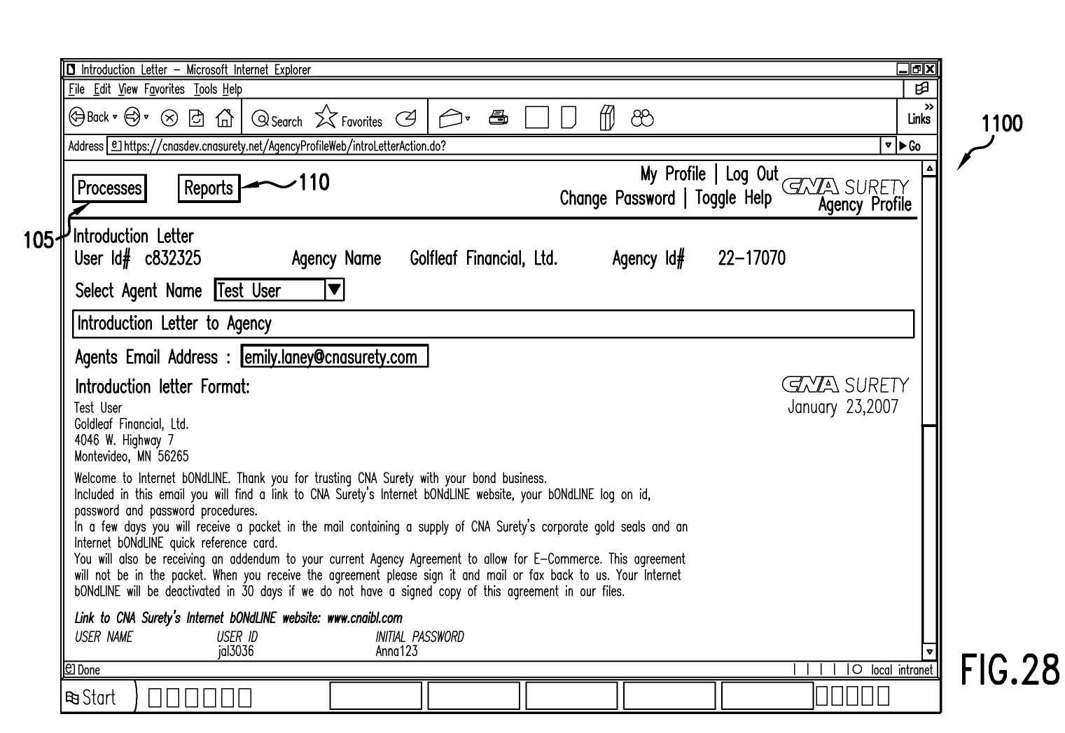

FIG. 28 shows an exemplary Introduction Letter Screen 1100 which displays an introduction letter for new users for a particular agency. The user can display the Introduction Letter Screen 1100 by selecting the Reports Menu 110, and then selecting, for example, the term “Introduction Letter” from a drop-down sub-menu. For example, when an agency hires a new agent, he or she must be set up on the system with a User Id and Password, and this introduction letter accomplishes that function. Preferably, an employee of the controlled form issuer generates this letter, creates the initial User Id and Password information, and either prints the letter out and mails it to the new agency employee, or e-mails it to them. The letter may be printed on, for example, the printer 18 coupled to the agent computer 14 in the computer system according to the first exemplary embodiment of the present invention, and mailed or otherwise transmitted to the new agent. In the exemplary embodiment, agents cannot access the Introduction Letter Screen 1100 and perform the above functions; this can only be accomplished by personnel of the controlled form issuer.

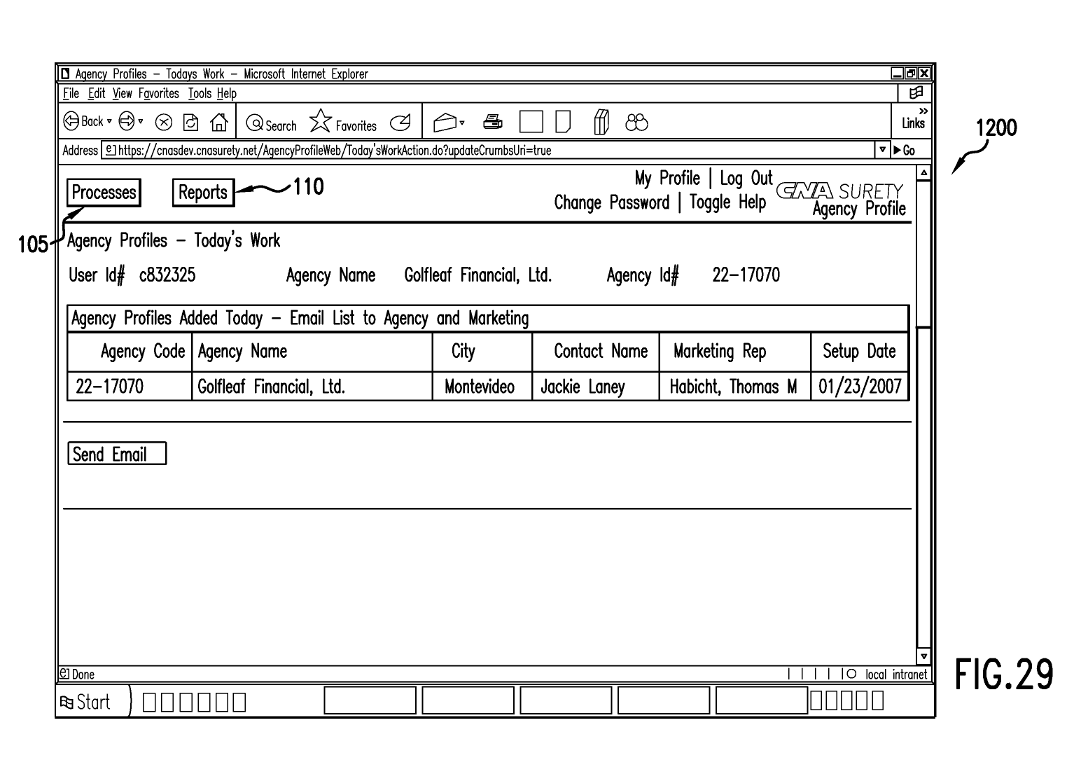

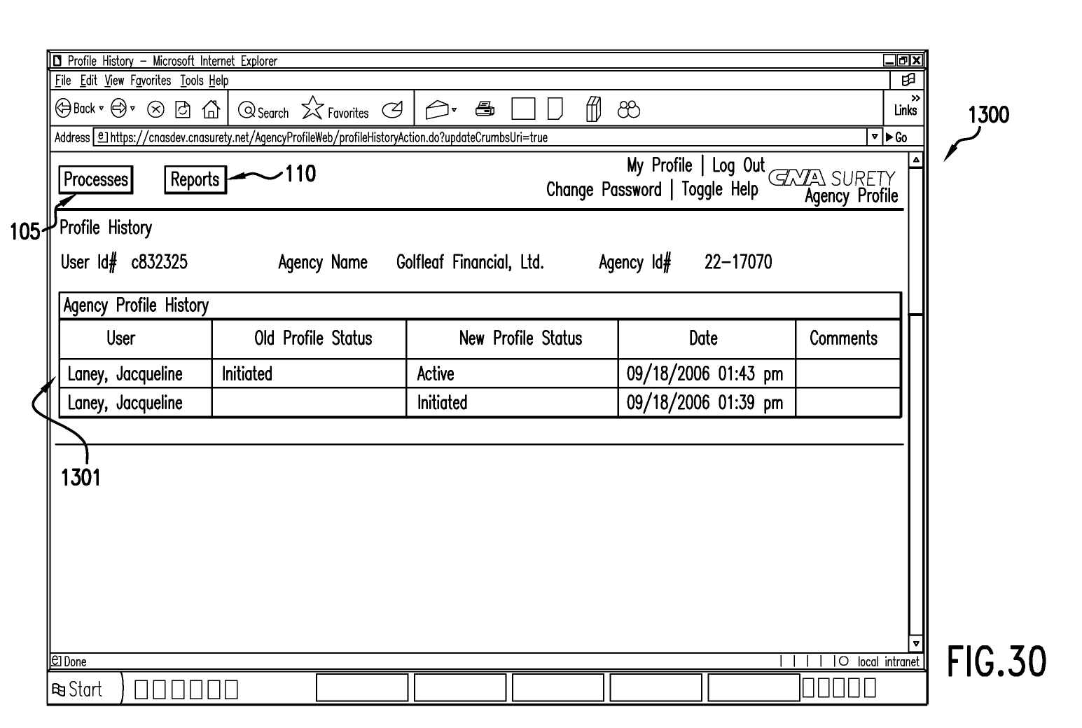

FIG. 29 shows an exemplary Today's Work Screen 1200 which displays a list of all agency profiles which were set up on the particular day in question. The user can display the Today's Work Screen 1200 by selecting the Reports Menu 110, and then selecting, for example, the term “Today's Work” from a drop-down sub-menu. The purpose of this report is to show all new agency profiles setup on the current day. The list may then be emailed (or transmitted otherwise) to underwriters and marketing staff of the controlled form issuer to keep them aware of new agencies.

FIG. 30 shows an exemplary Profile History Screen 1300 which displays a list of all historical changes to an agency's profile status. The user can display the Profile History Screen 1300 by selecting the Reports Menu 110, and then selecting, for example, the term “Profile History” from a drop-down sub-menu. The changes are listed in a profile history table 1301, which shows the User Id of each user (e.g., agent) who has accessed and modified the profile, and the date and time of the modification. Comments may also be stored for each modification to help others better understand the history.

### Manage Forms System

Any of the first through third exemplary embodiments of the present invention described above may optionally include a manage forms system which permits the certain employees of the controlled form issuer (e.g., insurer) to register and apply rules to the controlled forms. Preferably, the manage forms system is only accessible by employees of the controlled form issuer, and is not accessible by the agencies requesting issuance of the controlled forms. The manage forms system also provides a way to group forms into usable “packages,” or groups of entry forms and output forms that an agent will need to produce a usable bond. The manage forms system allows for the application of rules for a “package” the same way it does for an individual form. The manage forms system also allows for the viewing and modification of forms. The manage forms system may, for example, be implemented as a separate program module of the software which implements the primary processes described above with reference to FIGS. 2 (first exemplary embodiment), 8 and 12 (second and third exemplary embodiments). In short, the manage forms system comprises a software program which may be stored within the computer system (e.g., resident on the agent computers 14, 28 or server computers 10, 11, 31) which permits certain employees of the controlled form issuer and certain agents to customize certain forms. As with the agency management system, one of the benefits of the manage forms system is that it allows the changes to various parameters associated with the controlled form issuance process (e.g., penalty amounts, packages, etc.) to be made in real-time, so that once they are made by the controller form issuer an agent can immediately issue a controlled form (or package) within the changed parameters. The various forms, packages and reports available from the manage forms system may be accessed from a Forms Menu 1405, a Packages Menu 1410 and a Reports Menu 1415, respectively, as explained below.

The manage forms system may include at least two (2) types of forms: Input Forms and Output Forms. Input Forms are reusable electronic documents that may be completed by an agent by filling in various fields within the form with Data Entry Fragments. Data Entry Fragments may comprise pieces of information which may be entered into the various fields of a controlled form application. For example, a bond application form may include fields such as Premium, Penalty Amount, Principal Name, Obligee Name, Obligee Type, Risk State, etc., into which the agent enters the specified information. The fields of an Input Form may include validation and formatting scripts embedded therein to control the quality of the data entered. Output Forms comprise Anchor Forms and Output Attachments. Anchor Forms are independent forms that have some significance (e.g., bond). Output Attachments are attachments to Anchor Forms, and may comprise documents such as Powers of Attorney.

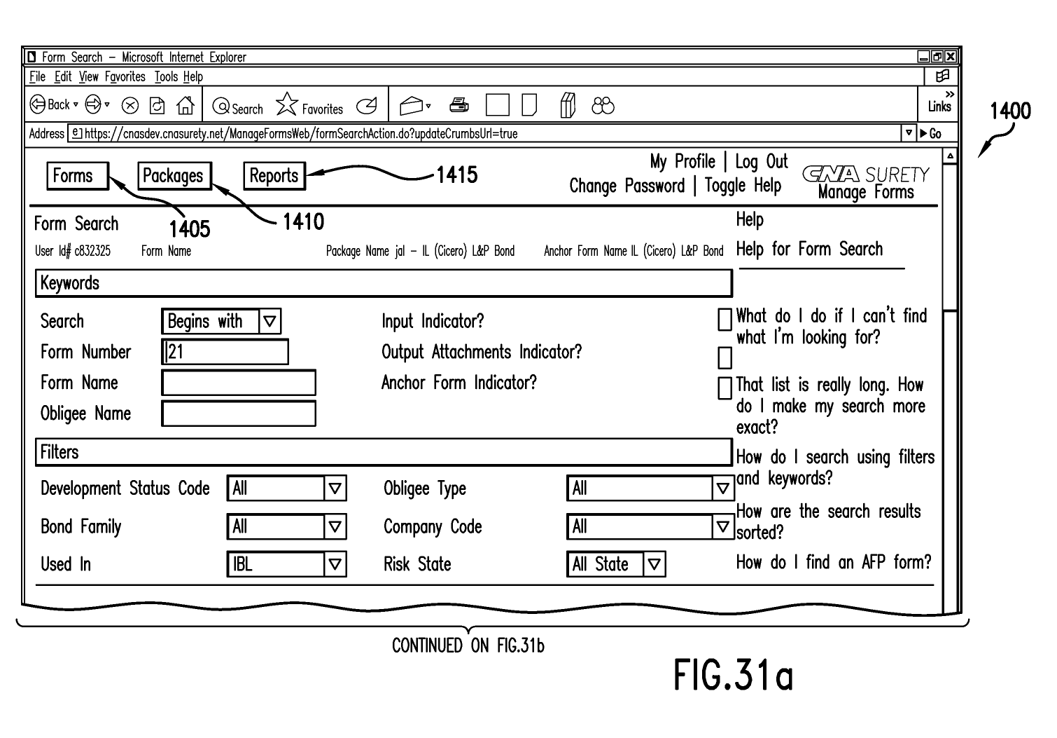

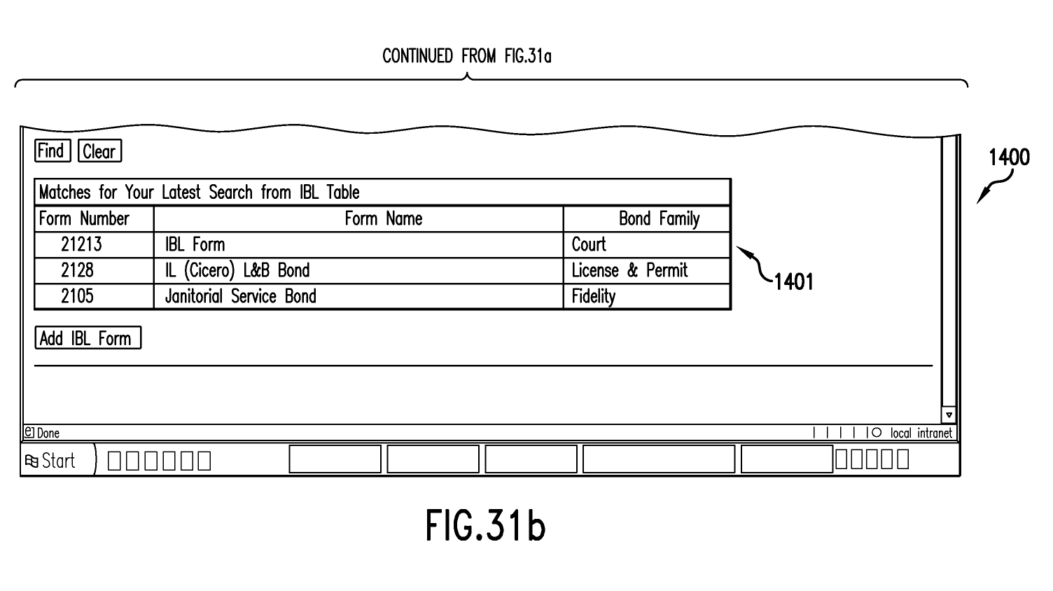

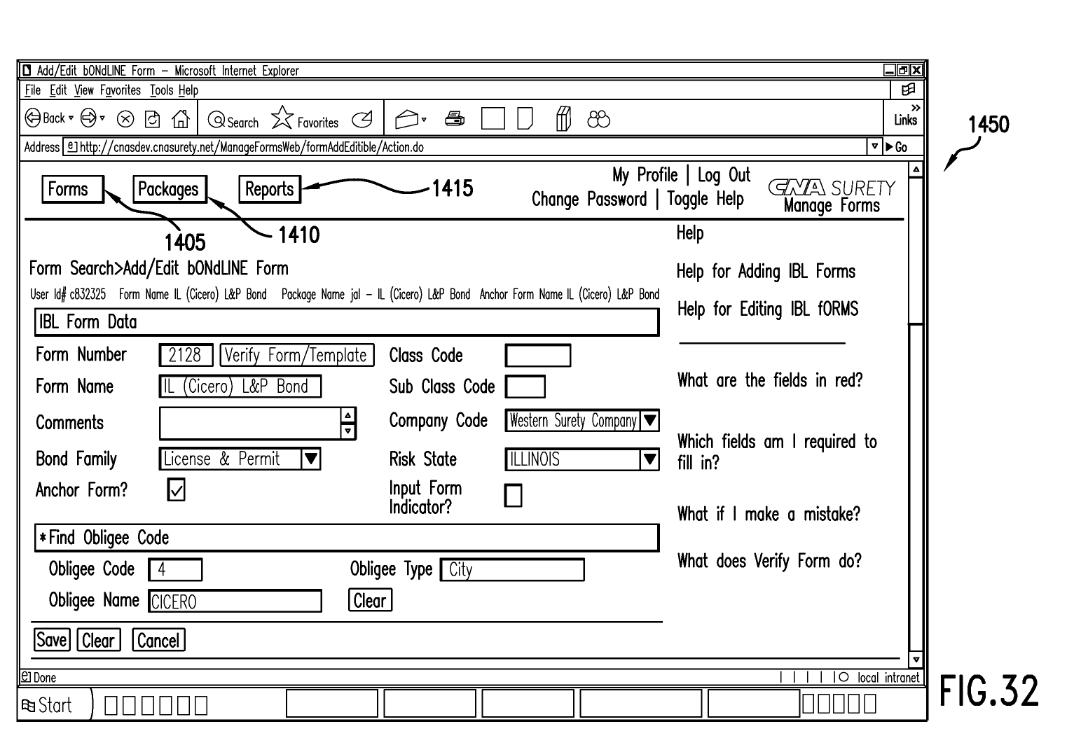

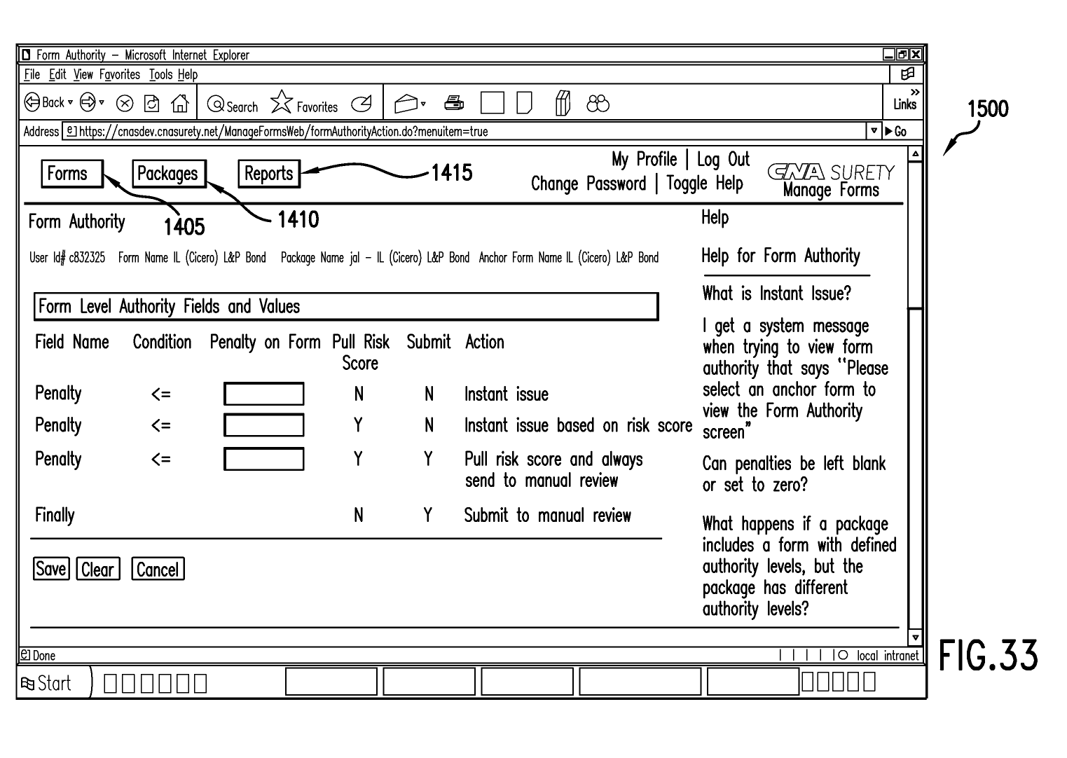

FIG. 31 shows an exemplary Form Search Screen 1400 which allows certain employees of the controlled form issuer to search for forms existing in the system. The user can display the Form Search Screen 1400 by selecting the Forms Menu 1405, and then selecting, for example, the term “Search Form” from a drop-down sub-menu. The search may be implemented through selection of various keywords and filters, as is well known in the art. As shown in FIG. 31, the user may search for a form using a form code (or portion thereof), and the search will return all forms that include that code or code portion (e.g., “21”). The search utility returns a list of any forms matching the search criteria in a results table 1401 (e.g., Form Nos. “21213,” “2128” and “2105”). The Form Number field in the results table 1401 may comprise a hyperlink to the form itself. If a user selects the hyperlink associated with a particular form (e.g., “2128”), the user may then be presented with an Add/Edit Forms Screen 1450, as described below in connection with FIG. 32. To avoid duplications, the manage forms system may restrict the entry of new forms until at least one form search has been completed.

FIG. 32 shows an exemplary Add/Edit Forms Screen 1450 which allows certain employees of the controlled form issuer to add forms to the system, or edit forms existing in the system. FIG. 32 shows an existing form (with Form No. “2128”), and certain fields which may be modified for the form (e.g., Form Name, Bond Family, Anchor Form designation, etc.). In short, the Add/Edit Forms Screen 1450 allows the user to define basic data for a particular form. The Add/Edit Forms Screen 1450 may include a “Anchor Form?” check box, which allows the user to designate the form as an Anchor Form. Anchor Forms may be defined as form that are independent, or have a meaning standing alone. For example, a bond form may comprise an Anchor Form, but a Power of Attorney form is not an Anchor Form because it has no significance without an associated bond or other primary agreement. If the form is obligee specific, the user can expand the “Find Obligee Code” section of the Add/Edit Forms Screen 1450 to search for and select the correct obligee. The agent can also use the “Verify Form/Template” button to view an image of the form in PDF or other suitable format. For any fields that are modifiable, the user may make modifications, and either save the changes (by selecting a “Save” button on screen), cancel changes (by selecting a “Cancel” button on screen), or reset to the original settings (by selecting a “Reset” button on screen). One of the benefits of the manage forms system is that it allows modifications of the forms stored therein in real-time, so that once the modifications are made, the forms are immediately available for use by the agents.

FIG. 33 shows an exemplary Forms Authority Screen 1500 which allows certain employees of the controlled form issuer to define at least three (3) penalty amounts for a particular form. As discussed above, these penalty amounts may be compared to the penalty amount of any agent submission, an used to make decisions on the further processing of such submission. The user can display the Forms Authority Screen 1500 by selecting the Forms Menu 1405, and then selecting, for example, the term “Form Authority” from a drop-down sub-menu, and entering a form number or form name. Similar to the Add/Edit Profile Authority Screen 450 (FIG. 20) described above, there are four (4) possible authority levels that can be set for each form: (1) Level 1—Instant Issue, (2) Level 2—Instant Issue Based on Risk Score, (3) Level 3—Pull Risk Score for Manual Review, and (4) Level 4—Submit to Manual Review, and the user can set penalty amounts for three (3) of those four (4) authority levels. Processing of requests from agents proceeds as described above in connection with the Add/Edit Profile Authority Screen 450. It should be noted that any penalty amount set using the Forms Authority Screen 1500 may be automatically overridden by setting a different penalty amount using the Add/Edit Profile Authority Screen 450, as the latter sets authority at the agency level, not the form level. One of the benefits of the manage forms system is that it allows modifications to authority and penalty levels of the forms stored therein in real-time, so that once the modifications are made, the forms with modified authority and penalty levels are immediately available for use by the agents.

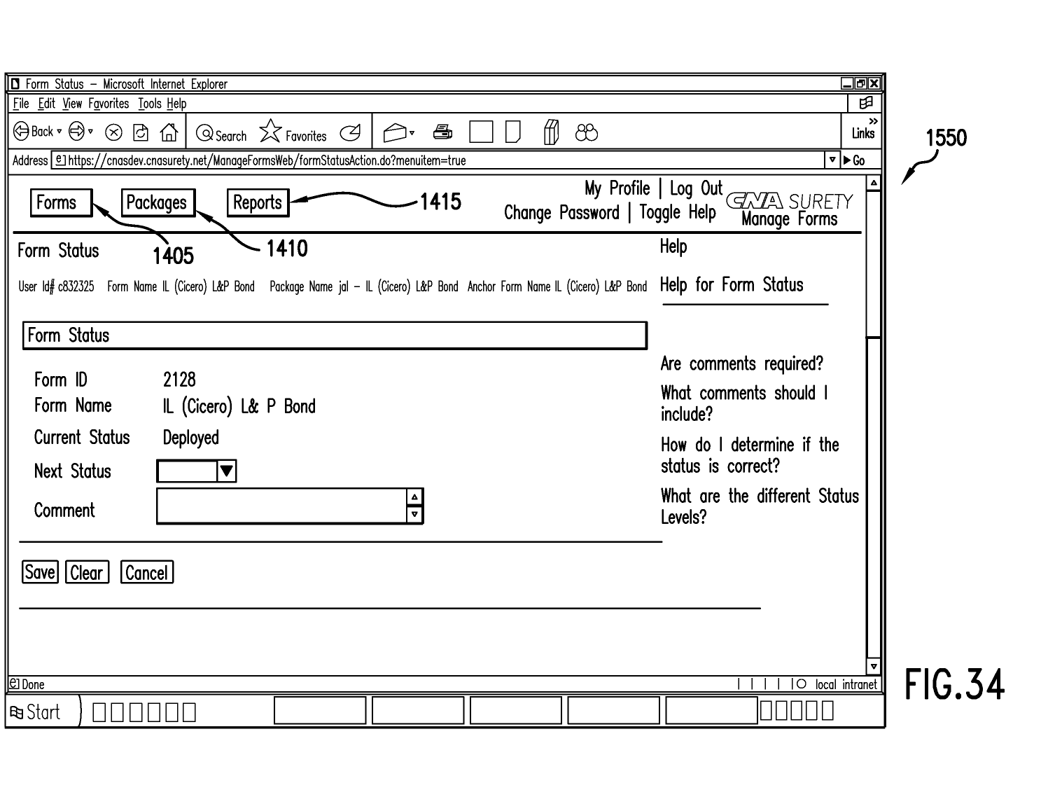

FIG. 34 shows an exemplary Form Status Screen 1550 which allows certain employees of the controlled form issuer to define the status of forms in the system. The user can display the Form Status Screen 1550 by selecting the Forms Menu 1405, and then selecting, for example, the term “Form Status” from a drop-down sub-menu, and entering a form number or form name. There are different status levels which may be used to track the life cycle of the forms. Status levels for forms may include “Complete” (meaning the form is ready for package setup), “Hold” (meaning the form is not currently active in any stage of the development life cycle), “Initial” (meaning a form number has been assigned, but no work is currently being performed), “No Longer Needed” (meaning the form cannot be deleted, but is still part of the system), “Rejected” (meaning the obligee has prohibited electronic replication of the form), and “Revising” (meaning the form is currently being revised).

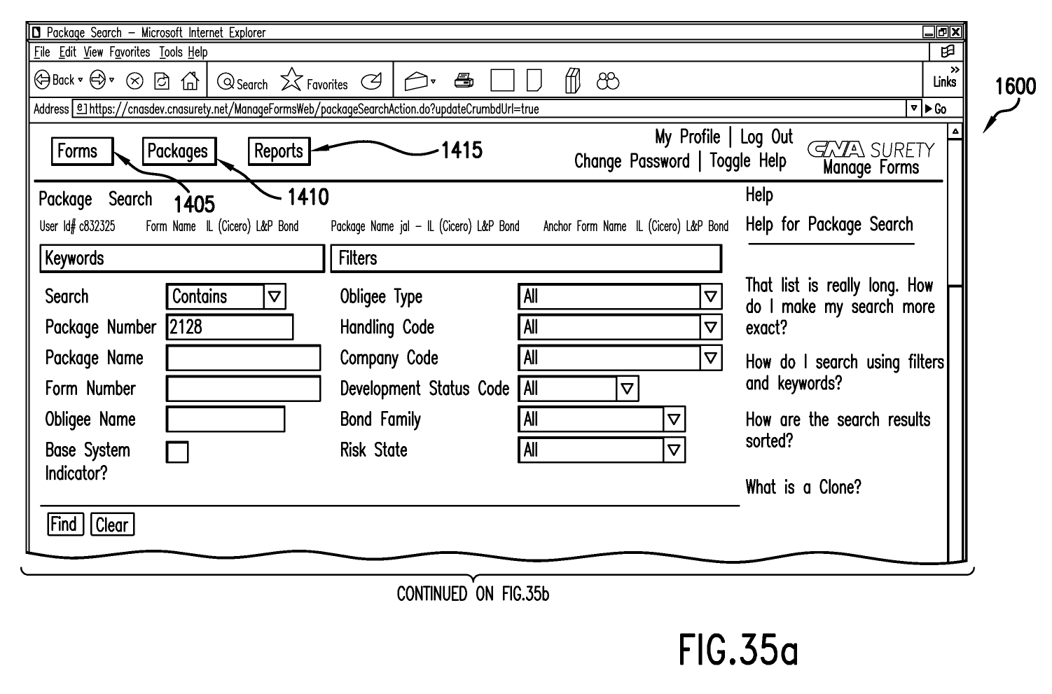

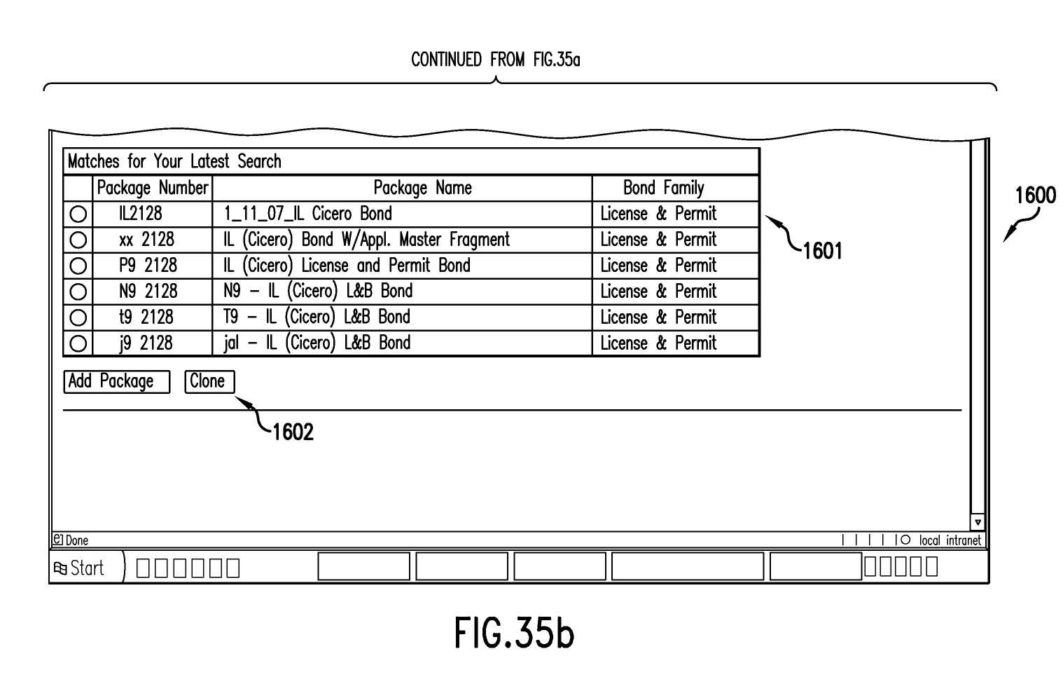

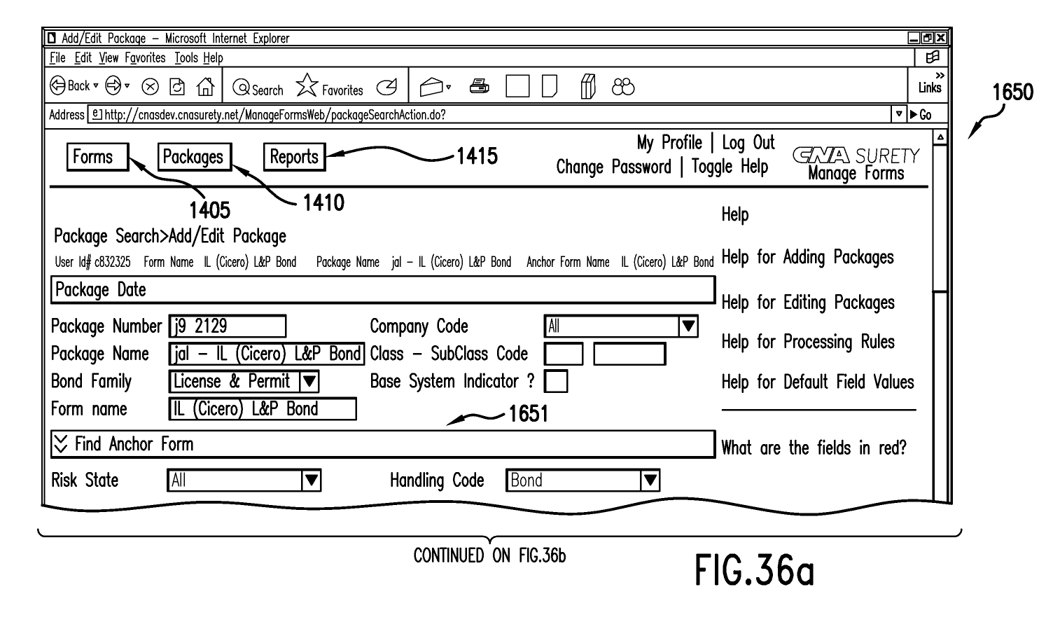

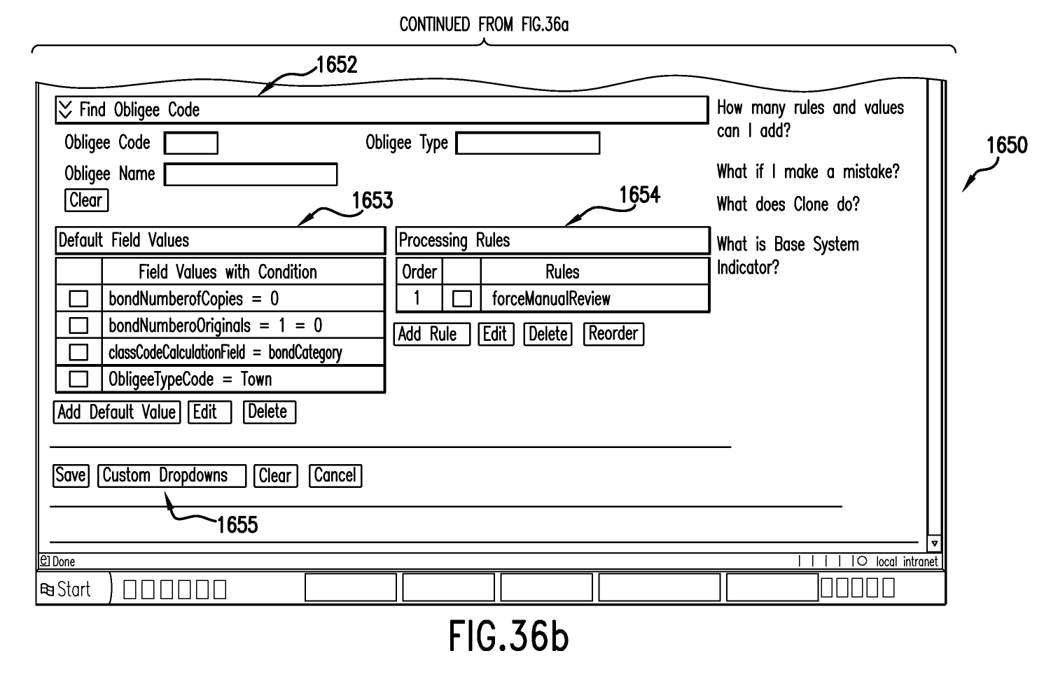

FIG. 35 shows an exemplary Package Search Screen 1600 which allows agents to search for packages registered in the system. The user can display the Package Search Screen 1600 by selecting the Packages Menu 1410, and then selecting, for example, the term “Search Package” from a drop-down sub-menu. As discussed above, a package may comprise a collection of forms that provides for the means to enter data and then produce a hardcopy output using that data. Packages may consist of Data Entry Fragments, Anchor Forms and Output Attachments, and package level rules may be defined for data entry and output. The package search may be implemented through selection of various keywords and filters, as is well known in the art. As shown in FIG. 35, the user may search for a package using a package code (or portion thereof), and the search will return all packages that include that code or code portion (e.g., “2128”). The search utility returns a list of any packages matching the search criteria in a results table 1601. The Package Number field in the results table 1601 may comprise a hyperlink to the package itself. If a user selects the hyperlink associated with a particular package (e.g., “j9 2128”), the user may then be presented with an Add/Edit Package Screen 1650, as described below in connection with FIG. 36. To avoid duplications, the manage forms system may restrict the entry of new packages until at least one package search has been completed. The Package Search Screen 1600 may include a “Clone” button 1602 which allows the user to copy all aspects of a selected package, and then save the cloned package under another package number and name. The package can then be modified to meet the new requirements, minimizing data entry.

FIG. 36 shows an exemplary Add/Edit Package Screen 1650 which allows certain employees of the controlled form issuer to define the basic data for a package. The user can display the Add/Edit Package Screen 1650 by selecting the Packages Menu 1410, and then selecting, for example, the term “Add/Edit Package” from a drop-down sub-menu, and entering a package number or package name. The Find Anchor Form table 1651 allows the user to find the particular Anchor Form corresponding to the selected package. Every package must have an Anchor Form. The Anchor Form can be entered using the Add/Edit Forms Screen 1450 (FIG. 32) discussed above, with the “Anchor Form?” check box checked. Once an Anchor From is chosen for a package it cannot be changed. The Find Obligee Code table 1652 allows the user to search for and select the obligee, as with the “Find Obligee Code” function in the Add/Edit Forms Screen 1450 (FIG. 32) discussed above. The user can override the obligee at the form level by choosing the obligee for the entire package from the Add/Edit Package Screen 1650. The Default Field Values table 1653 allows the selection of fields and the definition of a default value for each field. After the default is set, an indicator can be checked to make the field ‘not overwritable’. Moreover, default values can be added, edited or deleted from this table. The Processing Rules table 1654 allows the user to define processing rules for the package. The processing rules are predefined, and cannot be modified by the agent. Test cases may be setup for each processing rule that uniquely define the rule for the current package. Processing rules can be added, edited, deleted and reordered by the controlled form issuer to better control the issuance of the controlled forms. The order of the processing rules determines the order they are applied. For example, a rule entitled “Force Manual Review” may be created which requires manual review of any submission that meets the rule criteria under the particular package, thereby overriding penalty values set at the agency, package or form levels. For example, the rule criteria may be that a force manual review will be performed if the proposed insured has incurred prior losses. If this condition (e.g., prior losses) is met, the submission will be forced to an underwriter's work queue for review. The Add/Edit Package Screen 1650 may also include a “Custom Dropdowns” button 1655 for accessing a Custom Dropdowns Screen 1700, as discussed below.

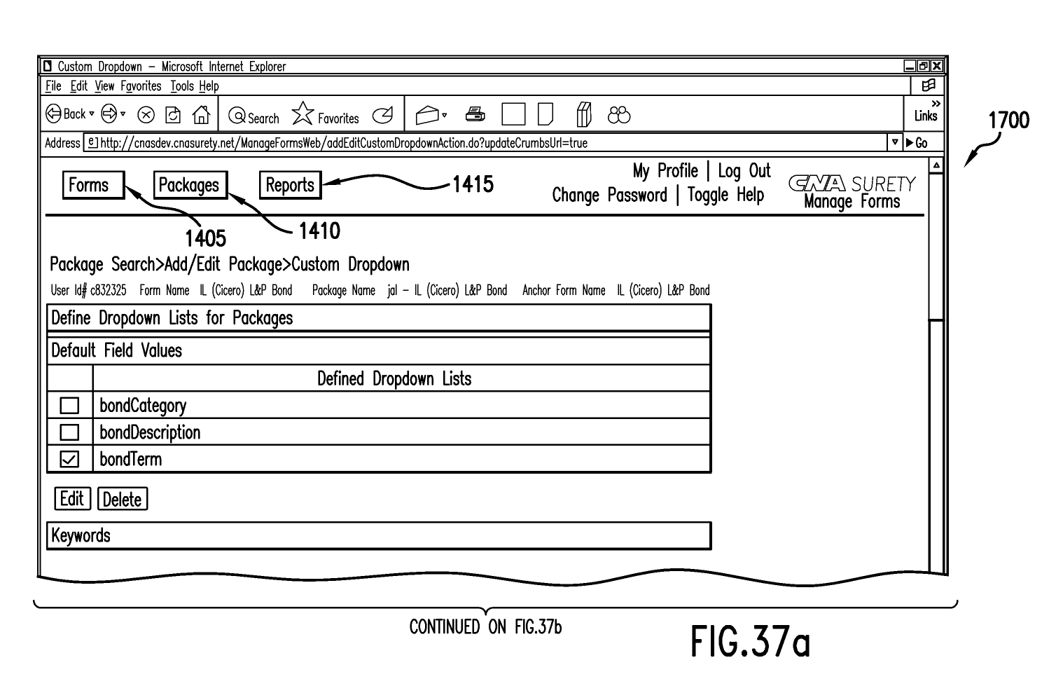

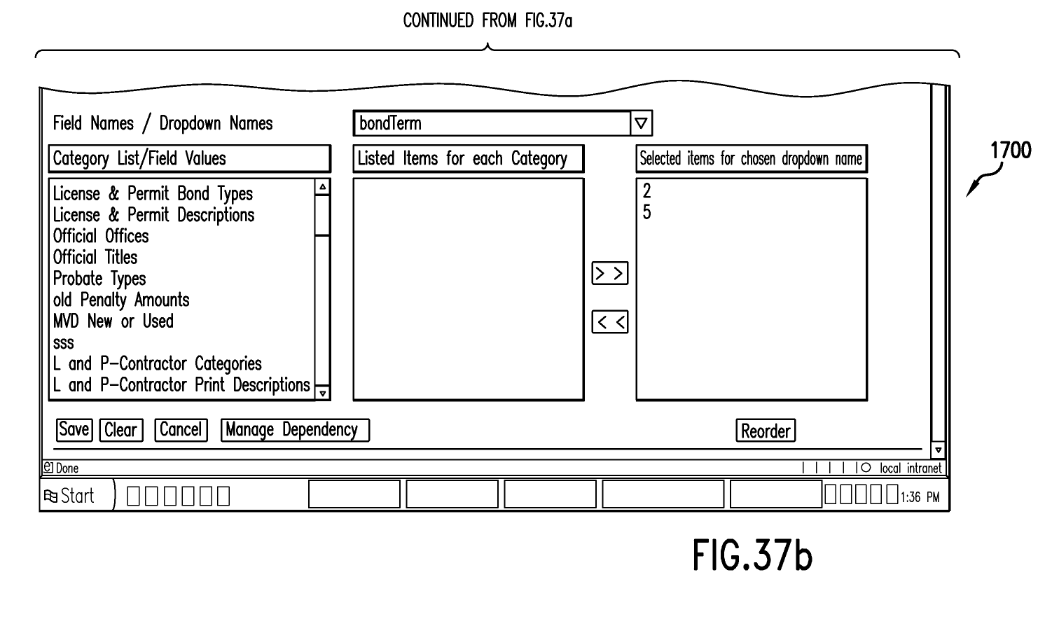

FIG. 37 shows an exemplary Custom Dropdowns Screen 1700 which allows certain employees of the controlled form issuer to define the values to be contained in a dropdown list for the particular package. For example, a Bond Term dropdown list may be defined to contain the values 1, 2 & 3 for one package, and the values 3 & 5 for another package. As noted above, the Custom Dropdowns Screen 1700 may be accessed through selection of a “Custom Dropdowns” button 1655 on the Add/Edit Package Screen 1650 (FIG. 36). One of the benefits of the manage forms system is that it allows modifications of the package stored therein in real-time, so that once the modifications are made, the packages are immediately available for use by the agents.

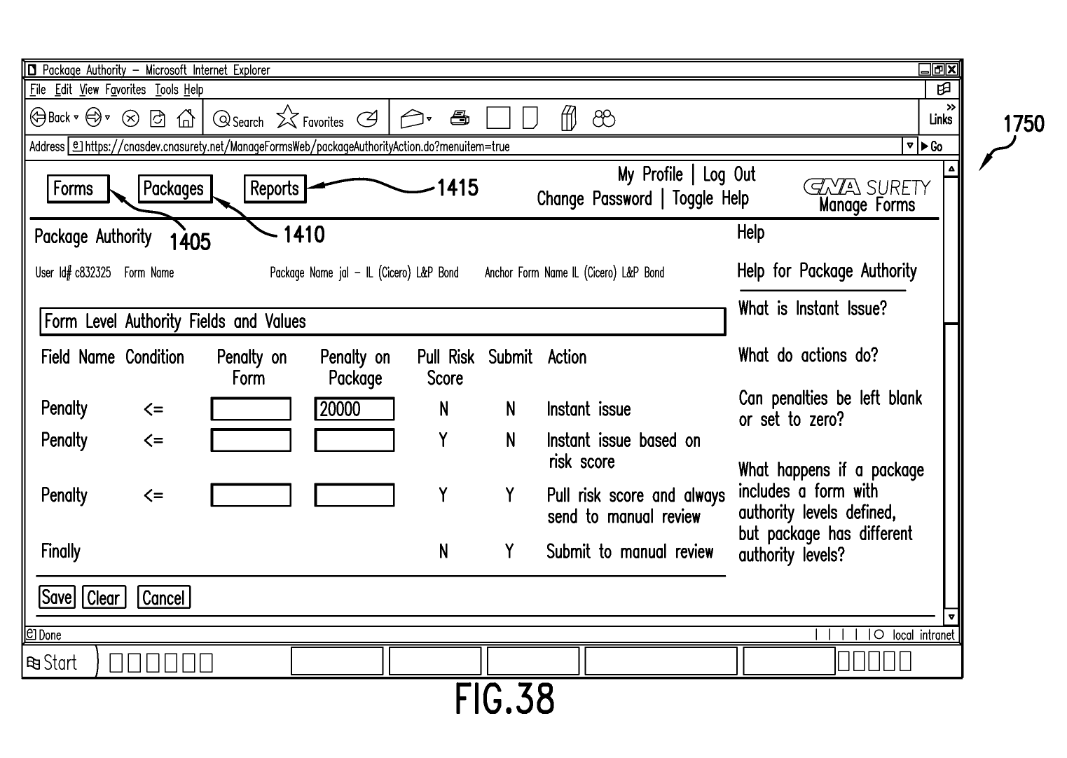

FIG. 38 shows an exemplary Package Authority Screen 1750 which allows certain employees of the controlled form issuer to define and manage authority levels for a package, in much the same manner as described above with regard to Add/Edit Profile Authority Screen 450 (FIG. 20) in the agency management system, and the Forms Authority Screen 1500 (FIG. 33) in this manage forms system. The user can display the Package Authority Screen 1750 by selecting the Packages Menu 1410, and then selecting, for example, the term “Package Authority” from a drop-down sub-menu, and entering a package number or package name. Any package authority setting will automatically override an authority set at the form level. However, authority settings made at the agency level will not be overridden by changes made on the Package Authority Screen 1750. For any fields that are modifiable on the Package Authority Screen 1750, the user may make modifications, and either save the changes (by selecting a “Save” button on screen), cancel changes (by selecting a “Cancel” button on screen), or reset to the original settings (by selecting a “Reset” button on screen). One of the benefits of the manage forms system is that it allows modifications of the authority and penalty levels for packages stored therein in real-time, so that once the modifications to the authority and penalty levels are made, the packages are immediately available for use by the agents.

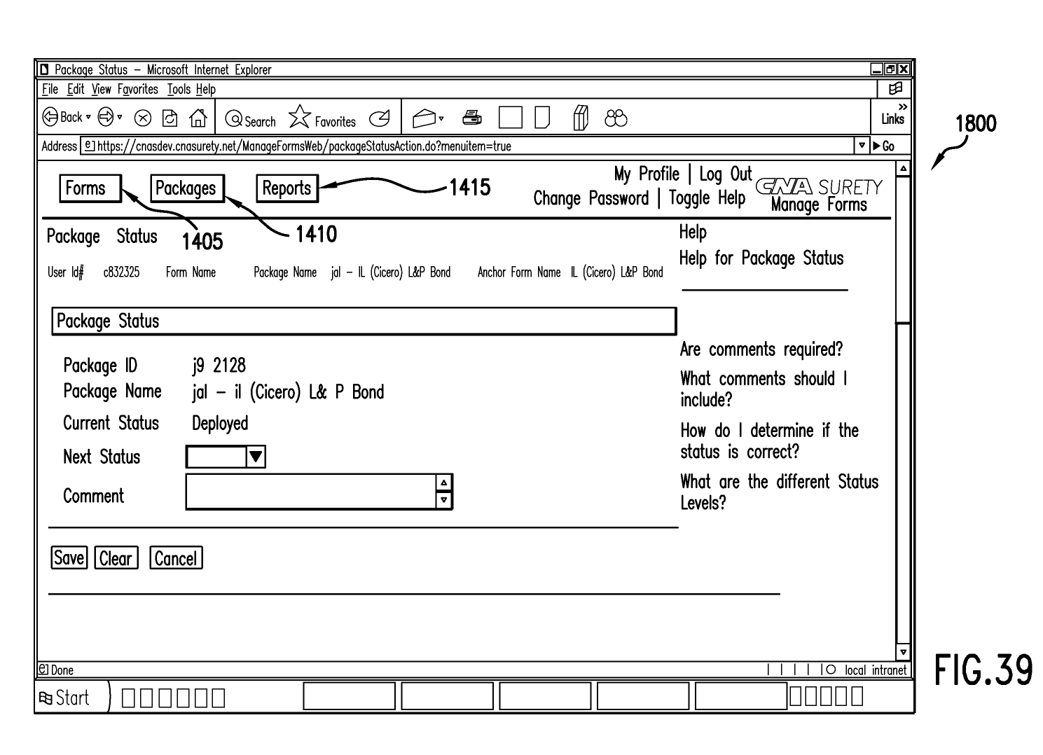

FIG. 39 shows an exemplary Package Status Screen 1800 which allows certain employees of the controlled form issuer to define the status of a package, in much the same manner as described above with regard to form level status and the Form Status Screen 1550 (FIG. 34). The user can display the Package Status Screen 1800 by selecting the Packages Menu 1410, and then selecting, for example, the term “Package Status” from a drop-down sub-menu, and entering a package number or package name. There are different status levels which may be used to track the life cycle of the packages. Status levels may include “Deployed” (meaning the package is in use currently), “Development” (meaning the package is being worked on), “Hold” (meaning the package is not currently active in any stage of the development life cycle), “Passed Testing” (meaning the package has successfully passed a testing stage), “No Longer Needed” (meaning the package cannot be deleted, but is still part of the system), “Ready for Production” (meaning the package is ready for implementation), and “Test” (meaning the package is currently being tested).

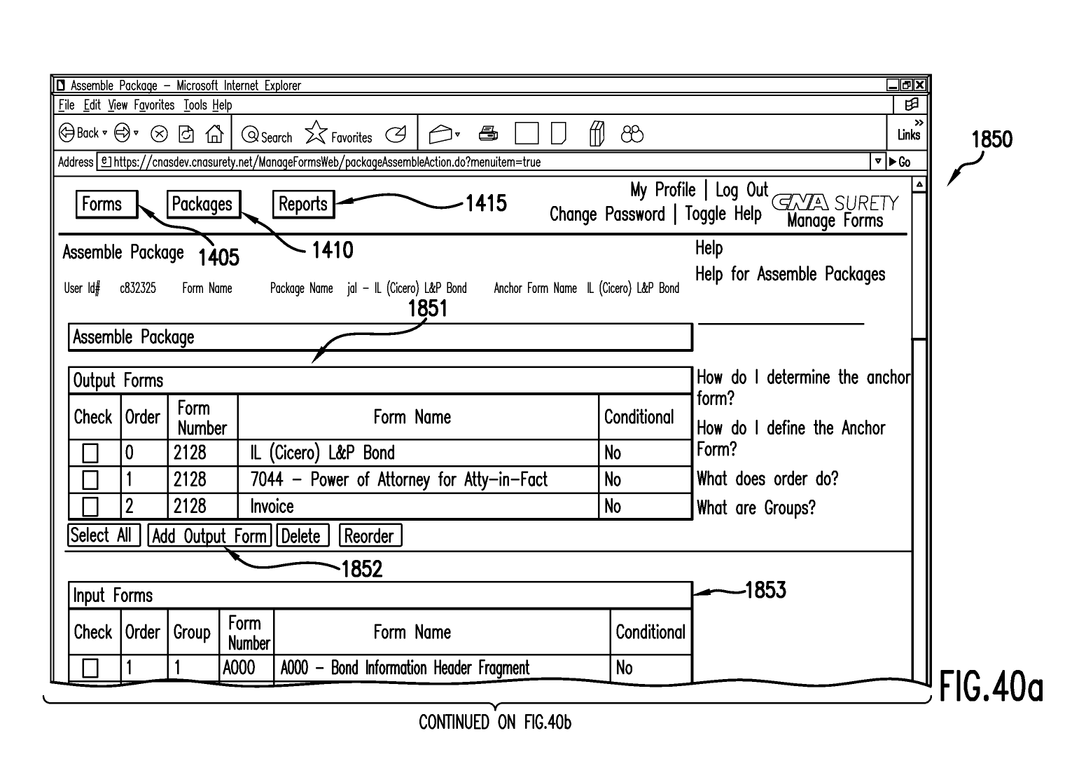

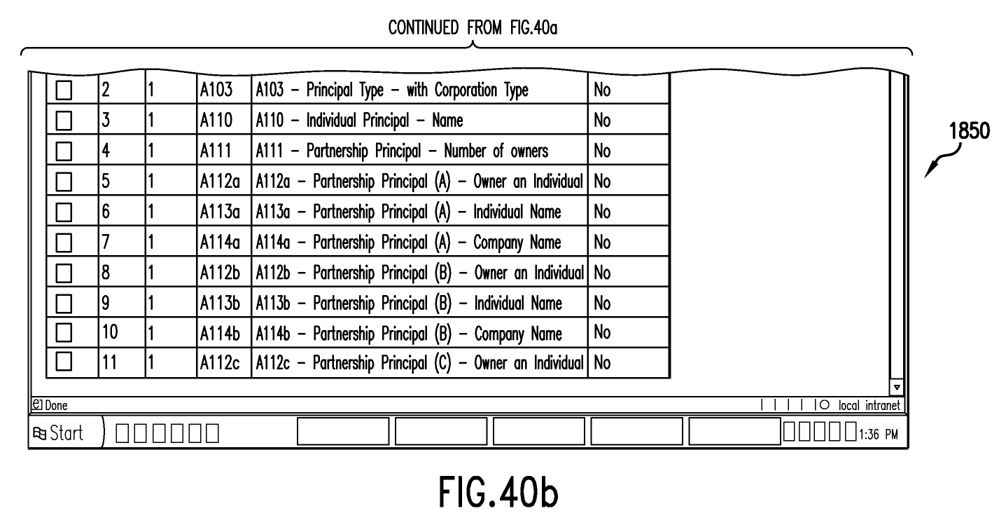

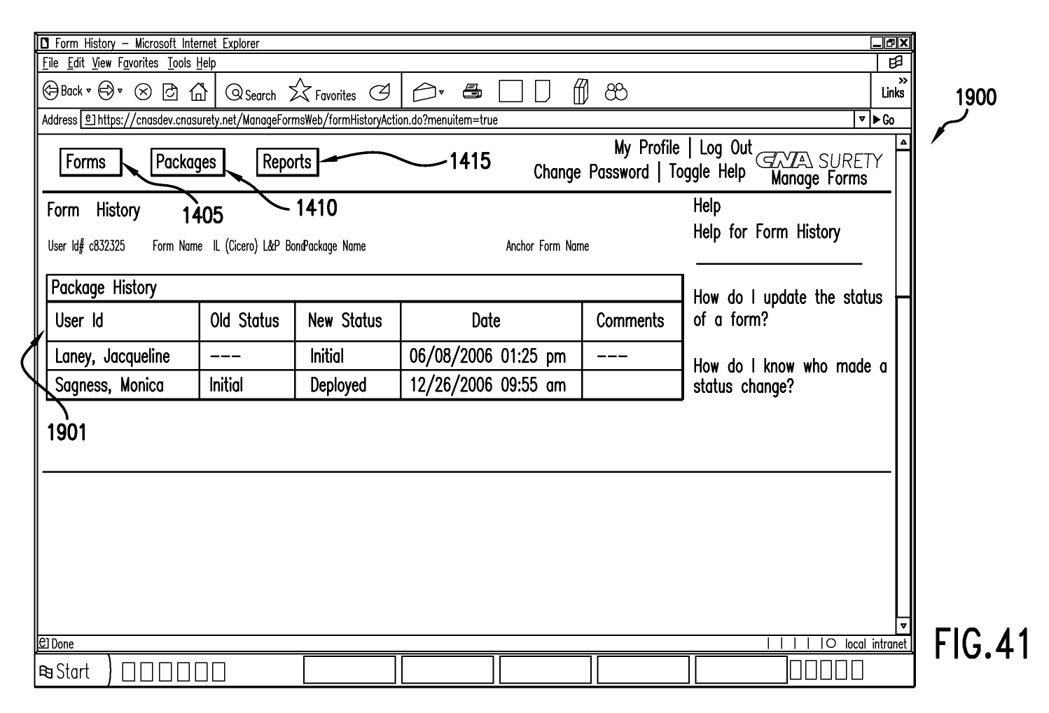

FIG. 40 shows an exemplary Package Assembly Screen 1850 which allows certain employees of the controller form issuer to link together Input Forms and Output Forms, to provide for all data entry and output needs for a package. The user can display the Package Assembly Screen 1850 by selecting the Packages Menu 1410, and then selecting, for example, the term “Package Assembly” from a drop-down sub-menu, and entering a package number or package name. The Output Forms table 1851 displays the Output Forms that have been defined for the package. Output Forms will print in the order that they are listed in the Output Forms table 1851. As noted above, every package must include at least one Anchor Form. However, a package may have an unlimited number of Output Forms. The Output Forms table 1851 may include an “Add Output Form” button 1852 which permits the user to search for and select additional Output Forms to be added to the package. The Output Forms table 1851 may also include additional buttons (e.g., “Select All,” “Delete,” “Reorder”) which permit the user to arrange the Output Forms within the Output Forms table. The Form Number field in the Output Forms table 1851 may comprise a hyperlink to an additional screen where the user can set additional conditions for the form, such as whether the form should be included in the package.

The Input Forms table 1853 displays the Input Forms that have been defined for the package. Each of the Input Forms may comprise one or more Data Entry Fragments (e.g., pieces of information relating to the form) which may be ‘stitched’ together at to create a complete set of data entry screens for the package. Input Forms may be displayed in the order that they are listed in the Input Forms table 1853. There can be multiple data entry screens for each package. Data Entry Fragments may be organized into groups that indicate in which screen they will appear. The Form Number field in the Input Forms table 1853 may comprise a hyperlink to an additional screen where the user can set additional conditions for the form, such as whether the form should be included in the package.

In addition to Input and Output Forms, the Package Assembly Screen 1850 may also permit the user to manipulate Supporting Packages. A Supporting Package is a package which is nested within another package. Supporting Packages can only comprise Output Forms. A Supporting Package Number field displayed on the Package Assembly Screen 1850 may comprise a hyperlink to an additional screen where the user can set additional conditions for the supporting package, such as whether the supporting package should be included in the package.

In addition to the form and package functionality described above, the manage forms system may also permit the generation of various reports, including: (1) a form history report, and (2) a form history report. Each of these reports will be explained in detail below.

FIG. 41 shows an exemplary Form History Screen 1900 which displays a listing of all the changes to a particular form. The user can display the Form History Screen 1900 by selecting the Reports Menu 1415, and then selecting, for example, the term “Form History” from a drop-down sub-menu, and entering a form number or form name. The changes to the particular form are listed in a history table 1901, which shows the User Id of each user who has accessed and modified the form, and the date and time of the modification. Comments may also be stored for each modification to help others better understand the form's history.

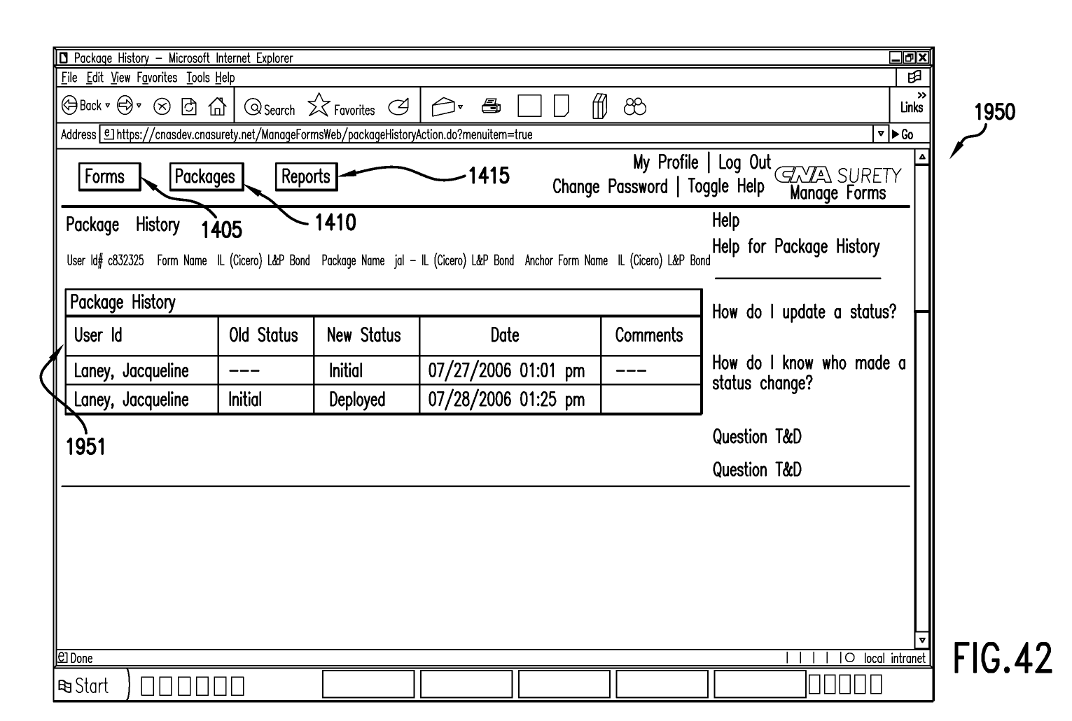

FIG. 42 shows an exemplary Package History Screen 1950 which displays a listing of all the changes to a particular package. The user can display the Package History Screen 1950 by selecting the Reports Menu 1415, and then selecting, for example, the term “Package History” from a drop-down sub-menu, and entering a package number or package name. The changes to the particular package are listed in a history table 1951, which shows the User Id of each user who has accessed and modified the package, and the date and time of the modification. Comments may also be stored for each modification to help others better understand the package's history.

### Underwriters' System

Any of the first through third exemplary embodiments of the present invention described above may optionally include an underwriters' system which permits certain employees in the underwriting department of the controlled form issuer (e.g., insurer) to view controlled forms and issue underwriting decisions. For example, the underwriters' system may be implemented as a separate program module of the software which implements the primary processes described above with reference to FIGS. 2 (first exemplary embodiment), 8 and 12 (second and third exemplary embodiments). In short, the underwriters' system comprises a software program within the computer system (e.g., resident on the agent computers 14, 28 or server computers 10, 11, 31) which permits certain employees of the controlled form issuer to make underwriting decisions in real-time. For example, an underwriter may receive a request to approve a bond penalty amount through the underwriters' system, and may issue an approval directly to the agent in real-time. In order to timely notify the underwriter of pending requests, the underwriters' system may provide an ability to automatically generate an e-mail to the appropriate underwriter when an agent submits a controlled form request that requires underwriter approval. Once the underwriter receives the e-mail, he or she can immediately use the underwriters' system to take some action with regard to the controlled form request, thereby allowing form-issuing decisions to be made in real-time.

The display screens of the underwriters' system are similar to the display screens of the form issuance system described above in connection with FIGS. 43 and 44. For example, the underwriter may first be presented with a search screen (like Form Search Screen 2000), which permits the underwriter to search for controlled forms by various parameters, such as Agency Name, Agency Code, Obligee Name, etc. Alternatively, the underwriter may display all his or her pending requests (across all agencies) by selecting a Pending List menu (similar to the Pending List menu 2010 on the Form Search Screen 2000). The underwriter can then select a particular controlled form, and take some action (e.g., approve, decline, submit for further processing, etc.). If, for example, the underwriter chooses to approve the controlled form for issuance (as explained below), the agent requesting the form will be notified (e.g., via e-mail generated by the underwriters' system) that the form is ready for issue, and the status of the form will be changed to “Approved for Print” on the agent's Pending List Screen 2050 (FIG. 44). In addition to the above-described methods, the e-mail informing the underwriter of the controlled from request may include a hyperlink directly to the controlled form, so that the underwriter does not need to waste time trying to find the form in the underwriters' system.

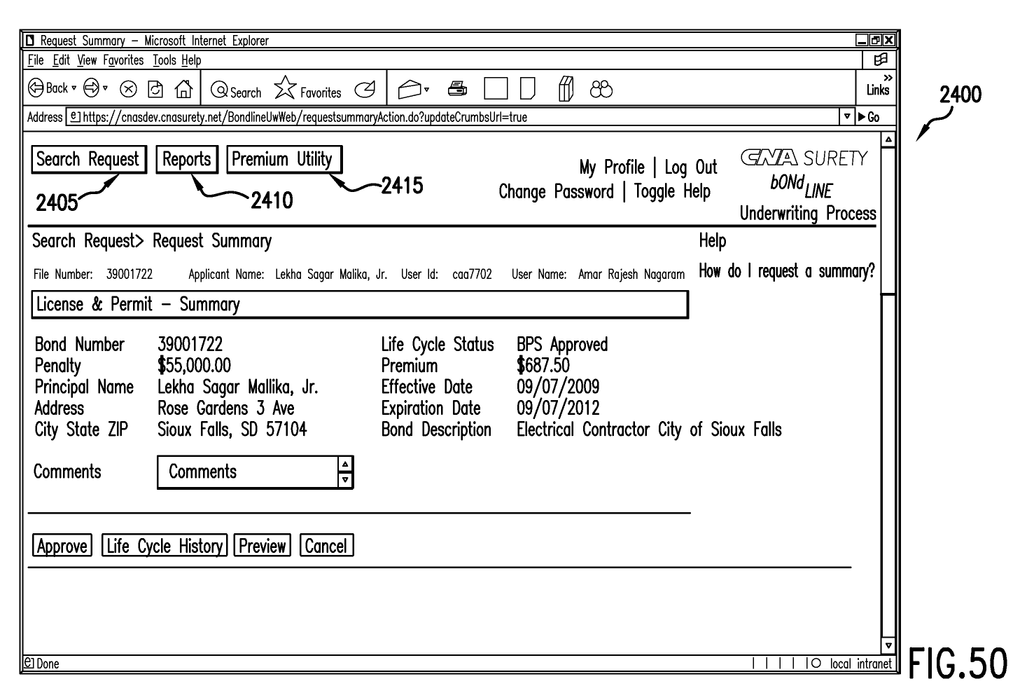

FIG. 50 shows an exemplary Request Approval Screen 2400 which displays a request for the issuance of one or more controlled forms (e.g., bonds). The user (e.g., underwriter) can display the Request Approval Screen 2400 by selecting a Search Request Menu 2405, and then selecting, for example, and then entering some search criteria indicative of the form (e.g., form number, principal name, etc.). If more than one controlled form matches the search criteria, the user will be presented with a table of matching entries, from which the proper controlled form may be selected via hyperlink, similar to the search process described above in connection with the Form Search Screen 2000 (FIG. 43). Alternatively, the user may display all his or her pending requests for approval (across all agencies) by selecting a Reports Menu 2410, and then selecting, for example, the term “Pending List” from a drop-down sub-menu. In addition to the Search Request Menu 2405, and the Reports Menu 2410, the Request Approval Screen 2400 may also include a Premium Utility Menu 2415, which permits the user to perform premium calculations, and/or change premium amounts. As shown, the Request Approval Screen 2400 may include information which allows the user to approve or deny the request, such as Form (Bond) Number, Penalty Amount, Principal Name, Principal Address, Premium Amount, Form (Bond) Description, etc. The Request Approval Screen 2400 may also include various buttons for assisting the user in the approval process, such as an “Approve” button (for approving the request), a “Life Cycle History” button (for displaying life cycle information for the request), a “Preview” button (for displaying a preview of the controlled form), and a “Cancel” button (for canceling the approval process and returning to the previous screen). If the user selects the “Approve” button, for example, the user may be presented with a Compose E-mail Screen 2450, as discussed below, which automates the sending of an e-mail back to the individual (e.g., agent) requesting the controlled form.

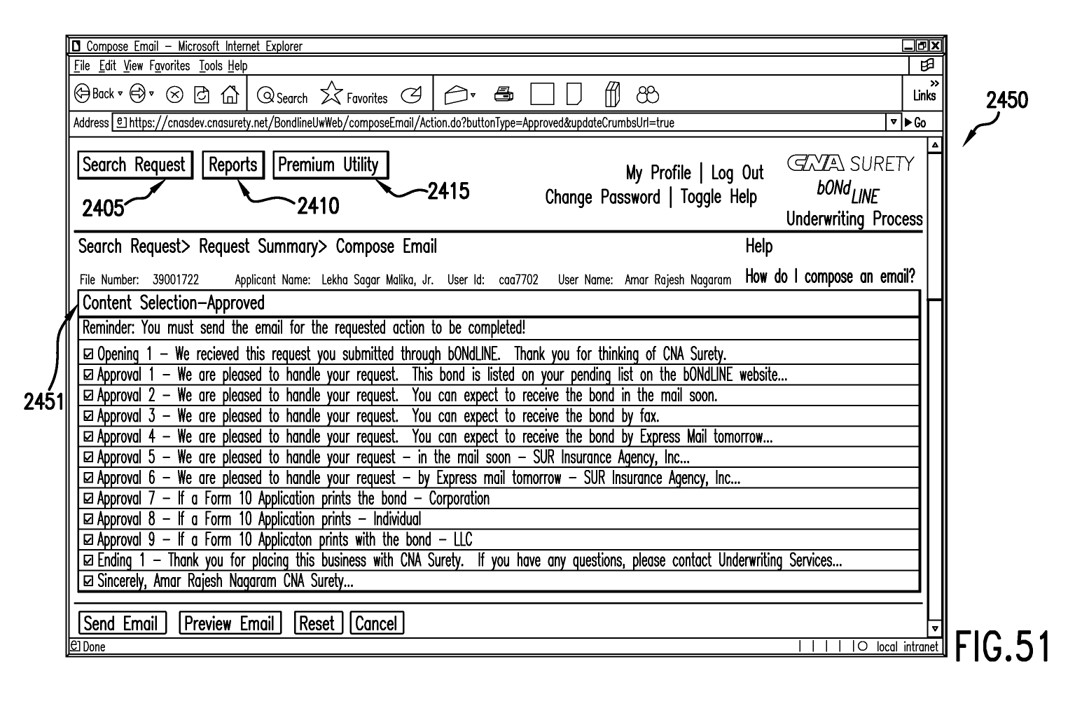

FIG. 51 shows an exemplary Compose E-mail Screen 2450 which displays a plurality of different approval messages. The approval messages may be displayed in Messages table 2451, which may include a check mark box next to each message, so that the user can easily select which messages will be included in an e-mail back to the requester of the controlled form (e.g., agent). The Compose E-mail Screen 2450 may also include various buttons for assisting the user in the e-mail generation process, such as an “Send Email” button (for sending an e-mail with the selected messages), a “Preview Email” button (for displaying a preview of the e-mail), a “Reset” button (for resetting all the check mark boxes to their unchecked setting), and a “Cancel” button (for canceling the e-mail generation process and returning to the previous screen). If the user selects the “Send Email” button, for example, the user may be presented with a Draft E-mail Screen 2500, as discussed below.

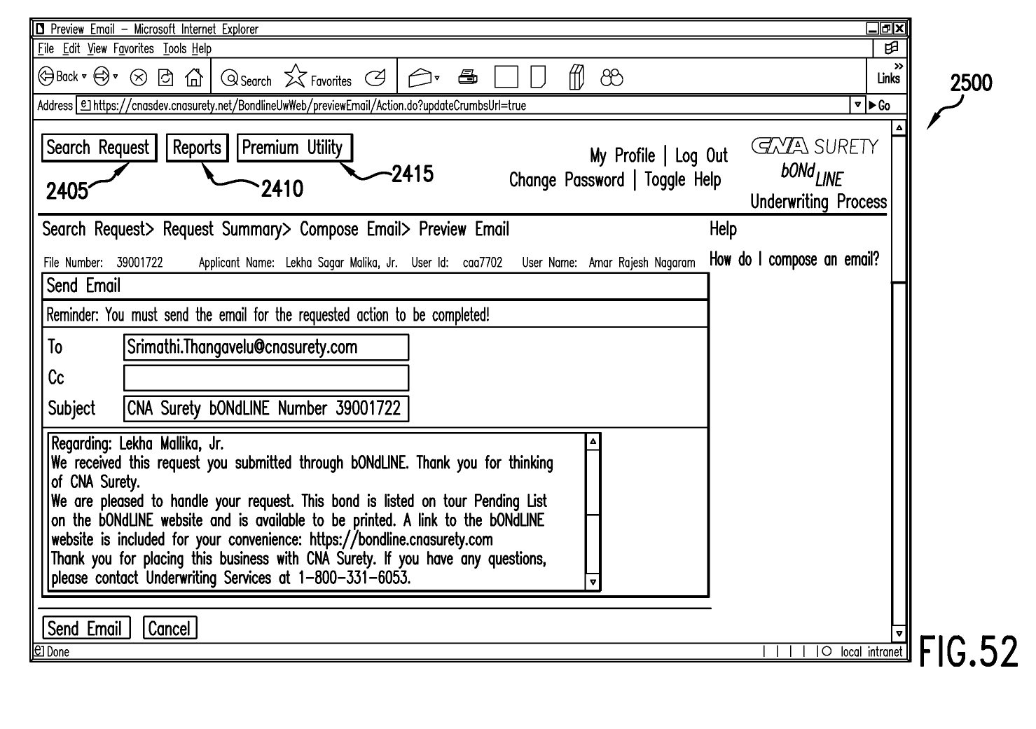

FIG. 52 shows an exemplary Draft E-mail Screen 2500 which displays a draft e-mail from the user (e.g., underwriter) to the individual requesting the controlled form (e.g., agent). The draft e-mail may include the e-mail address of the requestor in the “To” line (e.g., srimathi.thangavelu@cnasurety.com), and an identification number for the controlled form in the “Subject” line (e.g., “Number 39001722”). The Draft E-mail Screen 2500 may also include various buttons for assisting the user in the e-mail sending process, such as an “Send Email” button (for sending the draft e-mail as is), and a “Cancel” button (for canceling the e-mail sending process and returning to the previous screen). If the user selects the “Send Email” button, for example, an e-mail is sent to the individual requesting the controlled form in the format shown on the Draft E-mail Screen 2500.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. A computer system comprising:
at least one server computer; and,
at least one client computer coupled to the at least one server computer through a network;
wherein the at least one server computer includes at least one program stored thereon, said at least one program being capable of performing the following steps:
permitting a user stationed at the at least one client computer to select a controlled form issuer;
displaying one or more controlled forms associated with the selected controlled form issuer;
permitting the user to select at least one form from said one or more controlled forms;
displaying a data entry screen corresponding to the selected form;
permitting the user to enter data into one or more fields of the selected form; and,
issuing a completed controlled form corresponding to the selected form at the at least one client computer, whereby the controlled form issuer is bound to the terms of the completed controlled form.

2. The computer system of claim 1, further comprising a web server computer coupled to the at least one server computer and the at least one first client computer.

3. The computer system of claim 1, wherein said at least one program is capable of performing the further step of:
determining whether a printer coupled to the at least one client computer is capable of printing the completed controlled form, and if not, displaying one or more selections for transmitting the completed controlled form to the user on a screen of the at least one client computer.

4. The computer system of claim 1, wherein said at least one program is capable of performing the further step of:
permitting the user to perform a risk assessment on an applicant associated with the selected form.

5. The computer system of claim 4, wherein the step of permitting the user to perform a risk assessment on an applicant associated with the selected form comprises:
entering said risk-related information into one or more fields of the selected form; and,
performing a risk calculation based on the entered information.

6. The computer system of claim 4, wherein a cost associated with the selected form is adjusted based on said risk assessment.

7. The computer system of claim 5, wherein said at least one program is capable of performing the further steps of:
accepting the applicant if the risk calculation is above a first predetermined value; and,
declining the applicant if the risk calculation is below a second predetermined value.

8. The computer system of claim 1, wherein said at least one program is capable of performing the further steps of:
determining an authorized amount for the user;
determining an amount requested for the selected form; and,
displaying a message on a screen of the at least one client computer that the user's authorization has been exceeded if the amount requested exceeds the authorized amount.

9. The computer system of claim 1, wherein said at least one program is capable of performing the further step of:
displaying a main menu to the user, from which one or more of the controlled form issuer or the controlled form may be selected.

10. The computer system of claim 1, further comprising at least one internal workflow computer coupled to the at least one server computer.

11. The computer system of claim 1, wherein said at least one program is capable of performing the further steps of:
permitting the user to create at least one agency profile;
permitting the user to create at least one agent profile associated with the at least one agency profile; and,
permitting the user to set permissions associated with the at least one agent profile.

12. The computer system of claim 1, wherein said at least one program is capable of performing the further steps of:
permitting the user to create at least one controlled form;
permitting the user to set permissions associated with the at least one created controlled form; and,
permitting the user to change the permissions associated with the at least one created controlled form.

13. The computer system of claim 1, wherein the completed controlled form comprises a bond.

14. The computer system of claim 1, wherein the completed controlled form is selected from the group consisting of: bank depository bonds, bankruptcy trustee bonds, bid bonds, blanket bonds, blanket position bonds, blanket public official bonds, blanket position public official bonds, commercial bonds, commercial blanket bonds, contract bonds, court bonds, defendant bonds, errors and omissions insurance, fidelity bonds, fiduciary bonds, license and permit bonds, maintenance bonds, miscellaneous bonds, name schedule bonds, name schedule public official bonds, notary public bonds, payment bonds, performance bonds, plaintiff bonds, reclamation bonds, retrospective plans, supply bonds, self-insurers retention plans, surety bonds, and workers' compensation self-insurers bonds.

15. The computer system of claim 1, wherein said at least one program is capable of performing the further steps of:
generating a report file corresponding to the entered information for the selected form; and,
transmitting the report file from a web server computer to the at least one server computer.

16. The computer system of claim 1, further comprising a legacy computer system coupled to the at least one server computer.

17. The computer system of claim 1, wherein said at least one program is capable of performing the further step of storing information associated with the selected form on the legacy computer system.

18. The computer system of claim 1, wherein said at least one program is capable of performing the further steps of:
sending an e-mail message to at least one employee of the controlled form issuer that the selected form needs additional review;
permitting the at least one employee of the controlled form issuer to view the data entered into the data entry screen;
generating an e-mail message to the user that the selected form has been approved by the at least one employee of the controlled form issuer.

19. The computer system of claim 1, wherein said at least one program is capable of performing the further step of permitting at least one employee of the controlled form to perform one or more activities selected from the group consisting of: searching for an agency profile, editing an agency profile, defining authority levels for an agency profile, viewing authority overrides associated with an agency profile, adding one or more forms to an agency profile, and deleting one or more forms from an agency profile.

20. The computer system of claim 1, wherein said at least one program is capable of performing the further step of permitting at least one employee of the controlled form to perform one or more activities selected from the group consisting of: displaying a list of forms associated with an agency profile, displaying a list of all changes to agency profile information.

21. The computer system of claim 1, wherein said at least one program is capable of performing the further step of permitting at least one employee of the controlled form to perform one or more activities selected from the group consisting of searching for a form, editing form information, editing authority levels associated with the form.

22. A computer readable medium having embodied therein a computer program for processing by a machine, the computer program comprising:
a first code segment for permitting a user to select a controlled form issuer;
a second code segment for displaying one or more controlled forms associated with the selected controlled form issuer;
a third code segment for permitting the user to select at least one form from said one or more controlled forms;
a fourth code segment for displaying a data entry screen corresponding to the selected form;
a fifth code segment for permitting the user to enter data into one or more fields of the selected form; and,
a sixth code segment for issuing a completed controlled form corresponding to the selected form, whereby the controlled form issuer is bound to the terms of the completed controlled form.

23. The computer readable medium of claim 22, wherein the completed controlled form comprises a bond.

24. A computer data signal embodied in a carrier wave comprising:
a first code segment for permitting a user to select a controlled form issuer;
a second code segment for displaying one or more controlled forms associated with the selected controlled form issuer;
a third code segment for permitting the user to select at least one form from said one or more controlled forms;
a fourth code segment for displaying a data entry screen corresponding to the selected form;
a fifth code segment for permitting the user to enter data into one or more fields of the selected form; and,
a sixth code segment for issuing a completed controlled form corresponding to the selected form, whereby the controlled form issuer is bound to the terms of the completed controlled form.

25. The computer data signal of claim 24, wherein the completed controlled form comprises a bond.
